(19) United States
(12) Patent Application Publication
(10) Pub. No.: US 2011/0096942 A1
(43) Pub. Date: Apr. 28, 2011

(54) NOISE SUPPRESSION SYSTEM AND METHOD

(75) Inventor: Jes Thyssen, San Juan Capistrano, CA (US)

(73) Assignee: BROADCOM CORPORATION, Irvine, CA (US)

(21) Appl. No.: 12/897,548

(22) Filed: Oct. 4, 2010

Related U.S. Application Data
(60) Provisional application No. 61/254,477, filed on Oct. 23, 2009.

(51) Int. Cl. H04B 15/00

(52) U.S. Cl. 381/94.1

(57) ABSTRACT

Systems and methods are described for applying noise suppression to one or more audio signals to generate a noise-suppressed audio signal therefrom. In a single-channel implementation, an input signal is received that comprises a desired audio signal and an additive noise signal. Noise suppression is then applied to the input signal to generate a noise-suppressed signal in a manner that is controlled by at least a parameter that specifies a degree of balance between distortion of the desired audio signal and unnaturalness of a residual noise signal included in the noise-suppressed signal. In an alternative single-channel implementation, a plurality of sub-band signals obtained by applying a frequency conversion process to a time domain representation of an input signal is received. Noise suppression is then applied to each of the sub-band signals by passing each of the sub-band signals through a time direction filter. Multi-channel noise suppression variants are also described.

### CROSS REFERENCE TO RELATED APPLICATIONS

This application claims priority to U.S. Provisional Patent Application No. 61/254,477 filed Oct. 23, 2009 and entitled “Noise Suppression Framework that Considers both Speech Distortion and Unnaturalness of Residual Background Noise,” the entirety of which is incorporated by reference herein.

### BACKGROUND OF THE INVENTION

1. Field of the Invention

The invention generally relates to systems and methods that process audio signals, such as speech signals, to remove undesired noise components therefrom.

2. Background

The term noise suppression generally describes a type of signal processing that attempts to attenuate or remove an undesired noise component from an input audio signal. Noise suppression may be applied to almost any type of audio signal that may include an undesired noise component. Conventionally, noise suppression functionality is often implemented in telecommunications devices, such as telephones, Bluetooth® headsets, or the like, to attenuate or remove an undesired additive background noise component from an input speech signal.

An input speech signal may be viewed as comprising both a desired speech signal (sometimes referred to as “clean speech”) and an additive background noise signal. Many conventional noise suppression techniques attempt to derive a time domain filter or a frequency domain gain function that, when applied to an appropriate representation of the input speech signal, will have the effect of attenuating or removing the additive background noise signal. However, when conventional noise suppression techniques are applied to the input speech signal, two main types of distortion will occur: (1) distortion of the desired speech signal; and (2) distortion of a residual background noise signal that remains after application of noise suppression. The distortion of the residual background noise signal mentioned here is distortion that has the effect of making the residual background noise component sound unnatural. Currently, there is no noise suppression method that takes both of these types of distortion into account explicitly when deriving the noise suppression time domain filter or frequency domain gain function. For example, the legacy Wiener filter simply attempts to minimize the error between the output of the noise suppressor and the invisible clean speech component without regard to the naturalness of the residual background noise component. What is needed, then, is an approach to noise suppression that minimizes speech distortion while also maintaining a natural residual background noise. The desired approach should be applicable to all types of audio signals.

### BRIEF SUMMARY OF THE INVENTION

Systems and methods are described herein for applying noise suppression to one or more input audio signals to generate a noise-suppressed audio signal therefrom. In one embodiment, an input audio signal is received that comprises a desired audio signal and an additive noise signal. Noise suppression is then applied to the input audio signal to generate a noise-suppressed signal in a manner that is controlled by at least a parameter that specifies a degree of balance between distortion of the desired audio signal and unnaturalness of a residual noise signal included in the noise-suppressed signal.

In an alternate embodiment, a first input audio signal is received that comprises a first desired audio signal and a first additive noise signal and a second input audio signal is received that comprises a second desired audio signal and a second additive noise signal. The first input audio signal is processed to generate a first processed audio signal in a manner that is controlled by at least a parameter that specifies a degree of balance between distortion of the first desired audio signal and unnaturalness of a residual noise signal included in a noise-suppressed audio signal. The second input audio signal is processed to generate a second processed audio signal in a manner that is controlled by at least the parameter that specifies the degree of balance between distortion of the first desired audio signal and unnaturalness of the residual noise signal. The first processed audio signal and the second processed audio signal are then combined to produce the noise-suppressed audio signal.

In a further embodiment, a plurality of sub-band signals obtained by applying a frequency conversion process to a time domain representation of an input audio signal is received. Noise suppression is then applied to each of the sub-band signals by passing each of the sub-band signals through a corresponding time direction filter. In one implementation in which each sub-band signal comprises a desired audio signal and a noise signal, passing each of the sub-band signals through a corresponding time direction filter comprises passing each of the sub-band signals through a time direction filter having a response that is controlled by at least a parameter that specifies a degree of balance between distortion of the desired audio signal included in the sub-band signal and unnaturalness of a residual noise signal included in a noise-suppressed version of the sub-band signal.

In a still further embodiment, a plurality of first sub-band signals obtained by applying a frequency conversion process to a time domain representation of a first input audio signal is received and a plurality of second sub-band signals obtained by applying a frequency conversion process to a time domain representation of a second input audio signal is received. Each of the plurality of first sub-band signals is passed through a corresponding one of a plurality of first time direction filters. Each of the plurality of second sub-band signals is passed through a corresponding one of a plurality of second time direction filters. An output from each of the plurality of first time direction filters is combined with an output from a corresponding one of the plurality of second time direction filters to generate a plurality of noise-suppressed sub-band signals.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a single-channel noise suppression system in accordance with an embodiment of the present invention.

FIG. 2 is a graph that illustrates shaping of a residual noise signal by a shaping filter in comparison to a flat attenuation of the residual noise signal in accordance with different embodiments of the present invention.

FIG. 3 is a block diagram of an example single-channel noise suppressor that uses a time domain filter in accordance with an embodiment of the present invention.

FIG. 4 is a block diagram of an alternate example single-channel noise suppressor that uses a time domain filter in accordance with an embodiment of the present invention.

FIG. 5 depicts a flowchart of a method for performing single-channel noise suppression in the time domain in accordance with an embodiment of the present invention.

FIG. 6 is a block diagram of a dual-channel noise suppression system in accordance with an embodiment of the present invention.

FIG. 7 is a block diagram of an example dual-channel noise suppressor that uses two time domain filters in accordance with an embodiment of the present invention.

FIG. 8 is a block diagram of an alternate example dual-channel noise suppressor that uses two time domain filters in accordance with an embodiment of the present invention.

FIG. 9 depicts a flowchart of a method for performing dual-channel noise suppression in the time domain in accordance with an embodiment of the present invention.

FIG. 10 is a block diagram of an example single-channel frequency domain noise suppressor in accordance with an embodiment of the present invention.

FIG. 11 depicts a flowchart of a method for performing single-channel noise suppression in the frequency domain in accordance with an embodiment of the present invention.

FIG. 12 is a block diagram of an example dual-channel frequency domain noise suppressor in accordance with an embodiment of the present invention.

FIG. 13 depicts a flowchart of a method for performing dual-channel noise suppression in the frequency domain in accordance with an embodiment of the present invention.

FIG. 14 is a block diagram of an example single-channel noise suppressor that utilizes a hybrid approach for performing noise suppression in accordance with an embodiment of the present invention.

FIG. 15 depicts a flowchart of an example method for performing hybrid single-channel noise suppression in accordance with an embodiment of the present invention.

FIG. 16 is a block diagram of an example dual-channel noise suppressor that utilizes a hybrid approach in accordance with an embodiment of the present invention.

FIG. 17 depicts a flowchart of an example method for performing hybrid dual-channel noise suppression in accordance with an embodiment of the present invention.

FIG. 18 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description of the present invention refers to the accompanying drawings that illustrate exemplary embodiments consistent with this invention. Other embodiments are possible, and modifications may be made to the embodiments within the spirit and scope of the present invention. Therefore, the following detailed description is not meant to limit the invention. Rather, the scope of the invention is defined by the appended claims.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As noted in the background section above, an input speech signal may be viewed as comprising both a desired speech signal and an additive background noise signal. Many conventional noise suppression techniques attempt to derive a time domain filter or a frequency domain gain function that, when applied to an appropriate representation of the input speech signal, will have the effect of attenuating or removing the additive background noise signal. However, when conventional noise suppression techniques are applied to the input speech signal, two main types of distortion will occur: (1) distortion of the desired speech signal; and (2) distortion of a residual background noise signal that remains after application of noise suppression. The distortion of the residual background noise signal mentioned here is distortion that has the effect of making the residual background noise component sound unnatural. Currently, there is no noise suppression method that takes both of these types of distortion into account explicitly when deriving the noise suppression time domain filter or frequency domain gain function. For example, the legacy Wiener filter simply attempts to minimize the error between the output of the noise suppressor and the invisible clean speech component without regard to the naturalness of the residual background noise component.

The noise suppression systems and methods described herein have been developed to enable noise suppression to be performed in a manner that provides better control of both speech distortion and unnaturalness of residual background noise. In the following, techniques in accordance with embodiments of the present invention will be described for performing (1) single channel (i.e., single microphone) noise suppression in the time domain; (2) dual channel (i.e., dual microphone) noise suppression in the time domain; (3) single channel noise suppression in the frequency domain; (4) dual channel noise suppression in the frequency domain; (5) single channel hybrid noise suppression (i.e., noise suppression in the frequency/time domain); and (6) dual channel hybrid noise suppression. Based on the teachings provided herein, persons skilled in the relevant art(s) will be able to easily extend the dual channel implementations to M channel noise suppression.

The embodiments described herein that perform noise suppression in the time domain utilize a noise suppression filter, while the embodiments described herein that perform noise suppression in the frequency domain utilize a gain function. The embodiments described herein that perform noise suppression using a hybrid approach offer the flexibility of combining the time domain and frequency domain. This may be advantageous in practice where the noise suppression comprises part of an audio framework in which a sub-band (frequency domain) representation is available but of inadequate frequency resolution for noise suppression. As will be described herein, the hybrid solution utilizes a filter in the time direction of the sub-band signals. The sub-band signals can be the frequency points from a Fast Fourier Transform (FFT) when viewed in the time direction, or can be sub-band signals from a filter bank.

Furthermore, in accordance with certain embodiments described herein, general solutions are provided that allow for arbitrary shaping of the residual background noise as inherent part of controlling the noise suppression process. Thus, these embodiments may be thought of as providing flexibility beyond just suppressing/attenuating the background noise.

Although the foregoing described the application of noise suppression to an input speech signal comprising a desired speech component and an additive background noise component to produce a noise-suppressed speech signal that includes a residual background noise component, persons skilled in the relevant art(s) will readily appreciate that the noise suppression techniques described herein may be generally applied to any input audio signal that includes a desired audio component and an additive noise component to produce a noise-suppressed audio signal that includes a residual noise component. That is to say, embodiments of the present invention are by no means limited to the application of noise suppression to speech signals only but can instead be applied to audio signals generally.

### B. Single-Channel Noise Suppression in the Time Domain in Accordance with Embodiments of the Present Invention

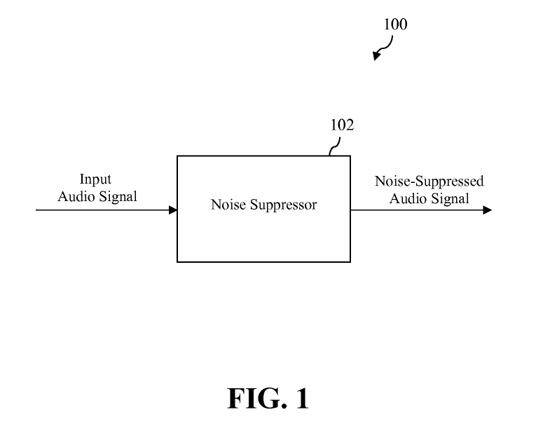

FIG. 1 is a high-level block diagram of a single-channel noise suppression system 100 in accordance with an embodiment of the present invention. As shown in FIG. 1, system 100 includes a noise suppressor 102 that receives a single input audio signal. The single input audio signal may be received, for example, from a single microphone or may be derived from an audio signal that is received from a single microphone. Noise suppressor 102 operates to apply noise suppression to the input audio signal to generate a noise-suppressed audio signal. The input audio signal comprises a desired audio signal and an additive noise signal. As will be discussed in more detail herein, noise suppressor 102 is configured to apply noise suppression in a manner that is controlled by at least a parameter that specifies a degree of balance between distortion of the desired audio signal and the unnaturalness of a residual noise signal included in the noise-suppressed audio signal.

Noise suppression system 100 may be implemented in any system or device that operates to process audio signals for transmission, storage and/or playback to a user. For example, noise suppression system 100 may be implemented in a telecommunications device, such as a cellular telephone or headset that processes input speech signals for subsequent transmission to a remote telecommunications device via a network, although this is merely an example. Noise suppression system 100 may be implemented in hardware using analog and/or digital circuits, in software, through the execution of instructions by one or more general purpose or special-purpose processors, or as a combination of hardware and software.

In embodiments to be described in this section, noise suppressor 102 operates to receive a time domain representation of the input audio signal and to pass the time domain representation of the input audio signal through a time domain filter having an impulse response that is controlled by at least the parameter that specifies the degree of balance between the distortion of the desired audio signal and the unnaturalness of the residual noise signal. In the following, exemplary derivations of such a time domain filter will first be described. An exemplary implementation of noise suppressor 102 that utilizes such a time domain filter will then be described. Finally, exemplary methods for performing single-channel noise suppression in the time domain will be described.

1. Example Derivation of Time Domain Filter for Single-Channel Noise Suppression

The input audio signal received by noise suppressor 102 may be represented as

y(n)=x(n)+s(n) (1)

wherein x(n) is a desired audio signal and s(n) is an additive noise signal. In a like manner to that used to derive the well-known Wiener filter, an estimate of the desired audio signal x(n) is predicted from the input audio signal y(n) by means of a finite impulse response (FIR) filter:

$$\hat{x} ( n ) = {\sum }_{k = 0}^{K} h ( k ) y ( n - k ) \qquad ( 2 )$$

wherein h(k) is the impulse response, and is the entity to be estimated.

Following the classical Wiener filter analysis, the error of the estimate of the desired audio signal x(n) is analyzed,

$$\begin{matrix}e ( n ) = x ( n ) - \hat{x} ( n ) \\ = x ( n ) - {\sum }_{k = 0}^{K} h ( k ) y ( n - k ) \\ = x ( n ) - {\sum }_{k = 0}^{K} h ( k ) ( x ( n - k ) + s ( n - k ) ) \\ = x ( n ) - {\sum }_{k = 0}^{K} h ( k ) x ( n - k ) - {\sum }_{k = 0}^{K} h ( k ) s ( n - k )\end{matrix} \qquad ( 3 )$$

wherein the observation of breaking the error term into two components originating from the desired audio signal x(n) and the additive noise signal s(n) was first seen in J. C. Chen et al., “A Minimum Distortion Noise Reduction Algorithm with Multiple Microphones,” IEEE Transactions on Audio, Speech and Language Processing, Vol. 16, No. 3, pp. 483-493, March 2008 (the entirety of which is incorporated by reference herein). The error originating from the desired audio signal x(n) is given by

$${e}_{x} ( n ) = x ( n ) - {\sum }_{k = 0}^{K} h ( k ) x ( n - k ) \qquad ( 4 )$$

and may be denoted the distortion of the desired audio signal. The error originating from the additive noise signal s(n) is given by

$${e}_{s} ( n ) = - {\sum }_{k = 0}^{K} h ( k ) s ( n - k ) \qquad ( 5 )$$

and may be denoted the residual noise signal. The total error signal is given by

e(n)=eₓ(n)+eₛ(n). (6)

The classical Wiener filter analysis focuses on minimizing the energy of the error signal e(n). By assuming independence of the desired audio signal x(n) and the additive noise signal s(n), following the Wiener analysis the energy of the error of the estimate of the desired audio signal x(n) can be written as

$$\begin{matrix}E = {\sum }_{n} {e}^{2} ( n ) \\ = {\sum }_{n} {( x ( n ) - {\sum }_{k = 0}^{K} h ( k ) y ( n - k ) )}^{2} \\ = {\sum }_{n} {( y ( n ) - s ( n ) - {\sum }_{k = 0}^{K} h ( k ) y ( n - k ) )}^{2} \\ = {\sum }_{n} {y}^{2} ( n ) + {\sum }_{n} {s}^{2} ( n ) + {\sum }_{n} {( {\sum }_{k = 0}^{K} h ( k ) y ( n - k ) )}^{2} - \\ 2 {\sum }_{n} {\sum }_{k = 0}^{K} y ( n ) h ( k ) y ( n - k ) - \\ 2 {\sum }_{n} {\sum }_{k = 0}^{K} s ( n ) h ( k ) y ( n - k ) + 2 {\sum }_{n} y ( n ) s ( n ) \\ = {\sum }_{n} {y}^{2} ( n ) - {\sum }_{n} {s}^{2} ( n ) - 2 {\sum }_{k = 0}^{K} h ( k ) {\sum }_{n} y ( n ) y ( n - k ) + \\ 2 {\sum }_{k = 0}^{K} h ( k ) {\sum }_{n} s ( n ) s ( n - k ) + {\sum }_{n} {( {\sum }_{k = 0}^{K} h ( k ) y ( n - k ) )}^{2}\end{matrix} \qquad ( 7 )$$

In vector and matrix notation, this can be written as

E=r_{y}(0)−rₛ(n)−2h^{T}r_{y}+2h^{T}rₛ+h^{T}R_{y}h (8)

wherein

$$\begin{matrix}{{R}_{\underline{\_}}}_{y} = [ \begin{matrix}{r}_{y} ( 0 ) & {r}_{y} ( 1 ) & … & {r}_{y} ( K ) \\ {r}_{y} ( 1 ) & {r}_{y} ( 0 ) & & {r}_{y} ( K - 1 ) \\ ⋮ & ⋮ & ⋱ & ⋮ \\ {r}_{y} ( K ) & {r}_{y} ( K - 1 ) & … & {r}_{y} ( 0 )\end{matrix} ] & ( 9 ) \\ {{R}_{\underline{\_}}}_{s} = [ \begin{matrix}{r}_{s} ( 0 ) & {r}_{s} ( 1 ) & … & {r}_{s} ( K ) \\ {r}_{s} ( 1 ) & {r}_{s} ( 0 ) & & {r}_{s} ( K - 1 ) \\ ⋮ & ⋮ & ⋱ & ⋮ \\ {r}_{s} ( K ) & {r}_{s} ( K - 1 ) & … & {r}_{s} ( 0 )\end{matrix} ] & ( 10 ) \\ {\underline{r}}_{y} = {[ {r}_{y} ( 0 ) , {r}_{y} ( 1 ) , … , {r}_{y} ( K ) ]}^{T} & ( 11 ) \\ {\underline{r}}_{s} = {[ {r}_{s} ( 0 ) , {r}_{s} ( 1 ) , … , {r}_{s} ( K ) ]}^{T} & ( 12 ) \\ {r}_{y} ( k ) = {\sum }_{n} y ( n ) y ( n - k ) & ( 13 ) \\ {r}_{s} ( k ) = {\sum }_{n} s ( n ) s ( n - k ) & ( 14 ) \\ \underline{h} = {[ h ( 0 ) , h ( 1 ) , … , h ( K ) ]}^{T} & ( 15 )\end{matrix}$$

By differentiating Equation 8 with respect to h and setting to zero the Wiener filter is derived:

$$\frac{\partial E}{\partial \underline{h}} = - 2 {\underline{r}}_{y} + 2 {\underline{r}}_{s} + 2 {{R}_{\underline{\_}}}_{y} \underline{h} = 0 \\ ⇓ \\ \underline{h} = {{R}_{\underline{\_}}}_{y}^{- 1} ( {\underline{r}}_{y} - {\underline{r}}_{s} ) \qquad ( 16 )$$

The statistics of y(n) may be estimated directly, as that is the input audio signal. In an embodiment in which the input audio signal is a speech signal, the statistics of s(n) may be estimated during non-speech segments and then be assumed to be sufficiently stationary to be valid during speech segments. This seems reasonable since many kinds of background noise are stationary. However, it may pose a limitation in performance for more non-stationary kinds of background noise.

The method proposed in the aforementioned article by J. C. Chen et al. uses the technique of Lagrange multipliers to perform a constrained optimization, wherein a constraint of zero distortion of the desired audio signal is enforced upon a minimization of the residual noise signal. For single channel noise suppression, this solution degenerates to the trivial unity filter (i.e., the output of the filter equals the input) and hence no noise suppression is achieved. That finding demonstrates nicely that for single channel noise suppression, it is only possible to achieve noise suppression at the expense of distortion of the desired audio signal.

Embodiments of the present invention described herein adopt an entirely different approach that provides a meaningful solution even for single channel noise suppression. The concept is to minimize the distortion of the desired audio signal while also maintaining a natural-sounding residual noise signal. A key factor in implementing this solution is to determine how to measure unnaturalness of the residual noise signal. However, by posing a question from a different angle, a viable solution can be formed: is it possible to formulate a cost function for minimization of the distortion of the desired audio signal that encourages a natural-sounding residual noise signal?

A multitude of cost functions can be constructed. A good cost function for minimizing the unnaturalness of the residual noise signal may be the squared sum of the difference between the residual noise signal and a scaled version of the original additive noise signal. The scaling would then correspond to specifying a desired noise attenuation factor in the noise suppression algorithm. Note that a scaled-down version of the original additive noise signal will sound perfectly natural. Accordingly, a cost function for minimizing the distortion of the desired audio signal may be

$${E}_{x} = {\sum }_{n} {e}_{x}^{2} ( n ) \qquad ( 17 )$$

and a cost function for minimizing the unnaturalness of the residual noise signal may be

$${E}_{s} = {\sum }_{n} {( η s ( n ) - {e}_{s} ( n ) )}^{2} \qquad ( 18 )$$

wherein η is the desired noise attenuation factor. For a desired noise attenuation of 15 decibels (dB), η=10^{(-15/20)}=0.1778.

To enable a trade-off between distortion of the desired audio signal and a specified noise attenuation factor, a weighted sum of the distortion of the desired audio signal and the measure of unnaturalness of the residual noise signal is minimized:

E=αEₓ+(1−α)Eₛ (19)

wherein α may be thought of as a parameter that specifies a degree of balance between distortion of the desired audio signal and unnaturalness of the residual noise signal. This composite cost function is minimized with respect to the noise suppression filter h(k) in a like manner to the derivation of the Wiener filter:

$$\begin{matrix}E = α ( {r}_{x} ( 0 ) + {\underline{h}}^{T} {{R}_{\underline{\_}}}_{y} \underline{h} - {\underline{h}}^{T} {{R}_{\underline{\_}}}_{s} \underline{h} - 2 {\underline{h}}^{T} {\underline{r}}_{y} + 2 {\underline{h}}^{T} {\underline{r}}_{s} ) + \\ ( 1 - α ) ( {η}^{2} {r}_{s} ( 0 ) + 2 η {\underline{h}}^{T} {\underline{r}}_{s} + {\underline{h}}^{T} {{R}_{\underline{\_}}}_{s} \underline{h} ) \\ = α {r}_{y} ( 0 ) - α {r}_{s} ( 0 ) + η ( 1 - α ) {r}_{s} ( 0 ) + α {\underline{h}}^{T} {{R}_{\underline{\_}}}_{y} \underline{h} + \\ ( 1 - 2 α ) {\underline{h}}^{T} {{R}_{\underline{\_}}}_{s} \underline{h} - 2 α {\underline{h}}^{T} {\underline{r}}_{y} + 2 {\underline{h}}^{T} {\underline{r}}_{s} ( α + η ( 1 - α ) )\end{matrix} \qquad ( 20 )$$

Differentiating the composite cost function with respect to h and setting it to zero yields

$$\frac{\partial E}{\partial \underline{h}} = 2 α {{R}_{\underline{\_}}}_{y} \underline{h} + 2 ( 1 - 2 α ) {{R}_{\underline{\_}}}_{s} \underline{h} - 2 α {\underline{r}}_{y} + 2 ( α + η ( 1 - α ) ) {\underline{r}}_{s} = \underline{0} \\ ⇓ \\ \underline{h} = {( α {{R}_{\underline{\_}}}_{y} + ( 1 - 2 α ) {{R}_{\underline{\_}}}_{s} )}^{- 1} ( α {\underline{r}}_{y} - ( η ( 1 - α ) + α ) {\underline{r}}_{s} ) \qquad ( 21 )$$

Thus, h provides one example implementation of a time domain filter that can be used to perform noise suppression in accordance with an embodiment of the present invention.

It is interesting to note that by specifying infinite noise attenuation, η=0, and setting the trade-off to α=½, the solution reduces to the legacy Wiener filter. Hence, the Wiener filter may be thought of as a special case of this new approach, or conversely, this new approach may be thought of as a novel generalized form of the Wiener filter that allows for specification of a desired noise attenuation factor as well as specification of a degree of balance between distortion of the desired audio signal and unnaturalness of the residual noise signal.

As an alternative to minimizing a weighted sum of the distortion of the desired audio signal and unnaturalness of the residual noise signal, one can also perform constrained optimization. For example, one can minimize the distortion of the desired audio signal with a constraint on the unnaturalness of the residual noise signal:

$$\underline{h} = arg {min}_{{\underline{h}}^{′}} \{ {E}_{x} ( {\underline{h}}^{′} ) \} subject to {E}_{s} ( \underline{h} ) = 0 \qquad ( 22 )$$

by using the technique of the Lagrange multiplier, i.e., by constructing the following cost function

L₁(h,λ)=Eₓ(h)+λEₛ(h), (23)

minimizing L₁(h,λ) with respect to h and λ and solving for h. Conversely, one can also minimize the unnaturalness of the residual noise signal with a constraint on the distortion of the desired audio signal:

$$\underline{h} = arg {min}_{{\underline{h}}^{′}} \{ {E}_{s} ( {\underline{h}}^{′} ) \} subject to {E}_{x} ( \underline{h} ) = 0 \qquad ( 24 )$$

by minimizing

L₂(h,λ)=Eₛ(h)+λEₓ(h) (25)

with respect to h and λ and solving for h. However, unless the constraint is linear in h, regular linear algebra techniques will not suffice to solve the system of equations. In the two Lagrange cases above it can be seen that

$$\begin{matrix}\frac{\partial {L}_{1} ( \underline{h} , λ )}{\partial λ} = {E}_{s} ( \underline{h} ) = 0 ( by design to enforce the constraint ) \\ ⇓ \\ {r}_{y} ( 0 ) - {r}_{s} ( 0 ) + {\underline{h}}^{T} {{R}_{\underline{\_}}}_{y} \underline{h} - {\underline{h}}^{T} {{R}_{\underline{\_}}}_{s} \underline{h} - 2 {\underline{h}}^{T} {\underline{r}}_{y} + 2 {\underline{h}}^{T} {\underline{r}}_{s} = 0 & ( 26 ) \\ and & \\ \frac{\partial {L}_{2} ( \underline{h} , λ )}{\partial λ} = {E}_{x} ( \underline{h} ) = 0 \\ ⇓ \\ {η}^{2} {r}_{s} ( 0 ) + 2 η {\underline{h}}^{T} {\underline{r}}_{s} + {\underline{h}}^{T} {{R}_{\underline{\_}}}_{s} \underline{h} = 0 & ( 27 )\end{matrix}$$

respectively, are both non-linear in h, and hence more complicated to solve. Hence, it may be more practical to implement the approach of minimizing a weighted sum as proposed in Equation 19 through Equation 21. For completeness, the solutions using the Lagrange multiplier in the two constrained optimization cases above would be found by solving

$$\begin{matrix}\frac{\partial {L}_{1} ( \underline{h} , λ )}{\partial \underline{h}} = \frac{\partial {E}_{x} ( \underline{h} )}{\partial \underline{h}} + λ \frac{\partial {E}_{s} ( \underline{h} )}{\partial \underline{h}} = 0 \\ \frac{\partial {L}_{1} ( \underline{h} , λ )}{\partial λ} = {E}_{s} ( \underline{h} ) = 0 & ( 28 ) \\ and & \\ \frac{\partial {L}_{2} ( \underline{h} , λ )}{\partial \underline{h}} = \frac{\partial {E}_{s} ( \underline{h} )}{\partial \underline{h}} + λ \frac{\partial {E}_{x} ( \underline{h} )}{\partial \underline{h}} = 0 \\ \frac{\partial {L}_{2} ( \underline{h} , λ )}{\partial λ} = {E}_{x} ( \underline{h} ) = 0 & ( 29 )\end{matrix}$$

respectively, with respect to h. The optimal approach to obtaining a mathematically tractable solution with the technique of the Lagrange multiplier for a constrained optimization would be to construct a constraint that is linear in h, yet perceptually meaningful in minimizing the unnaturalness of the residual noise signal, for L₁(h,λ), or minimizing the distortion of the desired audio signal, for L₂(h,λ).

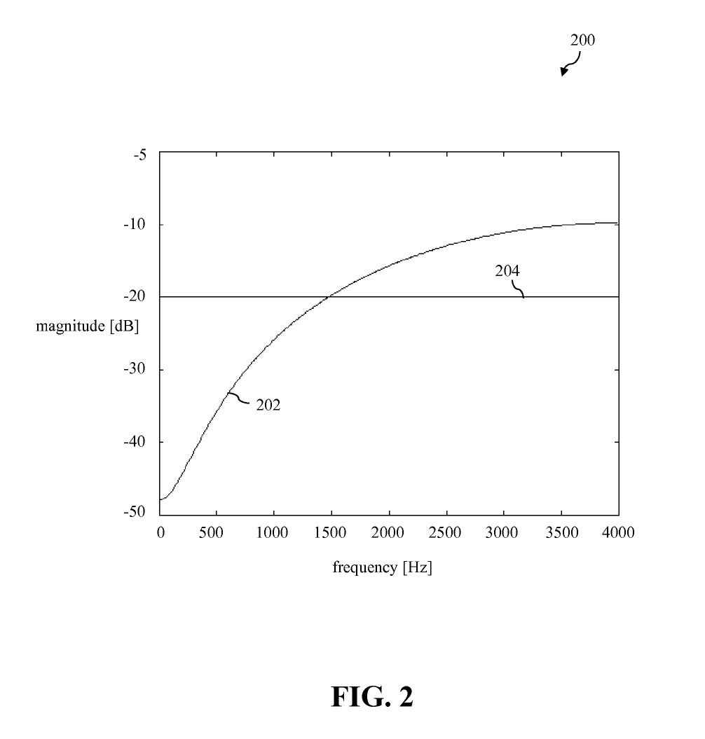

All of the above solutions, both for the cost function as a weighted sum as well as the Lagrange cost functions, were premised on a constructed cost function that reflects unnaturalness of the residual noise signal. A practical cost function for minimizing the unnaturalness of the residual noise signal was proposed in Equation 18. For the approach that minimizes a weighted sum of the distortion of the desired audio signal and the unnaturalness of the residual noise signal to be tractable, the first order derivative of the cost function must be linear in h. For the constrained optimization approach with a constraint on the unnaturalness of the residual noise signal, the cost function must be linear in h. However, for the constrained optimization approach with a constraint on the distortion of the desired audio signal, a sufficient requirement is that the first order derivative of the cost function is linear in h, but then the constraint on the distortion of the desired audio signal must be linear in h. For the approach that minimizes the weighted sum, a generalization of the cost function allows spectral shaping of the residual noise signal. FIG. 2 depicts a graph 200 that shows an example of a shaping of the residual noise signal by

Hₛ(z)=0.1778(1−0.8·z⁻¹), (30)

which is represented by the line labeled 202, in comparison to a flat attenuation of η=0.1778 (15 dB), which is represented by the line labeled 204.

Allowing spectral shaping of the residual noise signal generalizes the cost function of Equation 18 to

$${E}_{s} = {\sum }_{n} {( ( {\sum }_{{k}_{s} = 0}^{{K}_{s}} {h}_{s} ( {k}_{s} ) s ( n - {k}_{s} ) ) - {e}_{s} ( n ) )}^{2} \qquad ( 31 )$$

wherein Kₛ is the order of the shaping filter and hₛ (k) are the shaping filter coefficients. The weighted sum cost function of Equation 20 generalizes to

$$\begin{matrix}E = α {E}_{x} + ( 1 - α ) {E}_{s} \\ = α ( {r}_{y} ( 0 ) - {r}_{s} ( 0 ) + {\underline{h}}^{T} {{R}_{\underline{\_}}}_{y} \underline{h} - {\underline{h}}^{T} {{R}_{\underline{\_}}}_{s} \underline{h} - 2 {\underline{h}}^{T} {\underline{r}}_{y} + 2 {\underline{h}}^{T} {\underline{r}}_{s} ) + \\ ( 1 - α ) ( {\underline{h}}_{s}^{T} {{R}_{\underline{\_}}}_{s}^{′} {\underline{h}}_{s} + 2 {\underline{h}}_{s}^{T} {{R}_{\underline{\_}}}_{s}^{″} \underline{h} + {\underline{h}}^{T} {{R}_{\underline{\_}}}_{s} \underline{h} )\end{matrix} \qquad ( 32 )$$

where hₛ=[hₛ(0),hₛ(1), . . . , hₛ(Kₛ)]^{T} contains the impulse response of the shaping filter and R′ₛ and R″ₛ are size-adjusted versions of Rₛ that are introduced to account for any difference between Kₛ and K, i.e., the difference in order between the shaping filter and the noise suppression filter. Accordingly, Rₛ is a (K+1)×(K+1) matrix, R′ₛ is a (Kₛ+1)×(Kₛ+1) matrix, and R″ₛ is a (Kₛ+1)×(K+1) matrix, but common cells of the three matrices have identical elements. The derivative of E with respect to h is given below along with the solution for h:

$$\frac{\partial E}{\partial \underline{h}} = α ( 2 {{R}_{\underline{\_}}}_{y} \underline{h} - 2 {{R}_{\underline{\_}}}_{s} \underline{h} - 2 {\underline{r}}_{y} + 2 {\underline{r}}_{s} ) + ( 1 - α ) ( 2 {{R}_{\underline{\_}}}_{s} \underline{h} + 2 {{R}_{\underline{\_}}}_{s}^{″ T} {\underline{h}}_{s} ) = 0 \\ ⇓ \\ \underline{h} = {( α {{R}_{\underline{\_}}}_{y} + ( 1 - 2 α ) {{R}_{\underline{\_}}}_{s} )}^{- 1} ( α ( {\underline{r}}_{y} - {\underline{r}}_{s} ) - ( 1 - α ) {{R}_{\underline{\_}}}_{s}^{″ T} {\underline{h}}_{s} ) \qquad ( 33 )$$

One practical implementation uses α=0.125 for Equation 21 and Equation 33, η=0.1778 for Equation 21, and the shaping filter given by Equation 30 for Equation 33.

An alternative formulation for deriving a time domain filter for single-channel noise suppression will now be described. Having inherently defined the optimal output as the sum of the desired audio signal and a scaled or filtered version of the original additive noise signal, it seems appropriate to go back and revisit the key equation for the overall error of the noise suppression process, i.e., Equation 3. The error can be expressed as

$$\begin{matrix}e ( n ) = ( x ( n ) + {\sum }_{{k}_{s} = 0}^{{K}_{s}} {h}_{s} ( {k}_{s} ) s ( n - {k}_{s} ) ) - \hat{x} ( n ) \\ = x ( n ) + {\sum }_{{k}_{s} = 0}^{{K}_{s}} {h}_{s} ( {k}_{s} ) s ( n - {k}_{s} ) - {\sum }_{k = 0}^{K} h ( k ) y ( n - k ) \\ = x ( n ) + {\sum }_{{k}_{s} = 0}^{{K}_{s}} {h}_{s} ( {k}_{s} ) s ( n - {k}_{s} ) - {\sum }_{k = 0}^{K} h ( k ) ( x ( n - k ) + s ( n - k ) ) \\ = x ( n ) - {\sum }_{k = 0}^{K} h ( k ) x ( n - k ) + {\sum }_{{k}_{s} = 0}^{{K}_{s}} {h}_{s} ( {k}_{s} ) s ( n - {k}_{s} ) - \\ {\sum }_{k = 0}^{K} h ( k ) s ( n - k )\end{matrix} \qquad ( 34 )$$

wherein \hat{x}(n) is the output of the noise suppressor, x(n) is the target for the desired audio signal, and

$${\sum }_{{k}_{s} = 0}^{{K}_{s}} {h}_{s} ( {k}_{s} ) s ( n - {k}_{s} )$$

is the target for the residual noise signal. As noted previously, the target for the residual noise signal could be a spectrally flat attenuation, i.e., hₛ(0)=η and hₛ(k)=0 for k≠0. As can be seen, the formulation of Equation 34 directly includes the cost function signals. In accordance with this formulation, the distortion of the desired audio signal is defined as

$${e}_{x} ( n ) = x ( n ) - {\sum }_{k = 0}^{K} h ( k ) x ( n - k ) \qquad ( 35 )$$

(which is identical to Equation 4) and the unnaturalness of the residual noise signal is now defined as

$${e}_{s} ( n ) = {\sum }_{{k}_{s} = 0}^{{K}_{s}} {h}_{s} ( {k}_{s} ) s ( n - {k}_{s} ) - {\sum }_{k = 0}^{K} h ( k ) s ( n - k ) . \qquad ( 36 )$$

The effective difference is a change of sign, as can be seen by comparing Equation 36 to Equation 31 with the insertion of Equation 5.

Equivalent to Equation 19, the following error term is minimized:

$$\begin{matrix}E = α {E}_{x} + ( 1 - α ) {E}_{s} \\ = α {\sum }_{n} {e}_{x}^{2} ( n ) + ( 1 - α ) {\sum }_{n} {e}_{s}^{2} ( n )\end{matrix} \qquad ( 37 )$$

which, with previously-introduced vector and matrix notation, may be written as

$$\begin{matrix}E = α ( {r}_{y} ( 0 ) - {r}_{s} ( 0 ) + {\underline{h}}^{T} {{R}_{\underline{\_}}}_{y} \underline{h} - {\underline{h}}^{T} {{R}_{\underline{\_}}}_{s} \underline{h} - 2 {\underline{h}}^{T} {\underline{r}}_{y} + 2 {\underline{h}}^{T} {\underline{r}}_{s} ) \\ = + ( 1 - α ) ( {\underline{h}}_{s}^{T} {{R}_{\underline{\_}}}_{s}^{′} {\underline{h}}_{s} - 2 {\underline{h}}_{s}^{T} {{R}_{\underline{\_}}}_{s}^{″} \underline{h} + {\underline{h}}^{T} {{R}_{\underline{\_}}}_{s} \underline{h} )\end{matrix} \qquad ( 38 )$$

The similarity with Equation 32 is apparent and the derivative with respect to h is calculated and set to zero in order to solve for the optimal h:

$$\begin{matrix}\frac{\partial E}{\partial \underline{h}} = α ( 2 {{R}_{\underline{\_}}}_{y} \underline{h} - 2 {{R}_{\underline{\_}}}_{s} \underline{h} - 2 {\underline{r}}_{y} + 2 {\underline{r}}_{s} ) + ( 1 - α ) ( 2 {{R}_{\underline{\_}}}_{s} \underline{h} - 2 {{R}_{\underline{\_}}}_{s}^{″ T} {\underline{h}}_{s} ) \\ = 0\end{matrix} \\ ⇓ \\ \underline{h} = {( α {{R}_{\underline{\_}}}_{y} + ( 1 - 2 α ) {{R}_{\underline{\_}}}_{s} )}^{- 1} ( α ( {\underline{r}}_{y} - {\underline{r}}_{s} ) + ( 1 - α ) {{R}_{\underline{\_}}}_{s}^{″ T} {\underline{h}}_{s} ) \qquad ( 39 )$$

Similar to the previously-derived time domain filter, the Wiener solution is a special case, obtained with a parameter setting of α=0.5 and hₛ=0. This corresponds to infinite noise attenuation and weighing distortion of the desired audio signal and unnaturalness of the residual noise signal equally.

2. Example Single-Channel Noise Suppressor that Uses a Time Domain Filter

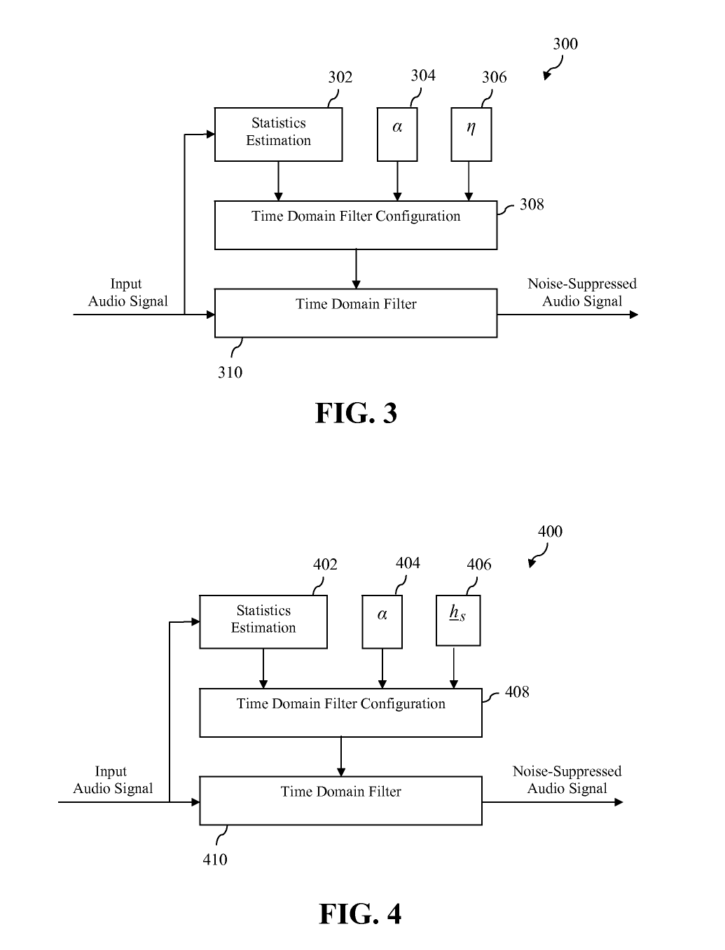

FIG. 3 is a block diagram of an example single-channel noise suppressor 300 that uses a time domain filter in accordance with an embodiment of the present invention. Noise suppressor 300 may comprise, for example, a particular implementation of noise suppressor 102 of system 100 as described above in reference to FIG. 1. Generally speaking, noise suppressor 300 operates to receive a time domain representation of an input audio signal that comprises a desired audio signal and an additive noise signal, to pass the time domain representation of the input audio signal through a time domain filter to generate a noise-suppressed audio signal, the time domain filter having an impulse response that is controlled by at least a parameter that specifies a degree of balance between distortion of the desired audio signal and unnaturalness of a residual noise signal in the noise-suppressed audio signal, and to output the noise-suppressed audio signal. As shown in FIG. 3, noise suppressor 300 comprises a number of interconnected components including a statistics estimation module 302, a first parameter provider module 304, a second parameter provider module 306, a time domain filter configuration module 308, and a time domain filter 310.

Statistics estimation module 302 is configured to calculate estimates of statistics associated with the input audio signal and the additive noise signal for use by time domain filter configuration module 308 in configuring time domain filter 310. The calculation of estimates may occur on some periodic or non-periodic basis depending upon a control scheme. In an embodiment, statistics estimation module 302 estimates statistics through correlation of the time domain representation of the input audio signal and correlation of a time domain representation of the additive noise signal. For example, statistics estimation module 302 may estimate r_{y}(k) through correlation of input audio signal y(n) as illustrated in Equation 13 and estimate rₛ (k) through correlation of additive noise signal s(n) as illustrated in Equation 14. These values can then be used to construct matrices R_{y} and Rₛ (see Equations 9 and 10) and vectors r_{y} and rₛ (see Equations 11 and 12), which can then be used by time domain filter configuration module 308 to configure a time domain filter such as that represented by Equation 21.

Statistics estimation module 302 may estimate the statistics of the input audio signal and the additive noise signal across a number of segments of the input audio signal. A sliding window approach may be used to select the segments. Statistics estimation module 302 may update the estimated statistics each time a new segment (e.g., each time a new frame) of the input audio signal is received. However, this example is not intended to be limiting, and the frequency with which the statistics are updated may vary depending upon the implementation.

Statistics estimation module 302 can estimate the statistics of the received input audio signal directly. In an embodiment in which the input audio signal is a speech signal, statistics estimation module 302 may estimate the statistics of the additive noise signal during non-speech segments, premised on the assumption that the additive noise signal will be sufficiently stationary during valid speech segments. In accordance with such an embodiment, statistics estimation module 302 may include functionality that is capable of classifying segments of the input audio signal as speech or non-speech segments. Alternatively, statistics estimation module 302 may be connected to another entity that is capable of performing such a function. Of course, numerous other methods may be used to estimate the statistics of the additive noise signal.

First parameter provider module 304 is configured to obtain a value of a parameter α that specifies a degree of balance between distortion of the desired audio signal included in the input audio signal and unnaturalness of a residual noise signal included in the output noise-suppressed audio signal and to provide the value of the parameter α to time domain filter configuration module 308. By way of example only, the parameter α may be that discussed above and utilized in the time domain filter representation of Equation 21.

In one embodiment, the value of the parameter α comprises a fixed aspect of noise suppressor 300 that is determined during a design or tuning phase associated with that component. Alternatively, the value of the parameter α may be determined in response to some form of user input (e.g., responsive to user control of settings of a device that includes noise suppressor 300). In a still further embodiment, first parameter provider module 304 adaptively determines the value of the parameter α based at least in part on characteristics of the input audio signal. For example, in an embodiment in which the input audio signal comprises a speech signal, first parameter provider module 304 may vary the value of the parameter α such that an increased emphasis is placed on minimizing the distortion of the desired speech signal during speech segments and such that an increased emphasis is placed on minimizing the unnaturalness of the residual noise signal during non-speech segments. Still other adaptive schemes for setting the value of parameter α may be used.

Second parameter provider module 306 is configured to obtain a value of a parameter η that specifies an amount of attenuation to be applied to the additive noise signal included in the input audio signal and to provide the value of the parameter η to time domain filter configuration module 308. By way of example only, the parameter η may be that discussed above and utilized in the time domain filter representation of Equation 21.

In one embodiment, the value of the parameter η comprises a fixed aspect of noise suppressor 300 that is determined during a design or tuning phase associated with that component. Alternatively, the value of the parameter η may be determined in response to some form of user input (e.g., responsive to user control of settings of a device that includes noise suppressor 300). In a still further embodiment, second parameter provider module 306 adaptively determines the value of the parameter η based at least in part on characteristics of the input audio signal.

In certain embodiments, first parameter provider module 304 determines a value of the parameter α based on a current value of the parameter η. Such an embodiment takes into account that certain values of α may provide a better trade-off between distortion of the desired audio signal and unnaturalness of the residual noise signal at different levels of noise attenuation. For example, as the value of η increases (i.e., as the amount of noise attenuation is increased), it may be deemed desirable to reduce the value of the γ parameter (i.e., to place more of an emphasis on reducing the unnaturalness of the residual noise signal). This is only one example, however. A scheme that derives the value of the parameter α based on the value of the parameter η may also be useful for facilitating user control of noise suppression since controlling the amount of noise attenuation may be a more intuitive and understandable operation to a user than controlling the trade-off between distortion of the desired audio signal and unnaturalness of the residual noise signal.

Time domain filter configuration module 308 is configured to obtain estimates of statistics associated with the input audio signal and the additive noise signal from statistics estimation module 302, the value of the parameter α that specifies the degree of balance between the distortion of the desired audio signal and the unnaturalness of the residual noise signal provided by first parameter provider module 304, and the value of the parameter η that specifies the amount of attenuation to be applied to the additive noise signal provided by second parameter provider module 306 and to use those values to configure time domain filter 310. For example, time domain filter configuration module 308 may use these values to configure time domain filter 310 in accordance with Equation 21, although this is only one example. Time domain filter configuration module 308 may re-configure time domain filter 310 each time a new segment of the input audio signal is received or in accordance with some other periodic or non-periodic control scheme.

Time domain filter 310 is configured to filter the input audio signal to generate and output a noise-suppressed audio signal. As discussed above, the filtering process performed by time domain filter 310 may be controlled by the estimates of statistics associated with the input audio signal and the additive noise signal from statistics estimation module 302, the value of the parameter α that specifies the degree of balance between the distortion of the desired audio signal and the unnaturalness of the residual noise signal provided by first parameter provider module 304, and the value of the parameter η that specifies the amount of attenuation to be applied to the additive noise signal provided by second parameter provider module 306.

FIG. 4 is a block diagram of an alternate example single-channel noise suppressor 400 that uses a time domain filter in accordance with an embodiment of the present invention. Noise suppressor 400 may also comprise, for example, a particular implementation of noise suppressor 102 of system 100 as described above in reference to FIG. 1. Like noise suppressor 300, noise suppressor 400 operates to receive a time domain representation of an input audio signal that comprises a desired audio signal and an additive noise signal, to pass the time domain representation of the input audio signal through a time domain filter to generate a noise-suppressed audio signal, the time domain filter having an impulse response that is controlled by at least a parameter that specifies a degree of balance between distortion of the desired audio signal and unnaturalness of a residual noise signal in the noise-suppressed signal, and to output the noise-suppressed audio signal.

As shown in FIG. 4, noise suppressor 400 comprises a number of interconnected components including a statistics estimation module 402, a first parameter provider module 404, a noise shaping filter provider module 406, a time domain filter configuration module 408, and a time domain filter 410. Statistics estimation module 402, first parameter provider module 404, time domain filter configuration module 408 and time domain filter 410 respectively operate in essentially the same fashion as statistics estimation module 302, first parameter provider module 304, time domain filter configuration module 308 and time domain filter 310 as described above in reference to noise suppressor 300 of FIG. 3, with exceptions to be described below.

In noise suppressor 400, noise shaping filter provider module 406 is configured to provide parameters associated with a noise shaping filter hₛ to time domain filter configuration module 408 for use in configuring time domain filter 410. For example, time domain filter configuration module 408 may utilize the parameters of the noise shaping filter noise shaping filter hₛ to configure time domain filter 410 in accordance with Equation 33 as previously described. In contrast to noise suppressor 300 which uses a noise attenuation factor η, noise suppressor 400 allows for arbitrary shaping of the residual noise signal through provision of the noise shaping filter hₛ. Depending upon the implementation, the noise shaping filter hₛ may be specified during design or tuning of a device that includes noise suppressor 400, determined based on some form of user input, or adaptively determined based on at least characteristics associated with the input audio signal.

3. Example Methods for Performing Single-Channel Noise Suppression in the Time Domain

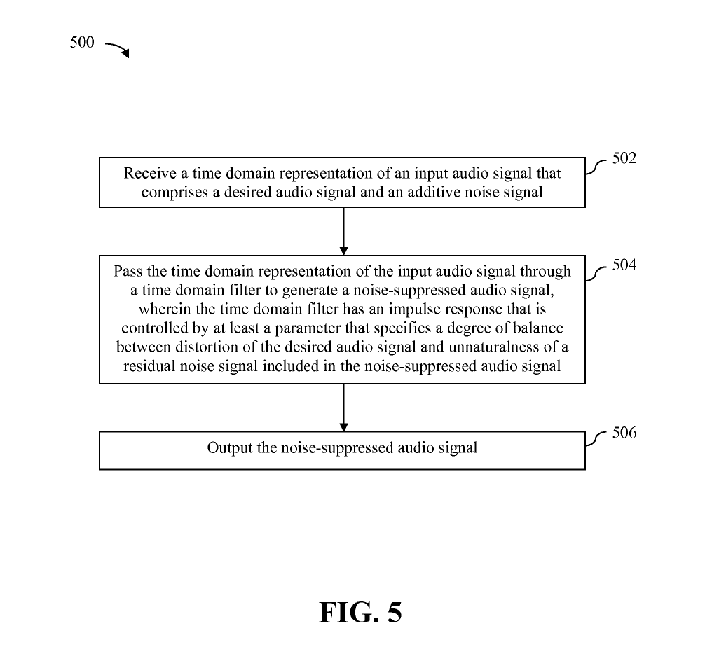

FIG. 5 depicts a flowchart 500 of a method for performing single-channel noise suppression in the time domain in accordance with an embodiment of the present invention. The method of flowchart 500 may be performed, for example and without limitation, by noise suppressor 300 as described above in reference to FIG. 3 or noise suppressor 400 as described above in reference to FIG. 4. However, the method is not limited to those implementations.

As shown in FIG. 5, the method of flowchart 500 begins at step 502 in which a time domain representation of an input audio signal is received, wherein the input audio signal comprises a desired audio signal and an additive noise signal.

At step 504, the time domain representation of the input audio signal is passed through a time domain filter to generate a noise-suppressed audio signal, wherein the time domain filter has an impulse response that is controlled by at least a parameter that specifies a degree of balance between distortion of the desired audio signal and unnaturalness of a residual noise signal included in the noise-suppressed audio signal. For example, the time domain filter may be either of the time domain filters represented by Equation 21 or 33 and the parameter that specifies the degree of balance between the distortion of the desired audio signal and the unnaturalness of the residual noise signal may comprise the parameter α included in those equations. However, these are examples only and other time domain filters may be used.

Depending upon the implementation, the parameter that specifies the degree of balance between the distortion of the desired audio signal and the unnaturalness of the residual noise signal may be determined in a variety of ways. For example, the parameter that specifies the degree of balance between the distortion of the desired audio signal and the unnaturalness of the residual noise signal may be determined based at least in part on characteristics of the input audio signal.

In certain embodiments, step 504 involves passing the time domain representation of the input audio signal through a time domain filter having an impulse response that is controlled by at least the parameter that specifies the degree of balance between the distortion of the desired audio signal and the unnaturalness of the residual noise signal and a noise attenuation factor. For example, the time domain filter may be the time domain filter represented by Equation 21 and the noise attenuation factor may comprise the parameter η included in that equation. However, this is one example only and other time domain filters that include a noise attenuation factor may be used. In certain embodiments, the value of the parameter that specifies the degree of balance between the distortion of the desired audio signal and the unnaturalness of the residual noise signal is determined based on the value of the noise attenuation factor.

In other embodiments, step 504 involves passing the time domain representation of the input audio signal through a time domain filter having an impulse response that is controlled by at least the parameter that specifies the degree of balance between the distortion of the desired audio signal and the unnaturalness of the residual noise signal and a noise shaping filter. For example, the time domain filter may be the time domain filter represented by Equation 33 and the noise shaping filter may comprise the filter hₛ included in that equation. However, this is one example only and other time domain filters that include a noise shaping filter may be used.

In certain implementations, the method of flowchart 500 further includes estimating statistics comprising correlation of the time domain representation of the input audio signal and correlation of a time domain representation of the additive noise signal. For example and without limitation, this estimation of statistics may comprise estimating r_{y} (k) through correlation of input audio signal y(n) as illustrated in Equation 13 and estimating rₛ(k) through correlation of additive noise signal s(n) as illustrated in Equation 14. These values can then be used to construct matrices R_{y} and Rₛ (see Equations 9 and 10) and vectors r_{y} and rₛ (see Equations 11 and 12), which can then be used to implement a time domain filter such as that represented by Equation 21 or Equation 33.

In accordance with such an implementation, step 504 may involve passing the time domain representation of the input audio signal through a time domain filter having an impulse response that is a function of at least the parameter that specifies the degree of balance between the distortion of the desired audio signal and the unnaturalness of the residual noise signal and at least some of the estimated statistics.

At step 506, the noise-suppressed audio signal generated during step 504 is output. Depending upon the implementation, the noise-suppressed audio signal may then be further processed, stored, transmitted to a remote entity, or played back to a user.

### C. Dual-Channel Noise Suppression in the Time Domain in Accordance with Embodiments of the Present Invention

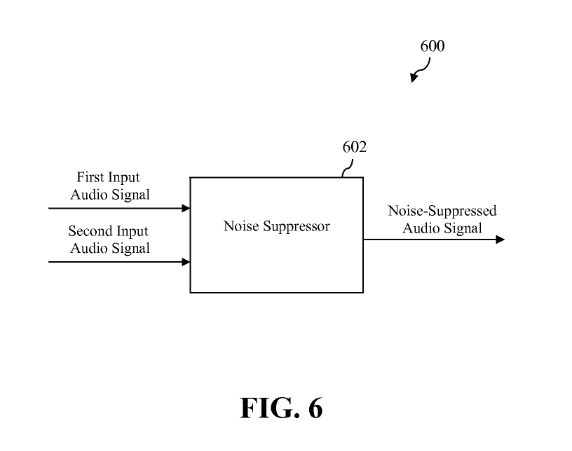

FIG. 6 is a high-level block diagram of a dual-channel noise suppression system 600 in accordance with an embodiment of the present invention. As shown in FIG. 6, system 600 includes a noise suppressor 602 that receives a first input audio signal and a second input audio signal. The first input audio signal comprises a first desired audio signal and a first additive noise signal while the second input audio signal comprises a second desired audio signal and a second additive noise signal. The first input audio signal may be received, for example, from a first microphone or may be derived from an audio signal that is received from a first microphone and the second input audio signal may be received, for example, from a second microphone or may be derived from an audio signal that is received from a second microphone.

As will be discussed in more detail herein, noise suppressor 602 processes the first input audio signal to generate a first processed audio signal in a manner that is controlled by at least a parameter that specifies a degree of balance between distortion of the first desired audio signal and unnaturalness of a residual noise signal included in a noise-suppressed audio signal. Noise suppressor 602 also processes the second input audio signal to generate a second processed audio signal in a manner that is controlled by at least the parameter that specifies the degree of balance between the distortion of the first desired audio signal and the unnaturalness of the residual noise signal. Noise suppressor 602 then combines the first processed audio signal and the second processed audio signal to produce the noise-suppressed signal for output.

Noise suppression system 600 may be implemented in any system or device that operates to process audio signals for transmission, storage and/or playback to a user. For example and without limitation, noise suppression system 600 may be implemented in a telecommunications device, such as a cellular telephone or headset that processes input speech signals for subsequent transmission to a remote telecommunications device via a network, although this is merely an example. Noise suppression system 600 may be implemented in hardware using analog and/or digital circuits, in software, through the execution of instructions by one or more general purpose or special-purpose processors, or as a combination of hardware and software.

In embodiments to be described in this section, noise suppressor 602 operates to pass a time domain representation of the first input audio signal through a first time domain filter having an impulse response that is controlled by at least the parameter that specifies the degree of balance between the distortion of the desired audio signal and the unnaturalness of the residual noise signal and to pass a time domain representation of the second input audio signal through a second time domain filter having an impulse response that is also controlled by at least the parameter that specifies the degree of balance between the distortion of the desired audio signal and the unnaturalness of the residual noise signal. In the following, exemplary derivations of the two time domain filters will first be described. An exemplary implementation of noise suppressor 602 that utilizes such time domain filters will then be described. Finally, exemplary methods for performing dual-channel noise suppression in the time domain will be described.

1. Example Derivation of Time Domain Filters for Dual-Channel Noise Suppression

With two physically disjoint observations, additional information is inherently available. Consider two microphones with outputs y₁(n) and y₂(n), respectively. The noise, s₁(n) and s₂(n), and desired audio components, x₁(n) and x₂(n), at the microphones are additive. Furthermore, the two desired audio signals, x₁(n) and x₂(n), originate from a single desired source, x(n), but due to the physical dislocation of the two microphones, the acoustic coupling between the source and the two microphones is different. The acoustic coupling is modeled by an impulse response, g₁(n) and g₂(n), respectively. Hence, the two observations are given by

y₁(n)=x₁(n)+s₁(n)=g₁(k)*x(n)+s₁(n)

y₂(n)=x₂(n)+s₂(n)=g₂(k)*x(n)+s₂(n) (40)

By attempting to estimate x(n), the acoustic coupling between the source and the microphones would be considered and de-reverberation would be performed. This may be advantageous since reverberation in some cases can be objectionable and decrease intelligibility and/or increase listener fatigue. It is, however, a difficult task that further complicates the problem. Furthermore, referring to traditional single channel noise suppression, the goal is commonly to estimate the desired source at the microphone (and not at the location of the source, although the two may be approximately co-located in traditional handheld telephony). To provide direct comparison to the previously-described derivation of a time domain filter for a single channel, the present treatment will aim at estimating the desired source at a microphone, and hence, the developed method will not be capable of performing any de-reverberation. Note that the idea of estimating the desired source at a microphone for multi-microphone noise suppression was previously described in J. C. Chen et al., “A Minimum Distortion Noise Reduction Algorithm with Multiple Microphones,” IEEE Transactions on Audio, Speech and Language Processing, Vol. 16, No. 3, pp. 483-493, March 2008. However, that approach has often been the common approach for single-microphone noise suppression.

Without loss of generality, the following will aim at estimating the desired source at the first microphone, i.e., at estimating x₁(n). Similar to single-channel noise suppression in the time domain, this is achieved with FIR filtering, except that now two filters, h₁(k₁) and h₂(k₂), are used:

$${\hat{x}}_{1} ( n ) = {\sum }_{{k}_{1} = 0}^{{K}_{1}} {h}_{1} ( {k}_{1} ) {y}_{1} ( n - {k}_{1} ) + {\sum }_{{k}_{2} = 0}^{{K}_{21}} {h}_{2} ( {k}_{2} ) {y}_{2} ( n - {k}_{2} ) , \qquad ( 41 )$$

exploiting the signals from both microphones. The objective is to estimate

h₁=[h₁(0),h₁(1), . . . ,h₁(K₁)]T, and (42)

h₂=[h₂(0),h₂(1), . . . ,h₂(K₂)]^{T} (43)

according to a suitable cost function, so that satisfactory noise suppression is achieved.

In a like manner to that shown in Equation 3, the error signal is broken into two components, distortion of the desired audio signal and residual noise, in accordance with

$$\begin{matrix}e ( n ) = {x}_{1} ( n ) - {\hat{x}}_{1} ( n ) \\ = {x}_{1} ( n ) - {\sum }_{{k}_{1} = 0}^{{K}_{1}} {h}_{1} ( {k}_{1} ) {y}_{1} ( n - {k}_{1} ) - {\sum }_{{k}_{2} = 0}^{{K}_{2}} {h}_{2} ( {k}_{2} ) {y}_{2} ( n - {k}_{2} ) \\ = {x}_{1} ( n ) - {\sum }_{{k}_{1} = 0}^{{K}_{1}} {h}_{1} ( {k}_{1} ) ( {x}_{1} ( n - {k}_{1} ) + {s}_{1} ( n - {k}_{1} ) ) - \\ {\sum }_{{k}_{2} = 0}^{{K}_{2}} {h}_{2} ( {k}_{2} ) ( {x}_{2} ( n - {k}_{2} ) + {s}_{2} ( n - {k}_{2} ) ) \\ = {x}_{1} ( n ) - {\sum }_{{k}_{1} = 0}^{{K}_{1}} {h}_{1} ( {k}_{1} ) {x}_{1} ( n - {k}_{1} ) - {\sum }_{{k}_{2} = 0}^{{K}_{2}} {h}_{2} ( {k}_{2} ) {x}_{2} ( n - {k}_{2} ) - \\ {\sum }_{{k}_{1} = 0}^{{K}_{1}} {h}_{1} ( {k}_{1} ) {s}_{1} ( n - {k}_{1} ) - {\sum }_{{k}_{2} = 0}^{{K}_{2}} {h}_{2} ( {k}_{2} ) {s}_{2} ( n - {k}_{2} )\end{matrix} \qquad ( 44 )$$

Distortion of the desired audio signal is defined as

$${e}_{{x}_{1}} ( n ) = {x}_{1} ( n ) - {\sum }_{{k}_{1} = 0}^{{K}_{1}} {h}_{1} ( {k}_{1} ) {x}_{1} ( n - {k}_{1} ) - {\sum }_{{k}_{2} = 0}^{{K}_{2}} {h}_{2} ( {k}_{2} ) {x}_{2} ( n - {k}_{2} ) \qquad ( 45 )$$

and the residual noise signal is defined as

$${e}_{s} ( n ) = - {\sum }_{{k}_{1} = 0}^{{K}_{1}} {h}_{1} ( {k}_{1} ) {s}_{1} ( n - {k}_{1} ) - {\sum }_{{k}_{2} = 0}^{{K}_{2}} {h}_{2} ( {k}_{2} ) {s}_{2} ( n - {k}_{2} ) \qquad ( 46 )$$

such that

e(n)=eₓ_{₁}(n)+eₛ(n). (47)

Similar to single-channel noise suppression in the time domain, the cost function for distortion of the desired audio signal may be defined as:

$$\begin{matrix}{E}_{{x}_{1}} = {\sum }_{n} {e}_{{x}_{1}}^{2} ( n ) \\ = {\sum }_{n} {( {x}_{1} ( n ) - {\sum }_{{k}_{1} = 0}^{{K}_{1}} {h}_{1} ( {k}_{1} ) {x}_{1} ( n - {k}_{1} ) - {\sum }_{{k}_{2} = 0}^{{K}_{2}} {h}_{2} ( {k}_{2} ) {x}_{2} ( n - {k}_{2} ) )}^{2} \\ = {\sum }_{n} {x}_{1}^{2} ( n ) + {\sum }_{n} {( {\sum }_{{k}_{1} = 0}^{{K}_{1}} {h}_{1} ( {k}_{1} ) {x}_{1} ( n - {k}_{1} ) )}^{2} + \\ {\sum }_{n} {( {\sum }_{{k}_{2} = 0}^{{K}_{2}} {h}_{2} ( {k}_{2} ) {x}_{2} ( n - {k}_{2} ) )}^{2} - \\ 2 {\sum }_{n} {\sum }_{{k}_{1} = 0}^{{K}_{1}} {x}_{1} ( n ) {h}_{1} ( {k}_{1} ) {x}_{1} ( n - {k}_{1} ) - \\ 2 {\sum }_{n} {\sum }_{{k}_{2} = 0}^{{K}_{2}} {x}_{1} ( n ) {h}_{2} ( {k}_{2} ) {x}_{2} ( n - {k}_{2} ) + \\ 2 {\sum }_{n} {\sum }_{{k}_{1} = 0}^{{K}_{1}} {\sum }_{{k}_{2} = 0}^{{K}_{2}} {h}_{1} ( {k}_{1} ) {x}_{1} ( n - {k}_{1} ) {h}_{2} ( {k}_{2} ) {x}_{2} ( n - {k}_{2} )\end{matrix} \qquad ( 48 )$$

Re-ordering of the summation yields

$${E}_{{x}_{1}} = {\sum }_{n} {x}_{1}^{2} ( n ) + {\sum }_{{k}_{1} = 0}^{{K}_{1}} {\sum }_{{k}_{2} = 0}^{{K}_{2}} {h}_{1} ( {k}_{1} ) {h}_{1} ( {k}_{2} ) {\sum }_{n} {x}_{1} ( n - {k}_{1} ) {x}_{1} ( n - {k}_{2} ) + {\sum }_{{k}_{1} = 0}^{{K}_{1}} {\sum }_{{k}_{2} = 0}^{{K}_{2}} {h}_{2} ( {k}_{1} ) {h}_{2} ( {k}_{2} ) {\sum }_{n} {x}_{2} ( n - {k}_{1} ) {x}_{2} ( n - {k}_{2} ) - 2 {\sum }_{{k}_{1} = 0}^{{K}_{1}} {h}_{1} ( {k}_{1} ) {\sum }_{n} {x}_{1} ( n ) {x}_{1} ( n - {k}_{1} ) - 2 {\sum }_{{k}_{2} = 0}^{{K}_{2}} {h}_{2} ( {k}_{2} ) {\sum }_{n} {x}_{1} ( n ) {x}_{2} ( n - {k}_{2} ) + 2 {\sum }_{{k}_{1} = 0}^{{K}_{1}} {\sum }_{{k}_{2} = 0}^{{K}_{2}} {h}_{1} ( {k}_{1} ) {h}_{2} ( {k}_{2} ) {\sum }_{n} {x}_{1} ( n - {k}_{1} ) {x}_{2} ( n - {k}_{2} ) . \qquad ( 49 )$$

### Utilizing

$${r}_{x , y} ( k ) = {\sum }_{n} x ( n ) y ( n - k ) \\ {R}_{x , y} ( {k}_{1} , {k}_{2} ) = {\sum }_{n} x ( n - {k}_{1} ) y ( n - {k}_{2} ) \\ {\underline{r}}_{x , y} = [ {r}_{x , y} ( 0 ) , {r}_{x , y} ( 1 ) , … , {r}_{x , y} ( K ) ] \\ \begin{matrix}{{R}_{\underline{\_}}}_{x , y} = [ \begin{matrix}{R}_{x , y} ( 0 , 0 ) & {R}_{x , y} ( 0 , 1 ) & ⋯ & {R}_{x , y} ( 0 , {K}_{2} ) \\ {R}_{x , y} ( 1 , 0 ) & {R}_{x , y} ( 1 , 1 ) & ⋯ & {R}_{x , y} ( 1 , {K}_{2} ) \\ ⋮ & ⋮ & ⋱ & ⋮ \\ {R}_{x , y} ( {K}_{1} , 0 ) & {R}_{x , y} ( {K}_{1} , 1 ) & ⋯ & {R}_{x , y} ( {K}_{1} , {K}_{2} )\end{matrix} ] \\ = [ \begin{matrix}{R}_{x , y} ( 0 , 0 ) & {R}_{x , y} ( 0 , 1 ) & ⋯ & {R}_{x , y} ( 0 , {K}_{2} ) \\ {R}_{x , y} ( 1 , 0 ) & {R}_{x , y} ( 0 , 0 ) & ⋯ & {R}_{x , y} ( 0 , {K}_{2} - 1 ) \\ ⋮ & ⋮ & ⋱ & ⋮ \\ {R}_{x , y} ( {K}_{1} , 0 ) & {R}_{x , y} ( {K}_{1} - 1 , 0 ) & ⋯ & {R}_{x , y} ( 0 , 0 )\end{matrix} ]\end{matrix} \qquad ( 50 )$$

the distortion of the desired audio signal of Equation 49 can be expressed as

Eₓ_{₁}=rₓ_{₁}(0)+h₁^{T}Rₓ_{₁}h₁+h₂^{T}Rₓ_{₂}h₂−2h₁^{T}rₓ_{₁}−2h₂^{T}rₓ_{₁}_{,x}_{₂}+2h₁^{T}Rₓ_{₁}_{,x}_{₂}h₂. (51)

For ease of notation, autocorrelation is only denoted by a single signal subscript, i.e., Rₓ=R_{x,x}r_{X}=r_{x,x} and rₓ(k)=r_{x,x}(k). If the desired audio source and the additive noise at the microphones are assumed to be independent, then Equation 51 can be re-written as

$${E}_{{x}_{1}} = {r}_{{y}_{1}} ( 0 ) - {r}_{{s}_{1}} ( 0 ) + {\underline{h}}_{1}^{T} ( {{R}_{\underline{\_}}}_{{y}_{1}} - {{R}_{\underline{\_}}}_{{s}_{1}} ) {\underline{h}}_{1} + {\underline{h}}_{2}^{T} ( {{R}_{\underline{\_}}}_{{y}_{2}} - {{R}_{\underline{\_}}}_{{s}_{2}} ) {\underline{h}}_{2} - 2 {\underline{h}}_{1}^{T} ( {\underline{r}}_{{y}_{1}} - {\underline{r}}_{{s}_{1}} ) - 2 {\underline{h}}_{2}^{T} ( {\underline{r}}_{{y}_{1} , {y}_{2}} - {\underline{r}}_{{s}_{1} , {s}_{2}} ) + 2 {\underline{h}}_{1}^{T} ( {{R}_{\underline{\_}}}_{{y}_{1} , {y}_{2}} - {{R}_{\underline{\_}}}_{{s}_{1} , {s}_{2}} ) {\underline{h}}_{2} . \qquad ( 52 )$$

From Equation 52, the derivatives with respect to h₁ and h₂ are derived:

$$\frac{\partial {E}_{{x}_{1}}}{\partial {\underline{h}}_{1}} = 2 ( {{R}_{\underline{\_}}}_{{y}_{1}} - {{R}_{\underline{\_}}}_{{s}_{1}} ) {\underline{h}}_{1} - 2 ( {\underline{r}}_{{y}_{1}} - {\underline{r}}_{{s}_{1}} ) + 2 ( {{R}_{\underline{\_}}}_{{y}_{1} , {y}_{2}} - {{R}_{\underline{\_}}}_{{s}_{1} , {s}_{2}} ) {\underline{h}}_{2} \\ \frac{\partial {E}_{{x}_{1}}}{\partial {\underline{h}}_{2}} = 2 ( {{R}_{\underline{\_}}}_{{y}_{2}} - {{R}_{\underline{\_}}}_{{s}_{2}} ) {\underline{h}}_{2} - 2 ( {\underline{r}}_{{y}_{1} , {y}_{2}} - {\underline{r}}_{{s}_{1} , {s}_{2}} ) + 2 {( {{R}_{\underline{\_}}}_{{y}_{1} , {y}_{2}} - {{R}_{\underline{\_}}}_{{s}_{1} , {s}_{2}} )}^{T} {\underline{h}}_{1} . \qquad ( 53 )$$

In a like manner to Equation 18, the cost function for the unnaturalness of the residual noise signal is initially chosen as the mean-squared error between the residual noise signal and a scaled version of the original additive noise signal:

$$\begin{matrix}{E}_{{s}_{1}} = {\sum }_{n} {( η {s}_{1} ( n ) - {e}_{s} ( n ) )}^{2} \\ = {\sum }_{n} {( \begin{matrix}η {s}_{1} ( n ) + {\sum }_{{k}_{1} = 0}^{{K}_{1}} {h}_{1} ( {k}_{1} ) {s}_{1} ( n - {k}_{1} ) + \\ {\sum }_{{k}_{2} = 0}^{{K}_{2}} {h}_{2} ( {k}_{2} ) {s}_{2} ( n - {k}_{2} )\end{matrix} )}^{2} \\ = {\sum }_{n} {η}^{2} {s}_{1}^{2} ( n ) + {\sum }_{n} {( {\sum }_{{k}_{1} = 0}^{{K}_{1}} {h}_{1} ( {k}_{1} ) {s}_{1} ( n - {k}_{1} ) )}^{2} + \\ {\sum }_{n} {( {\sum }_{{k}_{2} = 0}^{{K}_{2}} {h}_{2} ( {k}_{2} ) {s}_{2} ( n - {k}_{2} ) )}^{2} + \\ 2 η {\sum }_{n} {\sum }_{{k}_{1} = 0}^{{K}_{1}} {s}_{1} ( n ) {h}_{1} ( {k}_{1} ) {s}_{1} ( n - {k}_{1} ) + \\ 2 η {\sum }_{n} {\sum }_{{k}_{2} = 0}^{{K}_{2}} {s}_{1} ( n ) {h}_{2} ( {k}_{2} ) {s}_{2} ( n - {k}_{2} ) + \\ 2 {\sum }_{n} {\sum }_{{k}_{1} = 0}^{{K}_{1}} {\sum }_{{k}_{2} = 0}^{{K}_{2}} {h}_{1} ( {k}_{1} ) {s}_{1} ( n - {k}_{1} ) {h}_{2} ( {k}_{2} ) {s}_{2} ( n - {k}_{2} )\end{matrix} \qquad ( 54 )$$

Using the definitions of Equation 50, it is expressed as

Eₛ_{₁}=η²rₛ_{₁}(0)+h₁^{T}Rₛ_{₁}h₁+h₂^{T}Rₛ_{₂}h₂+2ηh₁^{T}rₛ_{₁}+2ηhh₂^{T}rₛ_{₁}_{,s}_{₂}+2h₁^{T}Rₛ_{₁}_{,s}_{₂}h₂ (55)

from which the derivatives with respect to h₁ and h₂ are derived:

$$\frac{\partial {E}_{{s}_{1}}}{\partial {\underline{h}}_{1}} = 2 {\underline{\underline{R}}}_{{s}_{1}} {\underline{h}}_{1} + 2 η {\underline{r}}_{{s}_{1}} + 2 {\underline{\underline{R}}}_{{s}_{1} , {s}_{2}} {\underline{h}}_{2} \\ \frac{\partial {E}_{{s}_{1}}}{\partial {\underline{h}}_{2}} = 2 {\underline{\underline{R}}}_{{s}_{2}} {\underline{h}}_{2} + 2 η {\underline{r}}_{{s}_{1} , {s}_{2}} + 2 {{\underline{\underline{R}}}_{{s}_{1} , {s}_{2}}}^{T} {\underline{h}}_{1} . \qquad ( 56 )$$

Equivalently to single-channel noise suppression in the time domain, the composite cost function is constructed as a linear combination of the cost function for the distortion of the desired audio signal and the cost function for unnaturalness of the residual background noise:

$$E {=}_{⇓} α {E}_{{x}_{1}} + ( 1 - α ) {E}_{{s}_{1}} \\ \frac{\partial E}{\partial {\underline{h}}_{1}} = α \frac{\partial {E}_{{x}_{1}}}{\partial {\underline{h}}_{1}} + ( 1 - α ) \frac{\partial {E}_{{s}_{1}}}{\partial {\underline{h}}_{1}} = \underline{0} \\ \frac{\partial E}{\partial {\underline{h}}_{2}} = α \frac{\partial {E}_{{x}_{1}}}{\partial {\underline{h}}_{2}} + ( 1 - α ) \frac{\partial {E}_{{s}_{1}}}{\partial {\underline{h}}_{2}} = \underline{0} \qquad ( 57 )$$

Using Equation 53 and Equation 56, the derivatives can be expanded to

$$\frac{\partial E}{\partial {\underline{h}}_{1}} = 2 ( α {\underline{\underline{R}}}_{{y}_{1}} + ( 1 - 2 α ) {\underline{\underline{R}}}_{{s}_{1}} ) {\underline{h}}_{1} + 2 ( α {\underline{\underline{R}}}_{{y}_{1} , {y}_{2}} + ( 1 - 2 α ) {\underline{\underline{R}}}_{{s}_{1} , {s}_{2}} ) {\underline{h}}_{2} - 2 α ( {\underline{r}}_{{y}_{1}} - {\underline{r}}_{{s}_{1}} ) + 2 η ( 1 - α ) {\underline{r}}_{{s}_{1}} = \underline{0} \\ \frac{\partial E}{\partial {\underline{h}}_{2}} = 2 ( α {\underline{\underline{R}}}_{{y}_{2}} + ( 1 - 2 α ) {\underline{\underline{R}}}_{{s}_{2}} ) {\underline{h}}_{2} + 2 {( α {\underline{\underline{R}}}_{{y}_{1} , {y}_{2}} + ( 1 - 2 α ) {\underline{\underline{R}}}_{{s}_{1} , {s}_{2}} )}^{T} {\underline{h}}_{1} - 2 α ( {\underline{r}}_{{y}_{1} , {y}_{2}} - {\underline{r}}_{{s}_{1} , {s}_{2}} ) + 2 η ( 1 - α ) {\underline{r}}_{{s}_{1} , {s}_{2}} = \underline{0} . \qquad ( 58 )$$

This can be written using the following matrix equation

$$[ \begin{matrix}( α {\underline{\underline{R}}}_{{y}_{1}} + ( 1 - 2 α ) {\underline{\underline{R}}}_{{s}_{1}} ) & ( α {\underline{\underline{R}}}_{{y}_{1} , {y}_{2}} + ( 1 - 2 α ) {\underline{\underline{R}}}_{{s}_{1} , {s}_{2}} ) \\ {( α {\underline{\underline{R}}}_{{y}_{1} , {y}_{2}} + ( 1 - 2 α ) {\underline{\underline{R}}}_{{s}_{1} , {s}_{2}} )}^{T} & ( α {\underline{\underline{R}}}_{{y}_{2}} + ( 1 - 2 α ) {\underline{\underline{R}}}_{{s}_{2}} )\end{matrix} ] [ \begin{matrix}{\underline{h}}_{1} \\ {\underline{h}}_{2}\end{matrix} ] = [ \begin{matrix}α {\underline{r}}_{{y}_{1}} - ( η ( 1 - α ) + α ) {\underline{r}}_{{s}_{1}} \\ α {\underline{r}}_{{y}_{1} , {y}_{2}} - ( η ( 1 - α ) + α ) {\underline{r}}_{{s}_{1} , {s}_{2}}\end{matrix} ] \qquad ( 59 )$$

and the solution for the FIR filters is given by

$$[ \begin{matrix}{\underline{h}}_{1} \\ {\underline{h}}_{2}\end{matrix} ] = {[ \begin{matrix}( α {\underline{\underline{R}}}_{{y}_{1}} + ( 1 - 2 α ) {\underline{\underline{R}}}_{{s}_{1}} ) & ( α {\underline{\underline{R}}}_{{y}_{1} , {y}_{2}} + ( 1 - 2 α ) {\underline{\underline{R}}}_{{s}_{1} , {s}_{2}} ) \\ {( α {\underline{\underline{R}}}_{{y}_{1} , {y}_{2}} + ( 1 - 2 α ) {\underline{\underline{R}}}_{{s}_{1} , {s}_{2}} )}^{T} & ( α {\underline{\underline{R}}}_{{y}_{2}} + ( 1 - 2 α ) {\underline{\underline{R}}}_{{s}_{2}} )\end{matrix} ]}^{- 1} [ \begin{matrix}α {\underline{r}}_{{y}_{1}} - ( η ( 1 - α ) + α ) {\underline{r}}_{{s}_{1}} \\ α {\underline{r}}_{{y}_{1} , {y}_{2}} - ( η ( 1 - α ) + α ) {\underline{r}}_{{s}_{1} , {s}_{2}}\end{matrix} ] \qquad ( 60 )$$

Comparing the solution in Equation 60 to that of the single-channel solution in Equation 21 reveals a strong resemblance between the four sub-matrices in the matrix inversion of Equation 60 and the equivalent single matrix of Equation 21. A similar resemblance is present between the right-most vectors in Equation 60 and Equation 21.

Recognizing the resemblance between Equation 60 and Equation 21 makes it easy to generalize the dual-channel solution to allow for shaping of the residual noise signal. By basically comparing the single-channel solution allowing noise shaping, Equation 33, to the solution of Equation 21 without noise shaping, the dual-channel solution is easily generalized to allow spectral shaping of the residual noise signal:

$$[ \begin{matrix}{\underline{h}}_{1} \\ {\underline{h}}_{2}\end{matrix} ] = {[ \begin{matrix}( α {\underline{\underline{R}}}_{{y}_{1}} + ( 1 - 2 α ) {\underline{\underline{R}}}_{{s}_{1}} ) & ( α {\underline{\underline{R}}}_{{y}_{1} , {y}_{2}} + ( 1 - 2 α ) {\underline{\underline{R}}}_{{s}_{1} , {s}_{2}} ) \\ {( α {\underline{\underline{R}}}_{{y}_{1} , {y}_{2}} + ( 1 - 2 α ) {\underline{\underline{R}}}_{{s}_{1} , {s}_{2}} )}^{T} & ( α {\underline{\underline{R}}}_{{y}_{2}} + ( 1 - 2 α ) {\underline{\underline{R}}}_{{s}_{2}} )\end{matrix} ]}^{- 1} [ \begin{matrix}α ( {\underline{r}}_{{y}_{1}} - {\underline{r}}_{{s}_{1}} ) - ( 1 - α ) {\underline{\underline{R}}}_{{s}_{1}} {\underline{h}}_{s} \\ α ( {\underline{r}}_{{y}_{1} , {y}_{2}} - {\underline{r}}_{{s}_{1} , {s}_{2}} ) - ( 1 - α ) {\underline{\underline{R}}}_{{s}_{1} {s}_{2}}^{T} {\underline{h}}_{s}\end{matrix} ] \qquad ( 61 )$$

Further exploiting the analogy of the single- and dual-channel solutions, the equivalent of the Wiener solution for the dual-channel noise suppression is easily deduced from Equation 60. With α=0.5 and η=0, corresponding to infinite noise attenuation, the solution is obtained as

$$[ \begin{matrix}{\underline{h}}_{1} \\ {\underline{h}}_{2}\end{matrix} ] = {[ \begin{matrix}{\underline{\underline{R}}}_{{y}_{1}} & {\underline{\underline{R}}}_{{y}_{1} , {y}_{2}} \\ {( {\underline{\underline{R}}}_{{y}_{1} , {y}_{2}} )}^{T} & {\underline{\underline{R}}}_{{y}_{2}}\end{matrix} ]}^{- 1} [ \begin{matrix}{\underline{r}}_{{y}_{1}} - {\underline{r}}_{{s}_{1}} \\ {\underline{r}}_{{y}_{1} , {y}_{2}} - {\underline{r}}_{{s}_{1} , {s}_{2}}\end{matrix} ] \qquad ( 62 )$$

Similar to single-channel noise suppression in the time domain as previously described, in practice, the statistics of the additive noise can be estimated during segments in which the desired audio signal is absent.

An alternative formulation for deriving a time domain filter for dual-channel noise suppression will now be described. The modified analysis is performed by making similar assumptions to those described in the latter portion of Section B.1 above with respect to modifying the formulation for deriving the single-channel time domain filter. In accordance with this modified formulation, Equation 44 changes to

$$\begin{matrix}e ( n ) = {x}_{1} ( n ) + {\sum }_{{k}_{s} = 0}^{{K}_{s}} {h}_{s} ( {k}_{s} ) {s}_{1} ( n - {k}_{s} ) - {\hat{x}}_{1} ( n ) \\ = {x}_{1} ( n ) + {\sum }_{{k}_{s} = 0}^{{K}_{s}} {h}_{s} ( {k}_{s} ) {s}_{1} ( n - {k}_{s} ) - \\ {\sum }_{{k}_{1} = 0}^{{K}_{1}} {h}_{1} ( {k}_{1} ) {y}_{1} ( n - {k}_{1} ) - \\ {\sum }_{{k}_{2} = 0}^{{K}_{2}} {h}_{2} ( {k}_{2} ) {y}_{2} ( n - {k}_{2} ) \\ = {x}_{1} ( n ) - {\sum }_{{k}_{1} = 0}^{{K}_{1}} {h}_{1} ( {k}_{1} ) {x}_{1} ( n - {k}_{1} ) - \\ {\sum }_{{k}_{2} = 0}^{{K}_{2}} {h}_{2} ( {k}_{2} ) {x}_{2} ( n - {k}_{2} ) + \\ {\sum }_{{k}_{s} = 0}^{{K}_{s}} {h}_{s} ( {k}_{s} ) {s}_{1} ( n - {k}_{s} ) - {\sum }_{{k}_{1} = 0}^{{K}_{1}} {h}_{1} ( {k}_{1} ) {s}_{1} ( n - {k}_{1} ) - \\ {\sum }_{{k}_{2} = 0}^{{K}_{2}} {h}_{2} ( {k}_{2} ) {s}_{2} ( n - {k}_{2} )\end{matrix} \qquad ( 63 )$$

including the generalization to shaping of the residual noise signal. Here, the distortion of the desired audio signal is represented as

$${x}_{1} ( n ) - {\sum }_{{k}_{1} = 0}^{{K}_{1}} {h}_{1} ( {k}_{1} ) {x}_{1} ( n - {k}_{1} ) - {\sum }_{{k}_{2} = 0}^{{K}_{2}} {h}_{2} ( {k}_{2} ) {x}_{2} ( n - {k}_{2} ) ,$$

which is identical to Equation 45. Since the distortion of the desired audio signal remains unchanged compared to Equation 45, the derivatives of the distortion of the desired audio signal relative to the FIR filters remain unchanged. Compare Equation 52 and Equation 53:

$$\begin{matrix}{E}_{{x}_{1}} = {r}_{{y}_{1}} ( 0 ) - {r}_{{s}_{1}} ( 0 ) + {\underline{h}}_{1}^{T} ( {\underline{\underline{R}}}_{{y}_{1}} - {\underline{\underline{R}}}_{{s}_{1}} ) {\underline{h}}_{1} + {\underline{h}}_{2}^{T} ( {\underline{\underline{R}}}_{{y}_{2}} - {\underline{\underline{R}}}_{{s}_{2}} ) {\underline{h}}_{2} - 2 {\underline{h}}_{1}^{T} ( {\underline{r}}_{{y}_{1}} - {\underline{r}}_{{s}_{1}} ) - 2 {\underline{h}}_{2}^{T} ( {\underline{r}}_{{y}_{1} , {y}_{2}} - {\underline{r}}_{{s}_{1} , {s}_{2}} ) + 2 {\underline{h}}_{1}^{T} ( {\underline{\underline{R}}}_{{y}_{1} , {y}_{2}} - {\underline{\underline{R}}}_{{s}_{1} , {s}_{2}} ) {\underline{h}}_{2} & ( 64 ) \\ \frac{\partial {E}_{{x}_{1}}}{\partial {\underline{h}}_{1}} = 2 ( {\underline{\underline{R}}}_{{y}_{1}} - {\underline{\underline{R}}}_{{s}_{1}} ) {\underline{h}}_{1} - 2 ( {\underline{r}}_{{y}_{1}} - {\underline{r}}_{{s}_{1}} ) + 2 ( {\underline{\underline{R}}}_{{y}_{1} , {y}_{2}} - {\underline{\underline{R}}}_{{s}_{1} , {s}_{2}} ) {\underline{h}}_{2} \\ \frac{\partial {E}_{{x}_{1}}}{\partial {\underline{h}}_{2}} = 2 ( {\underline{\underline{R}}}_{{y}_{2}} - {\underline{\underline{R}}}_{{s}_{2}} ) {\underline{h}}_{2} - 2 ( {\underline{r}}_{{y}_{1} , {y}_{2}} - {\underline{r}}_{{s}_{1} , {s}_{2}} ) + 2 {( {\underline{\underline{R}}}_{{y}_{1} , {y}_{2}} - {\underline{\underline{R}}}_{{s}_{1} , {s}_{2}} )}^{T} {\underline{h}}_{1} & ( 65 )\end{matrix}$$

In Equation 63, the unnaturalness of the residual noise signal is given by

$${\sum }_{{k}_{s} = 0}^{{K}_{s}} {h}_{s} ( {k}_{s} ) {s}_{1} ( n - {k}_{s} ) - {\sum }_{{k}_{1} = 0}^{{K}_{1}} {h}_{1} ( {k}_{1} ) {s}_{1} ( n - {k}_{1} ) - {\sum }_{{k}_{2} = 0}^{{K}_{2}} {h}_{2} ( {k}_{2} ) {s}_{2} ( n - {k}_{2} ) . \qquad ( 66 )$$

The associated cost function is expressed as

$$\begin{matrix}{E}_{{s}_{1}} = {\sum }_{n} {e}_{{s}_{1}}^{2} ( n ) \\ = {\sum }_{n} {( \begin{matrix}{\sum }_{{k}_{s} = 0}^{{K}_{s}} {h}_{s} ( {k}_{s} ) {s}_{1} ( n - {k}_{s} ) - \\ {\sum }_{{k}_{1} = 0}^{{K}_{1}} {h}_{1} ( {k}_{1} ) {s}_{1} ( n - {k}_{1} ) - \\ {\sum }_{{k}_{2} = 0}^{{K}_{2}} {h}_{2} ( {k}_{2} ) {s}_{2} ( n - {k}_{2} )\end{matrix} )}^{2} \\ = {\sum }_{{k}_{1} = 0}^{{K}_{1}} {\sum }_{{k}_{2} = 0}^{{K}_{2}} {h}_{s} ( {k}_{1} ) {h}_{s} ( {k}_{2} ) {\sum }_{n} {s}_{1} ( n - {k}_{1} ) {s}_{1} ( n - {k}_{2} ) + \\ {\sum }_{{k}_{1} = 0}^{{K}_{1}} {\sum }_{{k}_{2} = 0}^{{K}_{2}} {h}_{1} ( {k}_{1} ) {h}_{1} ( {k}_{2} ) {\sum }_{n} {s}_{1} ( n - {k}_{1} ) {s}_{1} ( n - {k}_{2} ) + \\ {\sum }_{{k}_{1} = 0}^{{K}_{1}} {\sum }_{{k}_{2} = 0}^{{K}_{2}} {h}_{2} ( {k}_{1} ) {h}_{2} ( {k}_{2} ) {\sum }_{n} {s}_{2} ( n - {k}_{1} ) {s}_{2} ( n - {k}_{2} ) - \\ 2 {\sum }_{{k}_{1} = 0}^{{K}_{1}} {\sum }_{{k}_{2} = 0}^{{K}_{2}} {h}_{s} ( {k}_{1} ) {h}_{1} ( {k}_{2} ) {\sum }_{n} {s}_{1} ( n - {k}_{1} ) {s}_{1} ( n - {k}_{2} ) - \\ 2 {\sum }_{{k}_{1} = 0}^{{K}_{1}} {\sum }_{{k}_{2} = 0}^{{K}_{2}} {h}_{s} ( {k}_{1} ) {h}_{2} ( {k}_{2} ) {\sum }_{n} {s}_{1} ( n - {k}_{1} ) {s}_{2} ( n - {k}_{2} ) + \\ 2 {\sum }_{{k}_{1} = 0}^{{K}_{1}} {\sum }_{{k}_{2} = 0}^{{K}_{2}} {h}_{1} ( {k}_{1} ) {h}_{2} ( {k}_{2} ) {\sum }_{n} {s}_{1} ( n - {k}_{1} ) {s}_{2} ( n - {k}_{2} )\end{matrix} \qquad ( 67 )$$

In vector and matrix notation this is expressed as

Eₛ_{₁}=hₛ^{T}R′hₛ_{₁}+h₁^{T}Rₛ_{₁}h₁+h₂^{T}Rₛ_{₂}h₂−2hₛ^{T}R″ₛ_{₁}h₁−2h₁−2hₛ^{T}R″ₛ_{₁}ₛ_{₂}h₂+2h₁^{T}Rₛ_{₁}ₛ_{₂}h₂ (68)

where Rₛ_{₁} is a (K₁+1)×(K₁+1) matrix, R′ₛ_{₁} is a (Kₛ+1)×(K₂+1) matrix, Rₛ_{₂} is a (K₂+1)×(K₂+1) matrix, R″ₛ_{₁} is a (Kₛ+1)×(K₁+1) matrix, R″ₛ_{₁}ₛ_{₂} is a (Kₛ+1)×(K₂+1) matrix, and Rₛ_{₁}ₛ_{₂} is a (K₁+1)×(K₂+1) matrix. Matrices with same subscripts but different superscript have identical element values but are of different sizes. From Equation 68 the derivatives with respect to h₁ and h₂ are calculated as

$$\frac{\partial {E}_{{s}_{1}}}{\partial {\underline{h}}_{1}} = 2 {\underline{\underline{R}}}_{{s}_{1}} {\underline{h}}_{1} - 2 {\underline{\underline{R}}}_{{s}_{1}}^{″ T} {\underline{h}}_{s} + 2 {\underline{\underline{R}}}_{{s}_{1} , {s}_{2}} {\underline{h}}_{2} \\ \frac{\partial {E}_{{s}_{1}}}{\partial {\underline{h}}_{2}} = 2 {\underline{\underline{R}}}_{{s}_{2}} {h}_{2} - 2 {\underline{\underline{R}}}_{{s}_{1} {s}_{2}}^{″ T} {\underline{h}}_{s} + 2 {\underline{\underline{R}}}_{{s}_{1} , {s}_{2}}^{T} {\underline{h}}_{1} \qquad ( 69 )$$

Given the weighted overall cost function of Equation 57, the derivatives for the overall cost function are given by

$$\begin{matrix}\frac{\partial E}{\partial {\underline{h}}_{1}} = α \frac{\partial {E}_{{x}_{1}}}{\partial {\underline{h}}_{1}} + ( 1 - α ) \frac{\partial {E}_{{s}_{1}}}{\partial {\underline{h}}_{1}} \\ = 2 ( α {\underline{\underline{R}}}_{{y}_{1}} + ( 1 - 2 α ) {\underline{\underline{R}}}_{{s}_{1}} ) {\underline{h}}_{1} \\ = + 2 ( α {\underline{\underline{R}}}_{{y}_{1} {y}_{2}} + ( 1 - 2 α ) {\underline{\underline{R}}}_{{s}_{1} {s}_{2}} ) {\underline{h}}_{2} - \\ 2 α ( {\underline{r}}_{{y}_{1}} - {\underline{r}}_{{s}_{1}} ) - 2 ( 1 - α ) {R}_{{s}_{1}}^{″ T} {\underline{h}}_{s} = \underline{0}\end{matrix} \\ \begin{matrix}\frac{\partial E}{\partial {\underline{h}}_{2}} = α \frac{\partial {E}_{{x}_{1}}}{\partial {\underline{h}}_{2}} + ( 1 - α ) \frac{\partial {E}_{{s}_{1}}}{\partial {\underline{h}}_{2}} \\ = 2 ( α {\underline{\underline{R}}}_{{y}_{1}} + ( 1 - 2 α ) {\underline{\underline{R}}}_{{s}_{1} {s}_{2}} ) {\underline{h}}_{1} + \\ 2 {( α {\underline{\underline{R}}}_{{y}_{1} {y}_{2}} + ( 1 - 2 α ) {\underline{\underline{R}}}_{{s}_{1} {s}_{2}} )}^{T} {\underline{h}}_{2} - \\ 2 α ( {\underline{r}}_{{y}_{1} {y}_{2}} - {\underline{r}}_{{s}_{1} {s}_{2}} ) - 2 ( 1 - α ) {R}_{{s}_{1} {s}_{2}}^{″ T} {\underline{h}}_{s} = \underline{0}\end{matrix} \qquad ( 70 )$$

which is written in matrix form as

$$[ \begin{matrix}( α {{R}_{\underline{\_}}}_{{y}_{1}} + ( 1 - 2 α ) {{R}_{\underline{\_}}}_{{s}_{1}} ) & ( α {{R}_{\underline{\_}}}_{{y}_{1} , {y}_{2}} + ( 1 - 2 α ) {{R}_{\underline{\_}}}_{{s}_{1} , {s}_{2}} ) \\ {( α {{R}_{\underline{\_}}}_{{y}_{1} , {y}_{2}} + ( 1 - 2 α ) {{R}_{\underline{\_}}}_{{s}_{1} {s}_{2}} )}^{T} & ( α {{R}_{\underline{\_}}}_{{y}_{2}} + ( 1 - 2 α ) {{R}_{\underline{\_}}}_{{s}_{2}} )\end{matrix} ] [ \begin{matrix}{\underline{h}}_{1} \\ {\underline{h}}_{2}\end{matrix} ] = [ \begin{matrix}α ( {\underline{r}}_{{y}_{1}} - {\underline{r}}_{{s}_{1}} ) + ( 1 - α ) {R}_{{s}_{1}}^{″ T} {\underline{h}}_{s} \\ α ( {\underline{r}}_{{y}_{1} , {y}_{2}} - {\underline{r}}_{{s}_{1} , {s}_{2}} ) + ( 1 - α ) {R}_{{s}_{1} {s}_{2}}^{″ T} {\underline{h}}_{s}\end{matrix} ] \qquad ( 71 )$$

The solution is expressed as

$$[ \begin{matrix}{\underline{h}}_{1} \\ {\underline{h}}_{2}\end{matrix} ] = {[ \begin{matrix}( α {{R}_{\underline{\_}}}_{{y}_{1}} + ( 1 - 2 α ) {{R}_{\underline{\_}}}_{{s}_{1}} ) & ( α {{R}_{\underline{\_}}}_{{y}_{1} , {y}_{2}} + ( 1 - 2 α ) {{R}_{\underline{\_}}}_{{s}_{1} , {s}_{2}} ) \\ {( α {{R}_{\underline{\_}}}_{{y}_{1} , {y}_{2}} + ( 1 - 2 α ) {{R}_{\underline{\_}}}_{{s}_{1} , {s}_{2}} )}^{T} & ( α {{R}_{\underline{\_}}}_{{y}_{2}} + ( 1 - 2 α ) {{R}_{\underline{\_}}}_{{s}_{2}} )\end{matrix} ]}^{- 1} [ \begin{matrix}α ( {\underline{r}}_{{y}_{1}} - {\underline{r}}_{{s}_{1}} ) + ( 1 - α ) {R}_{{s}_{1}}^{″ T} {\underline{h}}_{s} \\ α ( {\underline{r}}_{{y}_{1} , {y}_{2}} - {\underline{r}}_{{s}_{1} , {s}_{2}} ) + ( 1 - α ) {R}_{{s}_{1} {s}_{2}}^{″ T} {\underline{h}}_{s}\end{matrix} ] \qquad ( 72 )$$

Again, the Wiener solution is obtained as a special case with α=0.5 and hₛ=0. Comparing Eq. 72 to Eq. 62 reveals only a sign change on the right-most terms in the far right vector.

2. Example Dual-Channel Noise Suppressor that Uses Two Time Domain Filters

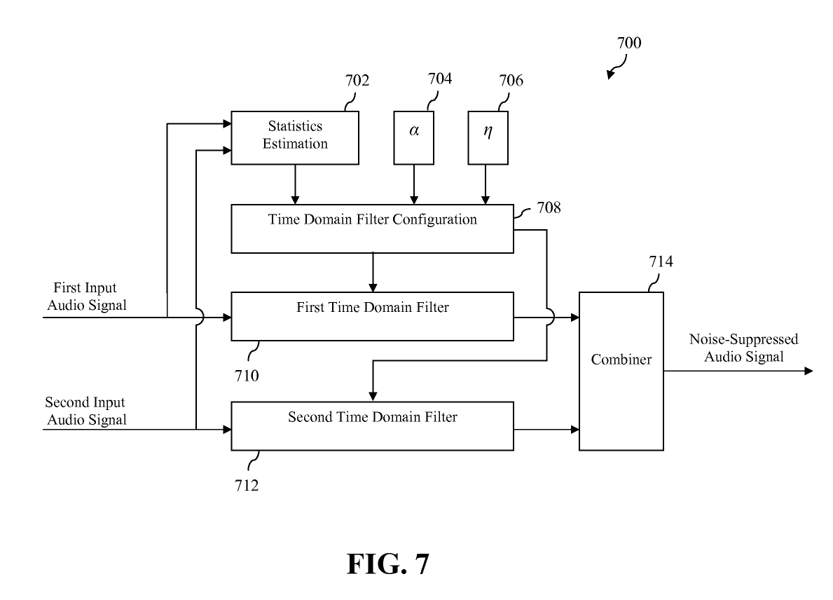

FIG. 7 is a block diagram of an example dual-channel noise suppressor 700 that uses two time domain filters in accordance with an embodiment of the present invention. Noise suppressor 700 may comprise, for example, a particular implementation of noise suppressor 602 of system 600 as described above in reference to FIG. 6. Generally speaking, noise suppressor 700 operates to receive a time domain representation of a first input audio signal that comprises a first desired audio signal and a first additive noise signal and a time domain representation of a second input audio signal that comprises a second desired audio signal and a second additive noise component. Noise suppressor 700 processes the time domain representations of the first input audio signal and the second input audio signal to produce a noise-suppressed audio signal. As shown in FIG. 7, noise suppressor 700 comprises a number of interconnected components including a statistics estimation module 702, a first parameter provider module 704, a second parameter provider module 706, a time domain filter configuration module 708, a first time domain filter 710, a second time domain filter 712, and a combiner 714.

Statistics estimation module 702 is configured to calculate estimates of statistics associated with the first input audio signal, the first additive noise signal, the second input audio signal, and the second additive noise signal for use by time domain filter configuration module 708 in configuring first time domain filter 710 and second time domain filter 712. The calculation of estimates may occur on some periodic or non-periodic basis depending upon a control scheme. In an embodiment, statistics estimation module 702 estimates statistics through correlation of the time domain representation of the first input audio signal, correlation of a time domain representation of the first additive noise signal, correlation of the time domain representation of the second input audio signal, correlation of a time domain representation of the second additive noise signal, a cross-correlation between the time domain representations of the first and second input audio signals and a cross-correlation between the time domain representations of the first and second additive noise signals. For example, statistics estimation module 702 may use auto-correlation and cross-correlation techniques to estimate the vectors r_{y}_{₁}, rₛ_{₁}, r_{y}_{₁}_{,y}_{₂} and rₛ_{₁}_{,s}_{₂} and the matrices R_{y}_{₁}, Rₛ_{₁}, R_{y}_{₂}, Rₛ_{₂}, R_{y}_{₁}_{,y}_{₂} Rₛ_{₁}_{,s}_{₂} that can be used to configure a first and second time domain filter in accordance with Equation 60.

Statistics estimation module 702 may estimate the statistics of the input audio signals and the additive noise signals across a number of segments of each of the input audio signals. A sliding window approach may be used to select the segments. Statistics estimation module 702 may update the estimated statistics each time a new segment (e.g., each time a new frame) is received for each of the two input audio signals. However, this example is not intended to be limiting, and the frequency with which the statistics are updated may vary depending upon the implementation.

Statistics estimation module 702 can estimate the statistics of the received input audio signals directly. In an embodiment in which the two input audio signals are speech signals, statistics estimation module 702 may estimate the statistics of the additive noise signals during non-speech segments, premised on the assumption that the additive noise signals will be sufficiently stationary during valid speech segments. In accordance with such an embodiment, statistics estimation module 702 may include functionality that is capable of classifying segments of the input audio signals as speech or non-speech segments. Alternatively, statistics estimation module 702 may be connected to another entity that is capable of performing such a function. Of course, numerous other methods may be used to estimate the statistics of the additive noise signals.

First parameter provider module 704 is configured to obtain a value of a parameter α that specifies a degree of balance between distortion of the first desired audio signal included in the first input audio signal and unnaturalness of a residual noise signal included in the output noise-suppressed audio signal and to provide the value of the parameter α to time domain filter configuration module 708. By way of example only, the parameter α may be that discussed above and utilized to represent the two time domain filters of Equation 60.

In one embodiment, the value of the parameter α comprises a fixed aspect of noise suppressor 700 that is determined during a design or tuning phase associated with that component. Alternatively, the value of the parameter α may be determined in response to some form of user input (e.g., responsive to user control of settings of a device that includes noise suppressor 700). In a still further embodiment, first parameter provider module 704 adaptively determines the value of the parameter α based at least in part on characteristics of the first input audio signal and/or the second input audio signal. For example, in an embodiment in which the input audio signals comprise speech signals, first parameter provider module 704 may vary the value of the parameter α such that an increased emphasis is placed on minimizing the distortion of the first desired speech signal during speech segments and such that an increased emphasis is placed on minimizing the unnaturalness of the residual noise signal during non-speech segments. Still other adaptive schemes for setting the value of parameter α may be used.

Second parameter provider module 706 is configured to obtain a value of a parameter η that specifies an amount of attenuation to be applied to the first additive noise signal included in the first input audio signal and to provide the value of the parameter η to time domain filter configuration module 708. By way of example only, the parameter η may be that discussed above and utilized to represent the two time domain filters of Equation 60.

In one embodiment, the value of the parameter η comprises a fixed aspect of noise suppressor 700 that is determined during a design or tuning phase associated with that component. Alternatively, the value of the parameter η may be determined in response to some form of user input (e.g., responsive to user control of settings of a device that includes noise suppressor 700). In a still further embodiment, second parameter provider module 706 adaptively determines the value of the parameter η based at least in part on characteristics of the first input audio signal and/or the second input audio signal.

In certain embodiments, first parameter provider module 704 determines a value of the parameter α based on a current value of the parameter η. Such an embodiment takes into account that certain values of α may provide a better trade-off between distortion of the desired audio signal and unnaturalness of the residual noise signal at different levels of noise attenuation. A scheme that derives the value of the parameter α based on the value of the parameter η may also be useful for facilitating user control of noise suppression since controlling the amount of noise attenuation may be a more intuitive and understandable operation to a user than controlling the trade-off between distortion of the first desired audio signal and unnaturalness of the residual noise signal.

Time domain filter configuration module 708 is configured to obtain estimates of statistics associated with the first and second input audio signals and the first and second additive noise signals from statistics estimation module 702, the value of the parameter α that specifies the degree of balance between the distortion of the first desired audio signal and the unnaturalness of the residual noise signal provided by first parameter provider module 704, and the value of the parameter η that specifies the amount of attenuation to be applied to the first additive noise signal provided by second parameter provider module 706 and to use those values to configure first time domain filter 710 and second time domain filter 712. For example, time domain filter configuration module 708 may use these values to configure first time domain filter 710 and second time domain filter 712 in accordance with Equation 60, although this is only one example. Time domain filter configuration module 708 may re-configure first time domain filter 710 and second time domain filter 712 each time new segments of the first and second input audio signals are received or in accordance with some other periodic or non-periodic control scheme.

First time domain filter 710 is configured to filter the first input audio signal to generate a first processed audio signal. Second time domain filter 710 is configured to filter the second input audio signal to generate a second processed audio signal. The filtering operation performed by each of first time domain filter 710 and second time domain filter 712 may be controlled by at least some of the estimated statistics received from statistics estimation module 702, the value of the parameter α that specifies the degree of balance between the distortion of the first desired audio signal and the unnaturalness of the residual noise signal provided by first parameter provider module 704, and the value of the parameter η that specifies the amount of attenuation to be applied to the first additive noise signal provided by second parameter provider module 706. Combiner 714 is configured to add the first processed audio signal received from first time domain filter 710 to the second processed audio signal received from second time domain filter 712 to produce the noise-suppressed audio signal. Persons skilled in the relevant art(s) will appreciate that other techniques may also be used to combine the first processed audio signal with the second processed audio signal to produce the noise-suppressed audio signal.

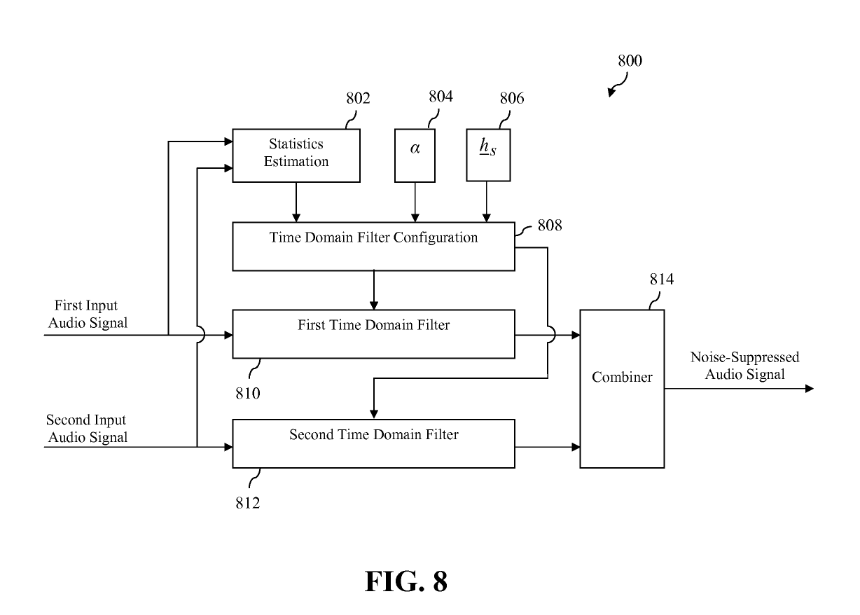

FIG. 8 is a block diagram of an alternate example dual-channel noise suppressor 800 that uses two time domain filters in accordance with an embodiment of the present invention. Noise suppressor 800 may also comprise, for example, a particular implementation of noise suppressor 602 of system 600 as described above in reference to FIG. 6. As shown in FIG. 8, noise suppressor 800 comprises a number of interconnected components including a statistics estimation module 802, a first parameter provider module 804, a noise shaping filter provider module 806, a time domain filter configuration module 808, a first time domain filter 810, a second time domain filter 812 and a combiner 814. Statistics estimation module 802, first parameter provider module 804, time domain filter configuration module 808, first time domain filter 810, second time domain filter 812 and combiner 814 respectively operate in essentially the same fashion as statistics estimation module 702, first parameter provider module 704, time domain filter configuration module 708, first time domain filter 710, second time domain filter 712 and combiner 714 as described above in reference to noise suppressor 700 of FIG. 7, with exceptions to be described below.

In noise suppressor 800, noise shaping filter provider module 806 is configured to provide parameters associated with a noise shaping filter hₛ to time domain filter configuration module 808 for use in configuring first time domain filter 810 and second time domain filter 812. For example, time domain filter configuration module 808 may utilize the parameters of the noise shaping filter noise shaping filter hₛ to configure first time domain filter 810 and second time domain filter 812 in accordance with Equation 61 as previously described. In contrast to noise suppressor 700 which uses a noise attenuation factor η, noise suppressor 800 allows for arbitrary shaping of the residual noise signal through provision of the noise shaping filter hₛ. Depending upon the implementation, the noise shaping filter hₛ may be specified during design or tuning of a device that includes noise suppressor 800, determined based on some form of user input, or adaptively determined based on at least characteristics associated with the first input audio signal and/or the second input audio signal.

3. Example Methods for Performing Dual-Channel Noise Suppression in the Time Domain

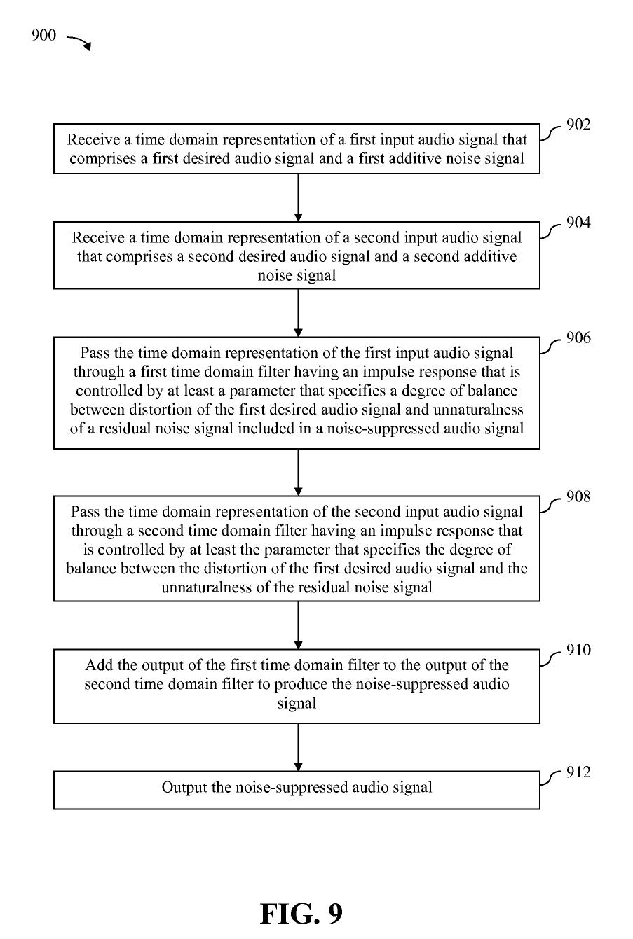

FIG. 9 depicts a flowchart 900 of a method for performing dual-channel noise suppression in the time domain in accordance with an embodiment of the present invention. The method of flowchart 900 may be performed, for example and without limitation, by noise suppressor 700 as described above in reference to FIG. 7 or noise suppressor 800 as described above in reference to FIG. 8. However, the method is not limited to those implementations.

As shown in FIG. 9, the method of flowchart 900 begins at step 902 in which a time domain representation of a first input audio signal is received, wherein the first input audio signal comprises a first desired audio signal and a first additive noise signal. At step 904, a time domain representation of a second input audio signal is received, wherein the second input audio signal comprises a second desired audio signal and a second additive noise signal.

At step 906, the time domain representation of the first input audio signal is passed through a first time domain filter having an impulse response that is controlled by at least a parameter that specifies a degree of balance between distortion of the first desired audio signal and unnaturalness of a residual noise signal included in a noise-suppressed audio signal. At step 908, the time domain representation of the second input audio signal is passed through a second time domain filter having an impulse response that is controlled by at least the parameter that specifies the degree of balance between the distortion of the first desired audio signal and the unnaturalness of the residual noise signal. For example, the first and second time domain filters may correspond to the two time domain filters specified by Equation 60 or 61 and the parameter that specifies the degree of balance between the distortion of the first desired audio signal and the unnaturalness of the residual noise signal may comprise the parameter α included in those equations. However, these are examples only and other time domain filters may be used.

Depending upon the implementation, the parameter that specifies the degree of balance between the distortion of the first desired audio signal and the unnaturalness of the residual noise signal may be determined in a variety of ways. For example, the parameter that specifies the degree of balance between the distortion of the first desired audio signal and the unnaturalness of the residual noise signal may be determined based at least in part on characteristics of the first input audio signal and/or the second input audio signal.

In certain embodiments, step 906 involves passing the time domain representation of the first input audio signal through a first time domain filter having an impulse response that is controlled by at least the parameter that specifies the degree of balance between the distortion of the first desired audio signal and the unnaturalness of the residual noise signal and a noise attenuation factor and step 908 involves passing the time domain representation of the second input audio signal through a second time domain filter having an impulse response that is controlled by at least the parameter that specifies the degree of balance between the distortion of the first desired audio signal and the unnaturalness of the residual noise signal and the noise attenuation factor. For example, the first and second time domain filters may be the first and second time domain filters represented by Equation 60 and the noise attenuation factor may comprise the parameter η included in that equation. However, this is one example only and other time domain filters that include a noise attenuation factor may be used. In certain embodiments, the value of the parameter that specifies the degree of balance between the distortion of the first desired audio signal and the unnaturalness of the residual noise signal is determined based on the value of the noise attenuation factor.

In other embodiments, step 906 involves passing the time domain representation of the first input audio signal through a first time domain filter having an impulse response that is controlled by at least the parameter that specifies the degree of balance between the distortion of the first desired audio signal and the unnaturalness of the residual noise signal and a noise shaping filter and step 908 involves passing the time domain representation of the second input audio signal through a second time domain filter having an impulse response that is controlled by at least the parameter that specifies the degree of balance between the distortion of the first desired audio signal and the unnaturalness of the residual noise signal and the noise shaping filter. For example, the first and second time domain filters may be the first and second time domain filters represented by Equation 61 and the noise shaping filter may comprise the filter hₛ included in that equation. However, this is one example only and other time domain filters that include a noise shaping filter may be used.

In certain implementations, the method of flowchart 900 further includes estimating statistics comprising correlation of the time domain representation of the first input audio signal, correlation of a time domain representation of the first additive noise signal, correlation of the time domain representation of the second input audio signal, correlation of a time domain representation of the second additive noise signal, a cross-correlation between the time domain representation of the first input audio signal and the time domain representation of the second input audio signal, and a cross-correlation between the time domain representation of the first additive noise signal and the time domain representation of the second additive noise signal. For example and without limitation, this estimation of statistics may comprise estimating the vectors r_{y}_{₁}, rₛ_{₁}, r_{y}_{₁}_{,y}_{₂} and rₛ_{₁}_{,s}_{₂} and the matrices R_{y}_{₁}, Rₛ_{₁}, R_{y}_{₂}, Rₛ_{₂}, R_{y}_{₁}_{,y}_{₂} Rₛ_{₁}_{,s}_{₂} that can be used to configure a first and second time domain filter in accordance with Equation 60 or Equation 61.

In accordance with such an implementation, step 904 may involve passing the time domain representation of the first input audio signal through a first time domain filter having an impulse response that is a function of at least the parameter that specifies the degree of balance between the distortion of the first desired audio signal and the unnaturalness of the residual noise signal and at least some of the estimated statistics and step 906 may involve passing the time domain representation of the second input audio signal through a second time domain filter having an impulse response that is a function of at least the parameter that specifies the degree of balance between the distortion of the first desired audio signal and the unnaturalness of the residual noise signal and at least some of the estimated statistics.

At step 910, the output of the first time domain filter is added to the output of the second time domain filter to produce the noise-suppressed audio signal. Persons skilled in the relevant art(s) will readily appreciate that techniques other than addition may be used to combine the output of the first time domain filter with the output of the second time domain filter to produce the noise-suppressed audio signal. At step 912, the noise-suppressed audio signal generated during step 910 is output. Depending upon the implementation, the noise-suppressed audio signal may then be further processed, stored, transmitted to a remote entity, or played back to a user.

### D. Single-Channel Noise Suppression in the Frequency Domain in Accordance with Embodiments of the Present Invention

As noted above, FIG. 1 is a high-level block diagram of a single-channel noise suppression system 100 in accordance with an embodiment of the present invention. System 100 includes a noise suppressor 102 that applies noise suppression to a single input audio signal to generate a noise-suppressed signal, wherein the input audio signal comprises a desired audio signal and an additive noise signal. As will be discussed in more detail herein, noise suppressor 102 is configured to apply noise suppression in a manner that is controlled by at least a parameter that specifies a degree of balance between distortion of the desired audio signal and the unnaturalness of a residual noise signal included in the noise-suppressed audio signal.

In embodiments to be described in this section, noise suppressor 102 operates to receive a frequency domain representation of the input audio signal and to multiply the frequency domain representation of the input audio signal by a frequency domain gain function that is controlled at least by a parameter that specifies a degree of balance between distortion of the desired audio signal and unnaturalness of a residual noise signal included in the noise-suppressed audio signal. In the following, exemplary derivations of such a frequency domain gain function will first be described. An exemplary implementation of noise suppressor 102 that utilizes such a frequency domain gain function will then be described. Finally, exemplary methods for performing single-channel noise suppression in the frequency domain will be described.

1. Example Derivation of Frequency Domain Gain Function for Single-Channel Noise Suppression

This section derives a frequency domain variation of the single-channel time domain algorithm proposed in Section B.1. In the frequency domain the assumption of the desired audio signal and noise signal being additive results in an observed signal given by

Y(f)=X(f)+S(f), (73)

where the capital letter variables represent the discrete Fourier transform of the corresponding lower case time variables. Instead of filtering in the time domain, the noise suppression is achieved by multiplication in the frequency domain:

\hat{X}(f)=H(f)Y(f) (74)

wherein H(f) is the frequency domain noise suppression filter. As in previous sections, the target of the noise suppression may be the desired audio signal plus an attenuated (and possibly spectrally shaped) version of the original noise signal. Hence, the error of the noise suppression is defined as

$$\begin{matrix}E ( f ) = [ X ( f ) + {H}_{s} ( f ) S ( f ) ] - \hat{X} ( f ) \\ = [ X ( f ) + {H}_{s} ( f ) S ( f ) ] - H ( f ) [ X ( f ) + S ( f ) ] \\ = X ( f ) [ 1 - H ( f ) ] + S ( f ) [ {H}_{s} ( f ) - H ( f ) ]\end{matrix} \qquad ( 75 )$$

wherein Hₛ(f) represents the desired attenuation and possibly shaping of the residual noise signal. From Equation 75, the distortion of the desired audio signal is defined as

Eₓ(f)=X(f)[1−H(f)] (76)

and the unnaturalness of the residual noise signal is defined as

Eₛ(f)=S(f)[Hₛ(f)−H(f)]. (77)

The cost function corresponding to the distortion of the desired audio signal is given by

$$\begin{matrix}{E}_{x} = {\sum }_{n} {e}_{x}^{2} ( n ) \\ = \frac{1}{N} {\sum }_{f} {E}_{x} ( f ) {E}_{x}^{*} ( f ) \\ = \frac{1}{N} {\sum }_{f} ( X ( f ) [ 1 - H ( f ) ] ) {( X ( f ) [ 1 - H ( f ) ] )}^{*} \\ = \frac{1}{N} {\sum }_{f} ( [ Y ( f ) - S ( f ) ] [ 1 - H ( f ) ] ) \\ {( [ Y ( f ) - S ( f ) ] [ 1 - H ( f ) ] )}^{*} \\ = \frac{1}{N} {\sum }_{f} [ Y ( f ) - S ( f ) ] [ {Y}^{*} ( f ) - {S}^{*} ( f ) ] \\ [ 1 - H ( f ) ] [ 1 - {H}^{*} ( f ) ] \\ = \frac{1}{N} {\sum }_{f} [ Y ( f ) {Y}^{*} ( f ) + S ( f ) {S}^{*} ( f ) - 2 Re \{ Y ( f ) {S}^{*} ( f ) \} ] \\ [ 1 - H ( f ) ] [ 1 - {H}^{*} ( f ) ] \\ = \frac{1}{N} {\sum }_{f} [ Y ( f ) {Y}^{*} ( f ) - S ( f ) {S}^{*} ( f ) - 2 Re \{ X ( f ) {S}^{*} ( f ) \} ] \\ [ 1 - H ( f ) ] [ 1 - {H}^{*} ( f ) ]\end{matrix} \qquad ( 78 )$$

Note that with an independent desired audio signal and noise

$$\begin{matrix}\begin{matrix}X ( f ) {S}^{*} ( f ) = {\sum }_{k = - ( N - 1 )}^{N - 1} {C}_{XS} ( k ) {e}^{- j2π fk / N} \\ = 0\end{matrix} \\ if x ( n ) and s ( n ) are uncorrelated and hence Equation \\ 78 reduces to & ( 79 ) \\ \begin{matrix}{E}_{x} = \frac{1}{N} {\sum }_{f} [ Y ( f ) {Y}^{*} ( f ) - S ( f ) {S}^{*} ( f ) ] [ 1 - H ( f ) ] [ 1 - {H}^{*} ( f ) ] \\ = \frac{1}{N} {\sum }_{f} ( {\vert Y ( f ) \vert}^{2} - {\vert S ( f ) \vert}^{2} ) {\vert 1 - H ( f ) \vert}^{2}\end{matrix} & ( 80 )\end{matrix}$$

The cost function corresponding to the unnaturalness of the residual noise signal is given by

$$\begin{matrix}{E}_{s} = {\sum }_{n} {e}_{s}^{2} ( n ) \\ = \frac{1}{N} {\sum }_{f} {E}_{s} ( f ) {E}_{s}^{*} ( f ) \\ = \frac{1}{N} {\sum }_{f} ( S ( f ) [ {H}_{s} ( f ) - H ( f ) ] ) {( S ( f ) [ {H}_{s} ( f ) - H ( f ) ] )}^{*} \\ = \frac{1}{N} {\sum }_{f} S ( f ) {{S}^{*} ( f ) [ {H}_{s} ( f ) - H ( f ) ] [ {H}_{s} ( f ) - H ( f ) ]}^{*} \\ = \frac{1}{N} {\sum }_{f} {\vert S ( f ) \vert}^{2} {\vert {H}_{s} ( f ) - H ( f ) \vert}^{2} .\end{matrix} \qquad ( 81 )$$

Hence, the weighted cost function of distortion of the desired audio signal and unnaturalness of the residual noise signal, equivalently to Equation 37, is given by

$$\begin{matrix}E = α {E}_{x} + ( 1 - α ) {E}_{s} \\ = \frac{α}{N} {\sum }_{f} ( {\vert Y ( f ) \vert}^{2} - {\vert S ( f ) \vert}^{2} ) {\vert 1 - H ( f ) \vert}^{2} + \\ \frac{( 1 - α )}{N} {\sum }_{f} {\vert S ( f ) \vert}^{2} {\vert {H}_{s} ( f ) - H ( f ) \vert}^{2} .\end{matrix} \qquad ( 82 )$$

If the gain function in the frequency domain, H(f), realizing the noise suppression, as well as the specified spectral attenuation and possibly shape, Hₛ(f), of the residual noise signal, are both required to be real in the frequency domain, then Equation 82 reduces to

$$\begin{matrix}E = a {E}_{x} + ( 1 - α ) {E}_{s} \\ = \frac{α}{N} {\sum }_{f} ( {\vert Y ( f ) \vert}^{2} - {\vert S ( f ) \vert}^{2} ) {( 1 - H ( f ) )}^{2} + \\ \frac{( 1 - α )}{N} {\sum }_{f} {\vert S ( f ) \vert}^{2} {( {H}_{s} ( f ) - H ( f ) )}^{2} \\ = \frac{α}{N} {\sum }_{f} ( {\vert Y ( f ) \vert}^{2} - {\vert S ( f ) \vert}^{2} ) ( 1 - 2 H ( f ) + {H}^{2} ( f ) ) + \\ \frac{( 1 - α )}{N} {\sum }_{f} {\vert S ( f ) \vert}^{2} ( {H}_{s}^{2} ( f ) - 2 {H}_{s} ( f ) H ( f ) + {H}^{2} ( f ) ) \\ = \frac{1}{N} {\sum }_{f} {H}^{2} ( f ) ( α {\vert Y ( f ) \vert}^{2} + ( 1 - 2 α ) {\vert S ( f ) \vert}^{2} ) - \\ 2 H ( f ) ( α ( {\vert Y ( f ) \vert}^{2} - {\vert S ( f ) \vert}^{2} ) + ( 1 - α ) {H}_{s} ( f ) {\vert S ( f ) \vert}^{2} ) + \\ α ( {\vert Y ( f ) \vert}^{2} - {\vert S ( f ) \vert}^{2} ) + ( 1 - α ) {\vert S ( f ) \vert}^{2} {H}_{s}^{2} ( f ) .\end{matrix} \qquad ( 83 )$$

From Equation 83, the derivative with respect to the noise suppression gain functions is calculated and set to zero in order to solve for the optimal noise suppression gain functions:

$$\begin{matrix}\frac{\partial E}{\partial H ( f )} = 2 \frac{1}{N} H ( f ) ( α {\vert Y ( f ) \vert}^{2} + ( 1 - 2 α ) {\vert S ( f ) \vert}^{2} ) - \\ 2 \frac{1}{N} ( α ( {\vert Y ( f ) \vert}^{2} - {\vert S ( f ) \vert}^{2} ) + ( 1 - α ) {H}_{s} ( f ) {\vert S ( f ) \vert}^{2} ) \\ = 0\end{matrix} \\ ⇓ \\ H ( f ) = \frac{α ( {\vert Y ( f ) \vert}^{2} - {\vert S ( f ) \vert}^{2} ) + ( 1 - α ) {H}_{s} ( f ) {\vert S ( f ) \vert}^{2}}{α {\vert Y ( f ) \vert}^{2} + ( 1 - 2 α ) {\vert S ( f ) \vert}^{2}} . \qquad ( 84 )$$

The resemblance to Equation 39 is noticeable. However, the matrix inversion of Equation 39 has been eliminated and replaced by simple division by operating in the frequency domain.

The above cost function can be readily integrated into signal-to-noise ratio (SNR) based noise suppression algorithms by re-writing the gain function (Equation 84) as

$$\begin{matrix}H ( f ) = \frac{α ( \frac{{\vert Y ( f ) \vert}^{2} - {\vert S ( f ) \vert}^{2}}{{\vert S ( f ) \vert}^{2}} ) + ( 1 - α ) {H}_{s} ( f )}{α ( \frac{{\vert Y ( f ) \vert}^{2} - {\vert S ( f ) \vert}^{2}}{{\vert S ( f ) \vert}^{2}} ) + ( 1 - α )} \\ = \frac{α {SNR}^{2} ( f ) + ( 1 - α ) {H}_{s} ( f )}{α {SNR}^{2} ( f ) + ( 1 - α )} ,\end{matrix} \qquad ( 85 )$$

wherein

$${SNR}^{2} ( f ) = \frac{{\vert X ( f ) \vert}^{2}}{{\vert S ( f ) \vert}^{2}} = \frac{{\vert Y ( f ) \vert}^{2} - {\vert S ( f ) \vert}^{2}}{{\vert S ( f ) \vert}^{2}} . \qquad ( 86 )$$

This a priori SNR-centric formulation can also be achieved directly from the first line of Equation 78,

$$\begin{matrix}{E}_{x} = \frac{1}{N} {\sum }_{f} ( X ( f ) [ 1 - H ( f ) ] ) {( X ( f ) [ 1 - H ( f ) ] )}^{*} \\ = \frac{1}{N} {\sum }_{f} {( 1 - H ( f ) )}^{2} {\vert X ( f ) \vert}^{2}\end{matrix} \qquad ( 87 )$$

### and Equation 81,

$${E}_{s} = \frac{1}{N} {\sum }_{f} {( {H}_{s} ( f ) - H ( f ) )}^{2} {\vert S ( f ) \vert}^{2} \qquad ( 88 )$$

where both are shown assuming real valued desired attenuation, Hₛ(f), and real valued noise suppression gain function, H(f). The weighted cost function, equivalent to Equation 83, becomes

$$\begin{matrix}E = α {E}_{x} + ( 1 - α ) {E}_{s} \\ = \frac{α}{N} {\sum }_{f} {( 1 - H ( f ) )}^{2} {\vert X ( f ) \vert}^{2} + \\ \frac{( 1 - α )}{N} {\sum }_{f} {( {H}_{s} ( f ) - H ( f ) )}^{2} {\vert S ( f ) \vert}^{2}\end{matrix} \qquad ( 89 )$$

and the minimization with respect to H(f) becomes

$$\begin{matrix}\frac{\partial E}{\partial H ( f )} = - 2 \frac{α}{N} ( 1 - H ( f ) ) {\vert X ( f ) \vert}^{2} - \\ 2 \frac{1 - α}{N} ( {H}_{s} ( f ) - H ( f ) ) {\vert S ( f ) \vert}^{2} \\ = 0\end{matrix} \\ ⇓ \begin{matrix}H ( f ) = \frac{α {\vert X ( f ) \vert}^{2} + ( 1 - α ) {H}_{s} ( f ) {\vert S ( f ) \vert}^{2}}{α {\vert X ( f ) \vert}^{2} + ( 1 - α ) {\vert S ( f ) \vert}^{2}} \\ = \frac{{αγ ( f )}^{2} + ( 1 - α ) {H}_{s} ( f )}{{αγ ( f )}^{2} + ( 1 - α )} ,\end{matrix} \qquad ( 90 )$$

wherein γ(f) is the a priori SNR,

$$γ ( f ) = \frac{\vert X ( f ) \vert}{\vert S ( f ) \vert} = SNR ( f ) . \qquad ( 91 )$$

In some practical systems it may not be the “real” a priori SNR that is estimated, but instead the signal plus noise to noise ratio, i.e. the a posteori signal to noise ratio (OSNR):

$${OSNR}^{2} ( f ) = \frac{{\vert Y ( f ) \vert}^{2}}{{\vert S ( f ) \vert}^{2}} . \qquad ( 92 )$$

In this case, the gain function can be calculated as

$$\begin{matrix}H ( f ) = \frac{α ( {\vert Y ( f ) \vert}^{2} / {\vert S ( f ) \vert}^{2} - 1 ) + ( 1 - α ) {H}_{s} ( f )}{α {\vert Y ( f ) \vert}^{2} / {\vert S ( f ) \vert}^{2} + ( 1 - 2 α )} \\ = \frac{α ( {OSNR}^{2} ( f ) - 1 ) + ( 1 - α ) {H}_{s} ( f )}{α ( {OSNR}^{2} ( f ) - 1 ) + ( 1 - α )} .\end{matrix} \qquad ( 93 )$$

2. Example Single-Channel Frequency Domain Noise Suppressor

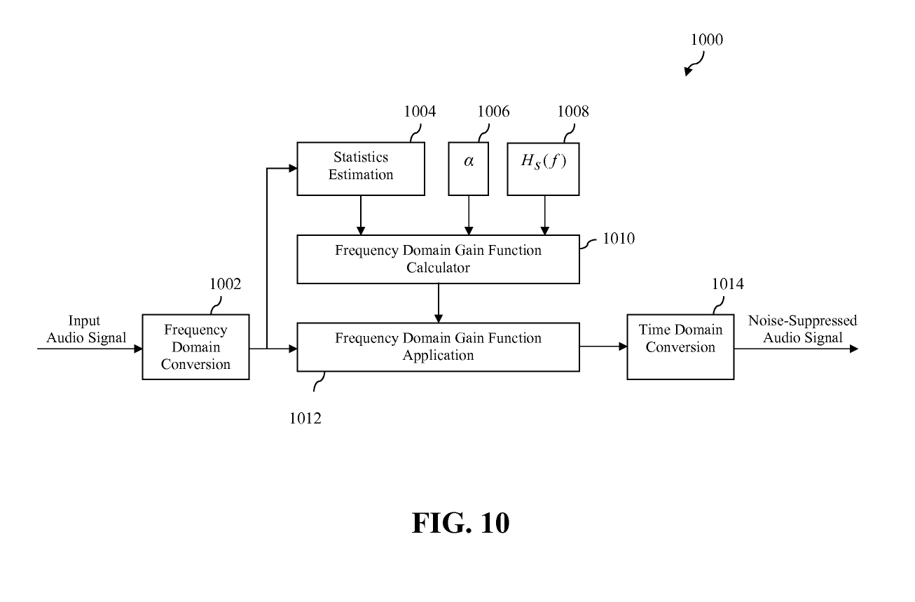

FIG. 10 is a block diagram of an example single-channel frequency domain noise suppressor 1000 in accordance with an embodiment of the present invention. Noise suppressor 1000 may comprise, for example, a particular implementation of noise suppressor 102 of system 100 as described above in reference to FIG. 1. Generally speaking, noise suppressor 1000 operates to obtain a frequency domain representation of an input audio signal that comprises a desired audio signal and an additive noise signal, to multiple the frequency domain representation of the input audio signal by a frequency domain gain function to generate a noise-suppressed audio signal, the frequency domain gain function being controlled by at least a parameter that specifies a degree of balance between distortion of the desired audio signal and unnaturalness of a residual noise signal in the noise-suppressed audio signal, and to output the noise-suppressed audio signal. As shown in FIG. 10, noise suppressor 1000 comprises a number of interconnected components including a frequency domain conversion module 1002, a statistics estimation module 1004, a first parameter provider module 1006, a second parameter provider module 1008, a frequency domain gain function calculator 1010, a frequency domain gain function application module 1012, and a time domain conversion module 1014.

Frequency domain conversion module 1002 is configured to receive a time domain representation of the input audio signal and to convert it into a frequency domain representation of the input audio signal. Various well-known techniques may be utilized to perform this frequency conversion function. For example and without limitation, a Fast Fourier Transform (FFT) may be used or an analysis filter bank may be used.

Statistics estimation module 1004 is configured to calculate estimates of statistics associated with the input audio signal and the additive noise signal for use by frequency domain gain function calculator 1010 in calculating a frequency domain gain function to be applied by frequency domain gain function application module 1012. The calculation of estimates may occur on some periodic or non-periodic basis depending upon a control scheme. In certain embodiments, statistics estimation module 1004 estimates the statistics by estimating power spectra associated with the input audio signal and power spectra associated with the additive noise signal. For example, with respect to the frequency domain gain function of Equation 84 discussed above, statistics estimation module 1004 may estimate |Y(f)|² and |S(f)|², although this is only one example.

Statistics estimation module 1004 can estimate the statistics of the received input audio signal directly. In an embodiment in which the input audio signal is a speech signal, statistics estimation module 1004 may estimate the statistics of the additive noise signal during non-speech segments, premised on the assumption that the additive noise signal will be sufficiently stationary during valid speech segments. In accordance with such an embodiment, statistics estimation module 1004 may include functionality that is capable of classifying segments of the input audio signal as speech or non-speech segments. Alternatively, statistics estimation module 1004 may be connected to another entity that is capable of performing such a function. Of course, numerous other methods may be used to estimate the statistics of the additive noise signal.

First parameter provider module 1006 is configured to obtain a value of a parameter α that specifies a degree of balance between distortion of the desired audio signal included in the input audio signal and unnaturalness of a residual noise signal included in the output noise-suppressed audio signal and to provide the value of the parameter α to frequency domain gain function calculator 1010. By way of example only, the parameter α may be that discussed above and utilized in defining the frequency domain gain function of Equation 84. Note that a different value of the parameter α may be specified for each frequency sub-band or the same value of the parameter α may be used for some or all of the frequency sub-bands. The parameter value(s) may be specified during design or tuning of a device that includes noise suppressor 1000, determined based on some form of user input, and/or adaptively determined based on factors such as, but not limited to, characteristics of the input audio signal.

Second parameter provider module 1008 is configured to provide a frequency-dependent noise attenuation factor, Hₛ(f), to frequency domain gain function calculator 1010 for use in calculating a frequency domain gain function to be applied by frequency domain gain function application module 1012. The frequency-dependent noise attenuation factor, Hₛ(f), may be that discussed above and utilized in defining the frequency domain gain function of Equation 84, although this is only an example. If the noise attenuation factor is the same across all frequency sub-bands, then this will be the same as applying a flat attenuation to the noise signal. If the noise attenuation factor varies from sub-band to sub-band, then arbitrary noise shaping can be achieved. Depending upon the implementation, the frequency-dependent noise attenuation factor, Hₛ(f), may be specified during design or tuning of a device that includes noise suppressor 1000, determined based on some form of user input, and/or adaptively determined based on factors such as, but not limited to, characteristics of the input audio signal.

In certain embodiments, first parameter provider module 1006 determines a value of the parameter α based on the value of the frequency-dependent noise attenuation factor, Hₛ(f), for a particular sub-band. Such an embodiment takes into account that certain values of α may provide a better trade-off between distortion of the desired audio signal and unnaturalness of the residual noise signal at different levels of noise attenuation.

Frequency domain gain function calculator 1010 is configured to obtain, for each frequency sub-band, estimates of statistics associated with the input audio signal and the additive noise signal from statistics estimation module 1004, the value of the parameter α that specifies the degree of balance between the distortion of the desired audio signal and the unnaturalness of the residual noise signal provided by first parameter provider module 1006, and the value of the frequency-dependent noise attenuation factor, Hₛ(f). Frequency domain gain function calculator 1010 then uses those values to calculate a frequency domain gain function to be applied by frequency domain gain function application module 1012. For example, frequency domain gain function calculator 1010 may use these values to calculate a frequency domain gain function in accordance with Equation 84, although this is only one example. The calculation of the frequency domain gain function may occur on a periodic or non-periodic basis dependent upon a control scheme.

Frequency domain gain function application module 1012 is configured to multiply the frequency domain representation of the input audio signal received from frequency domain conversion module 1002 by the frequency domain gain function constructed by frequency domain gain function calculator 1010 to produce a frequency domain representation of a noise-suppressed audio signal. Time domain conversion module 1014 receives the frequency domain representation of the noise-suppressed audio signal and converts it into a time domain representation of the noise-suppressed audio signal, which it then outputs. Various well-known techniques may be utilized to perform the time domain conversion function. For example, an inverse FFT or synthesis filter bank may be used.

Although FIG. 10 shows that frequency domain conversion module 1002 is directly connected to frequency domain gain function application module 1012, in certain embodiments one or more intermediate processing components may be connected between these two components. That is to say, some form of processing of the frequency domain representation of the input audio signal may occur prior to processing of that signal by frequency domain gain function application module 1012. Likewise, although FIG. 10 shows that time domain conversion module 1014 is directly connected to frequency domain gain function application module 1012, in certain embodiments one or more intermediate processing components may be connected between these two components. That is to say, some form of processing of the frequency domain representation of the noise-suppressed audio signal may occur prior to conversion of that signal to the time domain by time domain conversion module 1014.

3. Example Methods for Performing Single-Channel Noise Suppression In the Frequency Domain

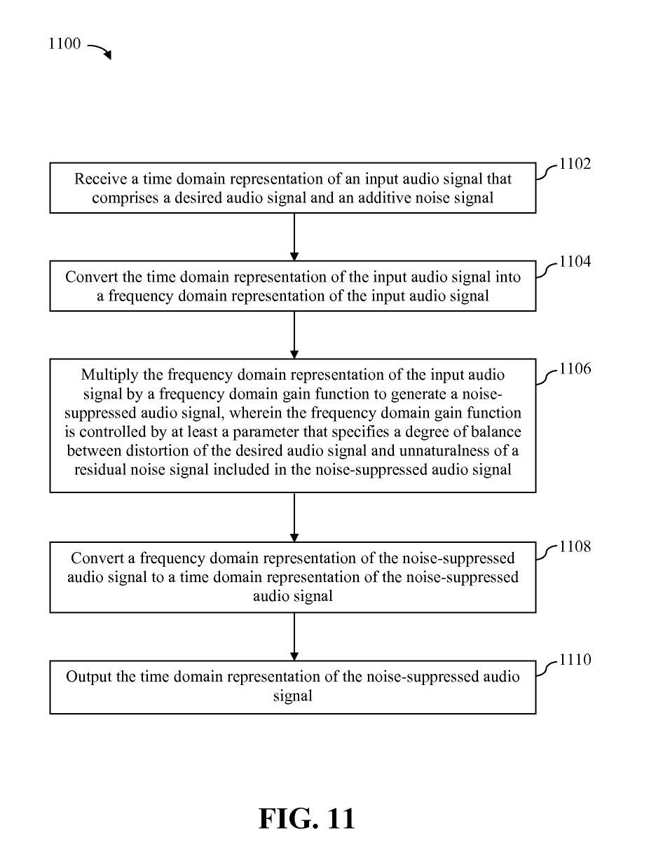

FIG. 11 depicts a flowchart 1100 of a method for performing single-channel noise suppression in the frequency domain in accordance with an embodiment of the present invention. The method of flowchart 1100 may be performed, for example and without limitation, by noise suppressor 1000 as described above in reference to FIG. 10. However, the method is not limited to those implementations.

As shown in FIG. 11, the method of flowchart 1100 begins at step 1102 in which a time domain representation of an input audio signal is received, wherein the input audio signal comprises a desired audio signal and an additive noise signal.

At step 1104, the time domain representation of the input audio signal is converted into a frequency domain representation of the input audio signal. Various well-known techniques may be utilized to perform this frequency conversion step. For example and without limitation, a Fast Fourier Transform (FFT) may be used or an analysis filter bank may be used.

At step 1106, the frequency domain representation of the input audio signal is multiplied by a frequency domain gain function to generate a noise-suppressed audio signal, wherein the frequency domain gain function is controlled by at least a parameter that specifies a degree of balance between distortion of the desired audio signal and unnaturalness of a residual noise signal included in the noise-suppressed audio signal. For example, the frequency domain gain function may be that specified by Equation 84 and parameter that specifies the degree of balance between the distortion of the desired audio signal and the unnaturalness of the residual noise signal may comprise the parameter α included in that equation. However, this is one example only and other frequency domain gain functions may be used.

Depending upon the implementation, the parameter that specifies the degree of balance between the distortion of the desired audio signal and the unnaturalness of the residual noise signal may be determined in a variety of ways. For example, the parameter that specifies the degree of balance between the distortion of the desired audio signal and the unnaturalness of the residual noise signal may be determined based at least in part on characteristics of the input audio signal. As noted above, the value of the parameter that specifies the degree of balance between the distortion of the desired audio signal and the unnaturalness of the residual noise signal may be different for each frequency sub-band or may be the same across some or all frequency sub-bands.

In certain embodiments, step 1106 involves multiplying the frequency domain representation of the input audio signal by a frequency domain gain function that is controlled by at least the parameter that specifies the degree of balance between the distortion of the desired audio signal and the unnaturalness of the residual noise signal and a frequency-dependent noise attenuation factor. For example, the frequency domain gain function may be the frequency domain gain function represented by Equation 84 and the frequency-dependent noise attenuation factor may comprise the parameter Hₛ(f) included in that equation. However, this is one example only and other frequency domain gain functions that include a frequency-dependent noise attenuation factor may be used. In certain embodiments, the value of the parameter that specifies the degree of balance between the distortion of the desired audio signal and the unnaturalness of the residual noise signal for a particular sub-band is determined based on the value of the noise attenuation factor for that sub-band.

In certain implementations, the method of flowchart 1100 further includes estimating statistics comprising power spectra associated with the input audio signal and power spectra associated with the additive noise signal. For example and without limitation, this estimation of statistics may comprise estimating |Y(f)|² and |S(f)|² with respect to the frequency domain gain function of Equation 84 discussed above, although this is only one example. In accordance with such an implementation, step 1106 may involve multiplying the frequency domain representation of the input audio signal by a frequency domain gain function that is a function of at least the parameter that specifies the degree of balance between the distortion of the desired audio signal and the unnaturalness of the residual noise signal and at least some of the estimated statistics.

At step 1108, the frequency domain representation of the noise-suppressed audio signal generated during step 1106 is converted into a time domain representation of the noise-suppressed audio signal. Various well-known techniques may be utilized to perform this time domain conversion step. For example and without limitation, an inverse FFT may be used or a synthesis filter bank may be used.

At step 1110, the time domain representation of the noise-suppressed audio signal is output. Depending upon the implementation, the time domain representation of the noise-suppressed audio signal may then be further processed, stored, transmitted to a remote entity, or played back to a user.

In certain embodiments, additional processing of the frequency domain representation of the input audio signal generated during step 1104 occurs prior to the multiplication of that signal by the frequency domain gain function in step 1106. Furthermore, in certain embodiments, additional processing of the frequency domain representation of the noise suppressed audio signal generated during 1106 occurs prior to conversion of that signal to the time domain in step 1108.

### E. Dual-Channel Noise Suppression in the Frequency Domain in Accordance with Embodiments of the Present Invention

As noted above, FIG. 6 is a high-level block diagram of a dual-channel noise suppression system 600 in accordance with an embodiment of the present invention. System 600 includes a noise suppressor 602 that receives a first input audio signal that comprises a first desired audio signal and a first additive noise signal and a second input audio signal that comprises a second desired audio signal and a second additive noise signal. Noise suppressor 602 processes the first input audio signal to generate a first processed audio signal, processes the second input audio signal to generate a second processed audio signal, and then combines the first processed audio signal and the second processed audio signal to produce the noise-suppressed audio signal for output.

In embodiments to be described in this section, noise suppressor 602 operates to multiply a frequency domain representation of the first input audio signal by a first frequency domain gain function that is controlled by at least a parameter that specifies a degree of balance between distortion of the first desired audio signal and unnaturalness of a residual noise signal included in the noise-suppressed audio signal, to multiply a frequency domain representation of the second input audio signal by a second frequency domain gain function that is controlled by at least the parameter that specifies the degree of balance between the distortion of the first desired audio signal and the unnaturalness of the residual noise signal, and to combine the products of these multiplication operations to produce the noise-suppressed audio signal. In the following, exemplary derivations of the two frequency domain gain functions will first be described. An exemplary implementation of noise suppressor 602 that utilizes such frequency domain gain functions will then be described. Finally, exemplary methods for performing dual-channel noise suppression in the frequency domain will be described.

1. Example Derivation of Frequency Domain Gain Function for Dual-Channel Noise Suppression

This section derives the frequency domain variation of the time domain algorithm proposed in Section C.1. In the frequency domain the input audio signals are given by

Y₁(f)=X₁(f)+S₁(f), and (94)

Y₂(f)=X₂(f)+S₂(f) (95)

The dual channel noise suppression is performed according to

\hat{X}₁(f)=H₁(f)Y₁(f)+H₂(f)Y₂(f) (96)

and the algorithm to estimate the two noise suppression gain functions, H₁(f) and H₂(f), corresponding to the two FIR noise suppression filters, h₁(k) and h₂(k) in Equation 41, needs to be derived. The error with respect to the first desired audio signal at the first microphone plus an attenuated or spectrally shaped version of the original noise at the first microphone is expressed as:

$$\begin{matrix}E ( f ) = [ {X}_{1} ( f ) + {H}_{s} ( f ) {S}_{1} ( f ) ] - {\hat{X}}_{1} ( f ) \\ = [ {X}_{1} ( f ) + {H}_{s} ( f ) {S}_{1} ( f ) ] - {H}_{1} ( f ) [ {X}_{1} ( f ) + {S}_{1} ( f ) ] - \\ {H}_{2} ( f ) [ {X}_{2} ( f ) + {S}_{2} ( f ) ] \\ = {X}_{1} ( f ) [ 1 - {H}_{1} ( f ) ] - {H}_{2} ( f ) {X}_{2} ( f ) + {S}_{1} ( f ) \\ [ {H}_{s} ( f ) - {H}_{1} ( f ) ] - {H}_{2} ( f ) {S}_{2} ( f ) .\end{matrix} \qquad ( 97 )$$

This is the frequency domain counterpart of Equation 63. The distortion of the first audio signal in Equation 97 is given by

Eₓ_{₁}(f)=X₁(f)[1−H₁(f)]−H₂(f)X₂(f) (98)

and the cost function for distortion of the first audio signal is expressed as

$$\begin{matrix}{E}_{{x}_{1}} = {\sum }_{n} {e}_{{x}_{1}}^{2} ( n ) \\ = \frac{1}{N} {\sum }_{f} {E}_{{x}_{1}} ( f ) {E}_{{x}_{1}}^{*} ( f ) \\ = \frac{1}{N} {\sum }_{f} ( {X}_{1} ( f ) [ 1 - {H}_{1} ( f ) ] - {H}_{2} ( f ) {X}_{2} ( f ) ) \\ {( {X}_{1} ( f ) [ 1 - {H}_{1} ( f ) ] - {H}_{2} ( f ) {X}_{2} ( f ) )}^{*} \\ = \frac{1}{N} {\sum }_{f} {X}_{1} ( f ) {{X}_{1}^{*} ( f ) [ 1 - {H}_{1} ( f ) ] [ 1 - {H}_{1} ( f ) ]}^{*} + \\ {X}_{2} ( f ) {X}_{2}^{*} ( f ) {H}_{2} ( f ) {H}_{2}^{*} ( f ) - 2 Re \\ \{ {X}_{1} ( f ) [ 1 - {H}_{1} ( f ) ] {H}_{2}^{*} ( f ) {X}_{2}^{*} ( f ) \} \\ = \frac{1}{N} {\sum }_{f} {\vert {X}_{1} ( f ) \vert}^{2} {\vert [ 1 - {H}_{1} ( f ) ] \vert}^{2} + {\vert {X}_{2} ( f ) \vert}^{2} {\vert {H}_{2} ( f ) \vert}^{2} - \\ 2 Re \{ {X}_{1} ( f ) {X}_{2}^{*} ( f ) [ 1 - {H}_{1} ( f ) ] {H}_{2}^{*} ( f ) \}\end{matrix} \qquad ( 99 )$$

By assuming independence between the desired audio signal and the noise, and constraining the gain functions as well as the noise attenuation/spectral shaping function to be real, Equation 99 can be written as

$${E}_{{x}_{1}} = \frac{1}{N} {\sum }_{f} {( {\vert {Y}_{1} ( f ) \vert}^{2} - {\vert {S}_{1} ( f ) \vert}^{2} ) [ 1 - {H}_{1} ( f ) ]}^{2} + ( {\vert {Y}_{2} ( f ) \vert}^{2} - {\vert {S}_{2} ( f ) \vert}^{2} ) {H}_{2}^{2} ( f ) - 2 [ 1 - {H}_{1} ( f ) ] {H}_{2} ( f ) Re \{ {Y}_{1} ( f ) {Y}_{2}^{*} ( f ) - {S}_{1} ( f ) {S}_{2}^{*} ( f ) \} \qquad ( 100 )$$

The derivatives with respect to H₁(f) and H₂(f) can be derived from Equation 100 as

$$\begin{matrix}\frac{\partial {E}_{{x}_{1}}}{\partial {H}_{1} ( f )} = - 2 \frac{1}{N} [ 1 - {H}_{1} ( f ) ] ( {\vert {Y}_{1} ( f ) \vert}^{2} - {\vert {S}_{1} ( f ) \vert}^{2} ) + 2 \frac{1}{N} {H}_{2} ( f ) Re \{ {Y}_{1} ( f ) {Y}_{2}^{*} ( f ) - {S}_{1} ( f ) {S}_{2}^{*} ( f ) \} \\ and & ( 101 ) \\ \frac{\partial {E}_{{x}_{1}}}{\partial {H}_{2} ( f )} = 2 \frac{1}{N} {H}_{2} ( f ) ( {\vert {Y}_{2} ( f ) \vert}^{2} - {\vert {S}_{2} ( f ) \vert}^{2} ) - 2 \frac{1}{N} [ 1 - {H}_{1} ( f ) ] Re \{ {Y}_{1} ( f ) {Y}_{2}^{*} ( f ) - {S}_{1} ( f ) {S}_{2}^{*} ( f ) \} . & ( 102 )\end{matrix}$$

The unnaturalness of the residual noise component of Equation 97 is given by

Eₛ_{₁}(f)=S₁(f)[Hₛ(f)−H₁(f)]−H₂(f)S₁(f) (103)

and the corresponding cost function is expressed as

$$\begin{matrix}{E}_{{s}_{1}} = {\sum }_{n} {e}_{{s}_{1}}^{2} ( n ) \\ = \frac{1}{N} {\sum }_{f} {E}_{{s}_{1}} ( f ) {E}_{{s}_{1}}^{*} ( f ) \\ = \frac{1}{N} {\sum }_{f} ( {S}_{1} ( f ) [ {H}_{s} ( f ) - {H}_{1} ( f ) ] - {H}_{2} ( f ) {S}_{2} ( f ) ) \\ {( {S}_{1} ( f ) [ {H}_{s} ( f ) - {H}_{1} ( f ) ] - {H}_{2} ( f ) {S}_{2} ( f ) )}^{*} \\ = \frac{1}{N} {\sum }_{f} {\vert {S}_{1} ( f ) \vert}^{2} {\vert [ {H}_{s} ( f ) - {H}_{1} ( f ) ] \vert}^{2} + {\vert {S}_{2} ( f ) \vert}^{2} {\vert {H}_{2} ( f ) \vert}^{2} - \\ 2 Re \{ {S}_{1} ( f ) {S}_{2}^{*} ( f ) [ {H}_{s} ( f ) - {H}_{1} ( f ) ] {H}_{2}^{*} ( f ) \} .\end{matrix} \qquad ( 104 )$$

Again, restricting the gain functions as well as the noise attenuation/spectral shaping function to be real, Equation 104 can be re-written as

$${E}_{{s}_{1}} = \frac{1}{N} {\sum }_{f} {{\vert {S}_{1} ( f ) \vert}^{2} [ {H}_{s} ( f ) - {H}_{1} ( f ) ]}^{2} + {\vert {S}_{2} ( f ) \vert}^{2} {H}_{2}^{2} ( f ) - 2 [ {H}_{s} ( f ) - {H}_{1} ( f ) ] {H}_{2} ( f ) Re \{ {S}_{1} ( f ) {S}_{2}^{*} ( f ) \} . \qquad ( 105 )$$

The derivatives with respect to H₁(f) and H₂(f) are derived from Equation 105 as

$$\begin{matrix}\frac{\partial {E}_{{s}_{1}}}{\partial {H}_{1} ( f )} = - 2 \frac{1}{N} [ {H}_{s} ( f ) - {H}_{1} ( f ) ] {\vert {S}_{1} ( f ) \vert}^{2} + 2 \frac{1}{N} {H}_{2} ( f ) Re \{ {S}_{1} ( f ) {S}_{2}^{*} ( f ) \} , \\ and & ( 106 ) \\ \frac{\partial {E}_{{s}_{1}}}{\partial {H}_{2} ( f )} = 2 \frac{1}{N} {\vert {S}_{2} ( f ) \vert}^{2} {H}_{2} ( f ) - 2 \frac{1}{N} [ {H}_{s} ( f ) - {H}_{1} ( f ) ] Re \{ {S}_{1} ( f ) {S}_{2}^{*} ( f ) \} . & ( 107 )\end{matrix}$$

As in preceding sections, the weighted composite cost function is written as

E=αEₓ+(1−α)Eₛ, (108)

and the derivatives with respect to the two gain functions H₁(f) and H₂(f) are

$$\frac{\partial E}{\partial {H}_{1} ( f )} = α \frac{\partial {E}_{x}}{\partial {H}_{1} ( f )} + ( 1 - α ) \frac{\partial {E}_{s}}{\partial {H}_{1} ( f )} = 0 \\ \frac{\partial E}{\partial {H}_{2} ( f )} = α \frac{\partial {E}_{x}}{\partial {H}_{2} ( f )} + ( 1 - α ) \frac{\partial {E}_{s}}{\partial {H}_{2} ( f )} = 0 , \qquad ( 109 )$$

respectively. Utilizing Equations 101, 102, 106 and 107, the equations that the solution must satisfy can be written in matrix form as

$$[ \begin{matrix}α {\vert {Y}_{1} ( f ) \vert}^{2} + ( 1 - 2 α ) {\vert {S}_{1} ( f ) \vert}^{2} & αRe \begin{matrix}\{ {Y}_{1} ( f ) {Y}_{2}^{*} ( f ) \} + \\ ( 1 - 2 α ) Re \{ {S}_{1} ( f ) {S}_{2}^{*} ( f ) \}\end{matrix} \\ αRe \begin{matrix}\{ {Y}_{1} ( f ) {Y}_{2}^{*} ( f ) \} + \\ ( 1 - 2 α ) Re \{ {S}_{1} ( f ) {S}_{2}^{*} ( f ) \}\end{matrix} & α {\vert {Y}_{2} ( f ) \vert}^{2} + ( 1 - 2 α ) {\vert {S}_{2} ( f ) \vert}^{2}\end{matrix} ] \\ [ \begin{matrix}{H}_{1} ( f ) \\ {H}_{2} ( f )\end{matrix} ] = [ \begin{matrix}α ( {\vert {Y}_{1} ( f ) \vert}^{2} - {\vert {S}_{1} ( f ) \vert}^{2} ) + ( 1 - α ) {H}_{s} ( f ) {\vert {S}_{1} ( f ) \vert}^{2} \\ α ( \begin{matrix}Re \{ {Y}_{1} ( f ) {Y}_{2}^{*} ( f ) \} - \\ Re \{ {S}_{1} ( f ) {S}_{2}^{*} ( f ) \}\end{matrix} ) + ( 1 - α ) {H}_{s} ( f ) Re \{ {S}_{1} ( f ) {S}_{2}^{*} ( f ) \}\end{matrix} ]$$

Again, the solution has structural resemblance to the solution for the time domain equivalent, see Equation 71. However, the matrix equation in Equation 110 is only second order while the matrix Equation in Equation 71 is (K₁+K₂+2)^{th} order. For the time domain solution only a single equation of the form in Equation 71 needs to be solved, i.e., a single (K₁+K₂+2)×(K₁+K₂+2) matrix inverted, while for the frequency domain solution only a 2×2 matrix needs to be inverted, but one for every frequency bin. Since Equation 110 is a second order linear set of equations with the form

$$[ \begin{matrix}a & b \\ b & c\end{matrix} ] [ \begin{matrix}{h}_{1} \\ {h}_{2}\end{matrix} ] = [ \begin{matrix}d \\ e\end{matrix} ] \qquad ( 111 )$$

the closed-form solution can be derived as

$${h}_{1} = \frac{cd - be}{a c - {b}^{2}} \\ {h}_{2} = \frac{ae - bd}{ac - {b}^{2}} \qquad ( 112 )$$

where

a=α|Y₁(f)|²+(1−2α)|S₁(f)|² (113)

b=αRe{Y₁(f)Y₂*(f)}+(1−2α)Re{S₁(f)S₂*(f)} (114)

c=α|Y₁(f)|²+(1−2α)|S₂(f)|² (115)

d=α(|Y₁(f)|²−|S₁(f)|²)+(1−α)Hₛ(f)|S₁(f)|², and (116)

e=α(Re{Y₁(f)Y₂*(f)}−Re{S₁(f)S₂*(f)})+(1−α)Hₛ(f)Re{S₁(f)S₂*(f)}. (117)

The dual channel noise suppression gain functions are then given by

H₁(f)=h₁, and (118)

H₂(f)=h₂. (119)

In practice, the two microphone signals may be highly coherent (since they are observing the same auditory scene from close albeit different positions) and the matrix of Equation 111 may become ill-conditioned, or of sufficiently poor condition to provide a useable solution through the matrix inversion taking place via Equation 112 through Equation 119. This is a phenomenon also known from stereophonic acoustic echo cancellation, and a solution proposed in J. Benesty, et al., “A Better Understanding and an Improved Solution to the Problems of Stereophonic Acoustic Echo Cancellation,” Proc. IEEE ICASSP, 1997, pp. 303-306 (the entirety of which is incorporated by reference herein), improves the ill-conditioning substantially. Basically, the two microphone signals are passed through a non-linearity such that the coherence is reduced. For the present work, the non-linearity of the Benesty et al. reference:

$${y}_{1} ( n ) ← \{ \begin{matrix}1.5 {y}_{1} ( n ) & if {y}_{1} ( n ) > 0 \\ {y}_{1} ( n ) & otherwise ,\end{matrix} \qquad ( 120 )$$

and likewise for the second input audio signal:

$${y}_{2} ( n ) ← \{ \begin{matrix}1.5 {y}_{2} ( n ) & if {y}_{2} ( n ) > 0 \\ {y}_{1} ( n ) & otherwise ,\end{matrix} \qquad ( 121 )$$

appears to provide a significant improvement of the conditioning of the matrix.

Another method that improves the conditioning of the matrix is diagonal loading which is known from the field of beamforming See, for example, B. D. Carlson, “Covariance Matrix Estimation Errors and Diagonal Loading in Adaptive Arrays,” IEEE Transactions on Aerospace and Electronic Systems, Vol. 24, No. 4, pp. 391-401, July 1988, the entirety of which is incorporated by reference herein.

2. Example Dual-Channel Frequency Domain Noise Suppressor

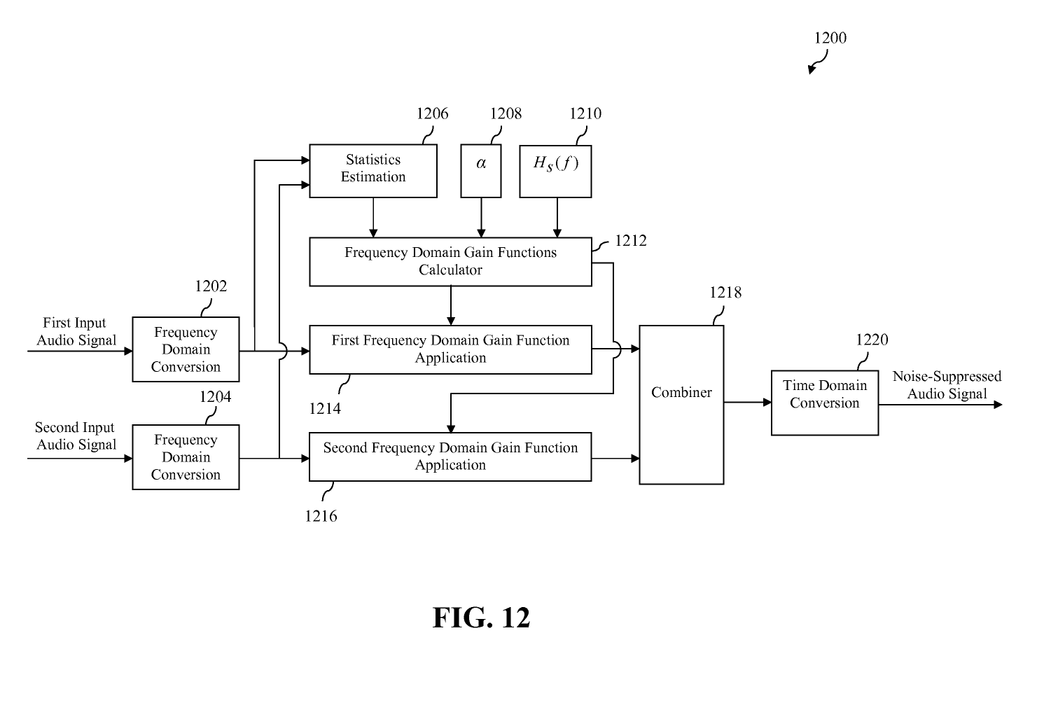

FIG. 12 is a block diagram of an example dual-channel frequency domain noise suppressor 1200 in accordance with an embodiment of the present invention. Noise suppressor 1200 may comprise, for example, a particular implementation of noise suppressor 602 of system 600 as described above in reference to FIG. 6. Generally speaking, noise suppressor 1200 operates to obtain a frequency domain representation of a first input audio signal that comprises a first desired audio signal and a first additive noise signal and a frequency domain representation of a second input audio signal that comprises a second desired audio signal and a second additive noise component. Noise suppressor 1200 processes the frequency domain representations of the first input audio signal and the second input audio signal to produce a noise-suppressed audio signal. As shown in FIG. 12, noise suppressor 1200 comprises a number of interconnected components including a first frequency domain conversion module 1202, a second frequency domain conversion module 1204, a statistics estimation module 1206, a first parameter provider module 1208, a second parameter provider module 1210, a frequency domain gain functions calculator 1212, a first frequency domain gain function application module 1214, a second frequency domain gain function application module 1216, a combiner 1218 and a time domain conversion module 1220.

First frequency domain conversion module 1202 is configured to receive a time domain representation of the first input audio signal and to convert it into a frequency domain representation of the first input audio signal. Second frequency domain conversion module 1204 is configured to receive a time domain representation of the second input audio signal and to convert it into a frequency domain representation of the second input audio signal. Various well-known techniques may be utilized by first and second frequency domain conversion modules 1202 and 1204 to perform the frequency conversion function. For example and without limitation, a FFT may be used or an analysis filter bank may be used.

Statistics estimation module 1206 is configured to calculate estimates of statistics associated with the first input audio signal, the first additive noise signal, the second input audio signal, and the second additive noise signal for use by frequency domain gain functions calculator 1212 in calculating a first frequency domain gain function to be applied by first frequency domain gain function application module 1214 and a second frequency domain gain function to be applied by second frequency domain gain function application module 1216. The calculation of estimates may occur on some periodic or non-periodic basis depending upon a control scheme. In certain embodiments, statistics estimation module 1206 estimates the statistics by estimating power spectra associated with the first input audio signal, power spectra associated with the second input audio signal, power spectra associated with the first additive noise signal, power spectra associated with the second additive noise signal, cross-power-spectra associated with the first and second input audio signals and cross-power spectra associated with the first and second additive noise signals. For example, with respect to the two frequency domain gain functions respectively represented by Equations 118 and 119 discussed above, statistics estimation module 1206 may estimate |Y₁(f)|², |Y₂(f)|², |S₁(f)|², |S₂(f)|², {Y₁(f)Y₂*(f)} {S₁(f)S₂*(f)}, although this is only one example.

Statistics estimation module 1206 can estimate the statistics of the received input audio signals directly. In an embodiment in which the two input audio signals are speech signals, statistics estimation module 1206 may estimate the statistics of the additive noise signals during non-speech segments, premised on the assumption that the additive noise signals will be sufficiently stationary during valid speech segments. In accordance with such an embodiment, statistics estimation module 1206 may include functionality that is capable of classifying segments of the input audio signals as speech or non-speech segments. Alternatively, statistics estimation module 1206 may be connected to another entity that is capable of performing such a function. Of course, numerous other methods may be used to estimate the statistics of the additive noise signals.

First parameter provider module 1208 is configured to obtain a value of a parameter α that specifies a degree of balance between distortion of the first desired audio signal included in the first input audio signal and unnaturalness of a residual noise signal included in the output noise-suppressed audio signal and to provide the value of the parameter α to frequency domain gain functions calculator 1212. By way of example only, the parameter α may be that discussed above and utilized in defining the two frequency domain gain functions of Equations 118 and 119. Note that a different value of the parameter α may be specified for each frequency sub-band or the same value of the parameter α may be used for some or all of the frequency sub-bands. The parameter value(s) may be specified during design or tuning of a device that includes noise suppressor 1200, determined based on some form of user input, and/or adaptively determined based on factors such as, but not limited to, characteristics of the first input audio signal and/or the second input audio signal.

Second parameter provider module 1210 is configured to provide a frequency-dependent noise attenuation factor, Hₛ(f), to frequency domain gain functions calculator 1212 for use in calculating a first frequency domain gain function to be applied by first frequency domain gain function application module 1214 and a second frequency domain gain function to be applied by second frequency domain gain function application module 1216. The frequency-dependent noise attenuation factor, Hₛ(f), may be that discussed above and utilized in defining the two frequency domain gain functions of Equations 118 and 119, although this is only an example. If the noise attenuation factor is the same across all frequency sub-bands, then this will be the same as applying a flat attenuation to the noise signal. If the noise attenuation factor varies from sub-band to sub-band, then arbitrary noise shaping can be achieved. Depending upon the implementation, the frequency-dependent noise attenuation factor, Hₛ(f), may be specified during design or tuning of a device that includes noise suppressor 1200, determined based on some form of user input, and/or adaptively determined based on factors such as, but not limited to, characteristics of the input audio signal.

In certain embodiments, first parameter provider module 1208 determines a value of the parameter α based on the value of the frequency-dependent noise attenuation factor, Hₛ(f), for a particular sub-band. Such an embodiment takes into account that certain values of α may provide a better trade-off between distortion of the desired audio signal and unnaturalness of the residual noise signal at different levels of noise attenuation.

Frequency domain gain functions calculator 1212 is configured to obtain, for each frequency sub-band, estimates of statistics associated with the first and second input audio signals and the first and second additive noise signals from statistics estimation module 1206, the value of the parameter α that specifies the degree of balance between the distortion of the first desired audio signal and the unnaturalness of the residual noise signal provided by first parameter provider module 1208, and the value of the frequency-dependent noise attenuation factor, Hₛ(f). Frequency domain gain functions calculator 1212 then uses those values to calculate a first frequency domain gain function to be applied by first frequency domain gain function application module 1214 and a second frequency domain gain function to be applied by second frequency domain gain function application module 1216. For example, frequency domain gain functions calculator 1212 may use these values to calculate first and second frequency domain gain functions in accordance with Equation 118 and 119, although this is only one example. The calculation of the first and second frequency domain gain functions may occur on a periodic or non-periodic basis dependent upon a control scheme.

First frequency domain gain function application module 1214 is configured to multiply the frequency domain representation of the first input audio signal received from first frequency domain conversion module 1202 by the first frequency domain gain function constructed by frequency domain gain functions calculator 1212 to produce a first product. Second frequency domain gain function application module 1216 is configured to multiply the frequency domain representation of the second input audio signal received from second frequency domain conversion module 1204 by the second frequency domain gain function constructed by frequency domain gain functions calculator 1212 to produce a second product. Combiner 1218 is configured to add the first product received from first frequency domain gain function application module 1214 with the second product received from second frequency domain gain function application module 1216 to produce a frequency domain representation of the noise-suppressed audio signal. Persons skilled in the relevant art(s) will appreciate that in certain implementations an operation other than addition may be used to combine the first product and the second product to produce the frequency domain representation of the noise-suppressed audio signal.

Time domain conversion module 1220 receives the frequency domain representation of the noise-suppressed audio signal from combiner 1218 and converts it into a time domain representation of the noise-suppressed audio signal. Various well-known techniques may be utilized to perform the time domain conversion function. For example and without limitation, an inverse FFT or synthesis filter bank may be used.

Although FIG. 12 shows that first frequency domain conversion module 1202 is directly connected to first frequency domain gain function application module 1214, in certain embodiments one or more intermediate processing components may be connected between these two components. That is to say, some form of processing of the frequency domain representation of the first input audio signal may occur prior to processing of that signal by first frequency domain gain function application module 1214. Likewise, although FIG. 12 shows that second frequency domain conversion module 1204 is directly connected to second frequency domain gain function application module 1216, in certain embodiments one or more intermediate processing components may be connected between these two components. That is to say, some form of processing of the frequency domain representation of the second input audio signal may occur prior to processing of that signal by second frequency domain gain function application module 1216. Furthermore, although FIG. 12 shows that time domain conversion module 1220 is directly connected to comber 1218, in certain embodiments one or more intermediate processing components may be connected between these two components. That is to say, some form of processing of the frequency domain representation of the noise-suppressed audio signal may occur prior to conversion of that signal to the time domain by time domain conversion module 1220.

3. Example Methods for Performing Dual-Channel Noise Suppression in the Frequency Domain

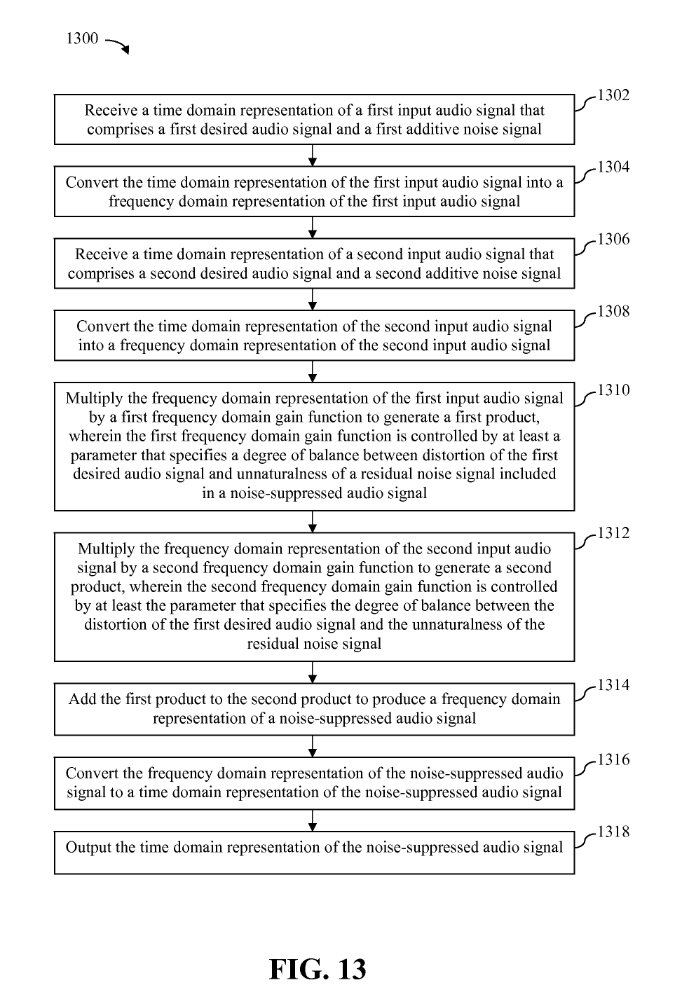

FIG. 13 depicts a flowchart 1300 of a method for performing dual-channel noise suppression in the frequency domain in accordance with an embodiment of the present invention. The method of flowchart 1300 may be performed, for example and without limitation, by noise suppressor 1200 as described above in reference to FIG. 12. However, the method is not limited to those implementations.

As shown in FIG. 13, the method of flowchart 1300 begins at step 1302 in which a time domain representation of a first input audio signal is received, wherein the first input audio signal comprises a first desired audio signal and a first additive noise signal. At step 1304, the time domain representation of the first input audio signal is converted into a frequency domain representation of the first audio signal.

At step 1306, a time domain representation of a second input audio signal is received, wherein the second input audio signal comprises a second desired audio signal and a second additive noise signal. At step 1308, the time domain representation of the second input audio signal is converted into a frequency domain representation of the second audio signal. Various well-known techniques may be utilized to perform the frequency conversion of steps 1304 and 1308, including but not limited to use of a FFT or analysis filter bank.

At step 1310, the frequency domain representation of the first input audio signal is multiplied by a first frequency domain gain function to generate a first product, wherein the first frequency domain gain function is controlled by at least a parameter that specifies a degree of balance between distortion of the first desired audio signal and unnaturalness of a residual noise signal included in a noise-suppressed audio signal. At step 1312, the frequency domain representation of the second input audio signal is multiplied by a second frequency domain gain function to generate a second product, wherein the second frequency domain gain function is controlled by at least the parameter that specifies the degree of balance between the distortion of the first desired audio signal and the unnaturalness of the residual noise signal. For example, the first and second frequency domain gain functions may correspond to the frequency domain gain functions specified by Equations 118 and 119 and the parameter that specifies the degree of balance between the distortion of the first desired audio signal and the unnaturalness of the residual noise signal may comprise the parameter α included in those equations. However, these are examples only and other frequency domain gain functions may be used.

Depending upon the implementation, the parameter that specifies the degree of balance between the distortion of the first desired audio signal and the unnaturalness of the residual noise signal may be determined in a variety of ways. For example, the parameter that specifies the degree of balance between the distortion of the first desired audio signal and the unnaturalness of the residual noise signal may be determined based at least in part on characteristics of the first input audio signal and/or the second input audio signal. As noted above, the value of the parameter that specifies the degree of balance between the distortion of the first desired audio signal and the unnaturalness of the residual noise signal may be different for each frequency sub-band or may be the same across some or all frequency sub-bands.

In certain embodiments, step 1310 involves multiplying the frequency domain representation of the first input audio signal by a first frequency domain gain function that is controlled by at least the parameter that specifies the degree of balance between the distortion of the first desired audio signal and the unnaturalness of the residual noise signal and a frequency-dependent noise attenuation factor and step 1312 involves multiplying the frequency domain representation of the second input audio signal by a second frequency domain gain function that is controlled by at least the parameter that specifies the degree of balance between the distortion of the first desired audio signal and the unnaturalness of the residual noise signal and the frequency-dependent noise attenuation factor. For example, the first and second frequency domain gain functions may be the first and second frequency domain gain functions represented by Equations 118 and 119 and the frequency-dependent noise attenuation factor may comprise the parameter Hₛ(f) included in those equations. However, this is one example only and other frequency domain gain functions that include a frequency-dependent noise attenuation factor may be used. In certain embodiments, the value of the parameter that specifies the degree of balance between the distortion of the first desired audio signal and the unnaturalness of the residual noise signal for a particular sub-band is determined based on the value of the noise attenuation factor for that sub-band.

In certain implementations, the method of flowchart 1300 further includes estimating statistics comprising power spectra associated with the first input audio signal, power spectra associated with the second input audio signal, power spectra associated with the first additive noise signal, power spectra associated with the second additive noise signal, cross-power-spectra associated with the first and second input audio signals, and cross-power-spectra associated with the first and second additive noise signals. For example and without limitation, this estimation of statistics may comprise estimating |Y₁(f)|², |Y₂(f)|², |S₁(f)|², |S₂(f)|², {Y₁(f)Y₂*(f)} and {S₁(f)S₂*(f)} with respect to the frequency domain gain functions of Equations 118 and 119 discussed above, although this is only one example.

In accordance with such an implementation, step 1310 may involve multiplying the frequency domain representation of the first input audio signal by a first frequency domain gain function that is a function of at least the parameter that specifies the degree of balance between the distortion of the first desired audio signal and the unnaturalness of the residual noise signal and at least some of the estimated statistics and step 1312 may involve multiplying the frequency domain representation of the second input audio signal by a second frequency domain gain function that is a function of at least the parameter that specifies the degree of balance between the distortion of the first desired audio signal and the unnaturalness of the residual noise signal and at least some of the estimated statistics.

At step 1314, the first product generated during step 1310 and the second product generated during step 1312 are added together to produce a frequency domain representation of the noise-suppressed audio signal. Persons skilled in the relevant art(s) will readily appreciate that methods other than addition may also be used to combine the first product and the second product to produce the frequency domain representation of the noise-suppressed audio signal.

At step 1316, the frequency domain representation of the noise-suppressed audio signal is converted into a time domain representation of the noise-suppressed audio signal. Various well-known techniques may be utilized to perform the time domain conversion of step 1316, including but not limited to use of an inverse FFT or synthesis filter bank.

At step 1318, the time domain representation of the noise-suppressed audio signal generated during step 1316 is output. Depending upon the implementation, the time domain representation of the noise-suppressed audio signal may then be further processed, stored, transmitted to a remote entity, or played back to a user.

In certain embodiments, additional processing of the frequency domain representation of the first input audio signal generated during step 1304 occurs prior to the multiplication of that signal by the first frequency domain gain function in step 1310. Likewise, in certain embodiments, additional processing of the frequency domain representation of the second input audio signal generated during step 1308 occurs prior to the multiplication of that signal by the second frequency domain gain function in step 1312. Furthermore, in certain embodiments, additional processing of the frequency domain representation of the noise suppressed audio signal generated during 1314 occurs prior to conversion of that signal to the time domain in step 1316.

### F. Single-Channel Hybrid Noise Suppression in Accordance with Embodiments of the Present Invention

A hybrid variation of a single-channel noise suppression framework in accordance with an embodiment of the present invention will now be described. The hybrid variation combines the time domain and frequency domain approaches described above. This can be a practical solution to performing noise suppression within a sub-band based audio system where an increased frequency resolution is desirable for the noise suppressor. The limited frequency resolution is expanded by applying a low-order time domain solution to individual sub-bands. This also offers the possibility of expanding the frequency resolution of sub-bands based on a psycho-acoustically motivated frequency resolution, e.g., expand low frequency regions more than high frequency regions. As a practical example, one may have a sub-band decomposition with 32 complex sub-bands in 0 to 4 kHz. This provides a spectral resolution of 125 Hz which may be inadequate. Instead of expanding spectral resolution of all sub-bands to 32 Hz by a 4^{th} order noise suppression filter in every sub-band, it may be desirable to expands the low sub-bands by 4, the middle sub-bands by 2, and leave the upper sub-bands at the native resolution.

In the following, an example derivation of a hybrid approach for single-channel noise suppression is first described. An exemplary implementation of a noise suppressor that utilizes such a hybrid approach for performing single-channel noise suppression will then be described. Finally, exemplary methods for performing single-channel noise suppression using the hybrid approach will be described.

1. Example Derivation of Hybrid Approach for Single-Channel Noise Suppression

In the frequency domain the assumption of the desired audio signal and the noise signal being additive results in an observed signal given by

Y(f)=X(f)+S(f), (122)

where the capital letter variables represent the discrete Fourier transform of the corresponding lower case time domain variables. The hybrid noise suppression is achieved by a filtering of the sub-band signals in the time direction:

$$\hat{X} ( f ) = {\sum }_{k = 0}^{K} {H}^{*} ( k , f ) Y ( n - k , f ) \qquad ( 123 )$$

wherein f is the sub-band index, n indexes the current time index, ( )* indicates complex conjugate, and H(k,f), k=0, 1, . . . , K are the individual noise suppression filters for every frequency index f. Going forward, the term time direction filter will be used to refer to a filter such as that described above that filters sub-band signals in the time direction. Note that the sub-band signals can be complex, and hence a solution will differ from a previously-described time domain solution. As in previous sections, the target of the noise suppression is the desired audio signal plus an attenuated (and possibly spectrally shaped) version of the original noise. Hence, the error of the noise suppression is defined as

$$\begin{matrix}E ( n , f ) = [ X ( n , f ) + {H}_{s} ( f ) S ( n , f ) ] - \hat{X} ( n , f ) \\ = [ X ( n , f ) + {H}_{s} ( f ) S ( n , f ) ] - \\ {\sum }_{k = 0}^{K} {H}^{*} ( k , f ) Y ( n - k , f ) \\ = [ X ( n , f ) + {H}_{s} ( f ) S ( n , f ) ] - {\sum }_{k = 0}^{K} {H}^{*} ( k , f ) \\ [ X ( n - k , f ) + S ( n - k , f ) ] \\ = X ( n , f ) - {\sum }_{k = 0}^{K} {H}^{*} ( k , f ) X ( n - k , f ) + \\ {H}_{s} ( f ) S ( n , f ) - {\sum }_{k = 0}^{K} {H}^{*} ( k , f ) S ( n - k , f )\end{matrix} \qquad ( 124 )$$

where Hₛ(f) represents the desired attenuation and possibly shaping of the residual noise signal. Based on Equation 124, the distortion of the desired audio signal is defined as

$${E}_{x} ( n , f ) = X ( n , f ) - {\sum }_{k = 0}^{K} {H}^{*} ( k , f ) X ( n - k , f ) \qquad ( 125 )$$

and the unnaturalness of the residual noise signal is defined as

$${E}_{s} ( n , f ) = {H}_{s} ( f ) S ( n , f ) - {\sum }_{k = 0}^{K} {H}^{*} ( k , f ) S ( n - k , f ) . \qquad ( 126 )$$

The cost function for the distortion of the desired audio signal is given by

$$\begin{matrix}{E}_{x} = {\sum }_{n} {\sum }_{f} {E}_{x} ( n , f ) {E}_{x}^{*} ( n , f ) \\ = {\sum }_{n} {\sum }_{f} ( X ( n , f ) - {\sum }_{k = 0}^{K} {H}^{*} ( k , f ) X ( n - k , f ) ) \\ ( {X}^{*} ( n , f ) - {\sum }_{k = 0}^{K} H ( k , f ) {X}^{*} ( n - k , f ) ) \\ = {\sum }_{f} ( \begin{matrix}{\sum }_{n} X ( n , f ) {X}^{*} ( n , f ) + {\sum }_{n} [ {\underline{H} ( f )}^{T} \underline{X} ( n , f ) ] \\ [ {\underline{X} ( n , f )}^{T} \underline{H} ( f ) ] - {\sum }_{n} X ( n , f ) [ {\underline{X} ( n , f )}^{T} \underline{H} ( f ) ] - \\ {\sum }_{n} [ {\underline{H} ( f )}^{T} \underline{X} ( n , f ) ] {X}^{*} ( n , f )\end{matrix} ) \\ = {\sum }_{f} ( \begin{matrix}[ {\sum }_{n} X ( n , f ) {X}^{*} ( n , f ) ] + {\underline{H} ( f )}^{T} [ {\sum }_{n} \underline{X} ( n , f ) {\underline{X} ( n , f )}^{T} ] \\ \underline{H} ( f ) - [ {\sum }_{n} {\underline{X} ( n , f )}^{T} X ( n , f ) ] \underline{H} ( f ) - {\underline{H} ( f )}^{T} \\ [ {\sum }_{n} \underline{X} ( n , f ) {X}^{*} ( n , f ) ]\end{matrix} )\end{matrix} \qquad ( 127 )$$

where the superscript denotes T conjugate transpose (also known as the Hermitian transpose) and

H(f)=[H(0,f),H(1,f), . . . ,H(K,f)]^{non-cT} (128)

and

X(n,f)=[X(n,f),X(n−1,f), . . . ,X(n−K,f)]^{non-cT}, (129)

i.e., the complex filter coefficients and signal samples, respectively, arranged in column vectors in non-conjugate form.

From the definition of the unnaturalness of the residual noise signal, Equation 126, the cost function for the unnaturalness of the residual noise signal is constructed as

$$\begin{matrix}{E}_{s} = {\sum }_{n} {\sum }_{f} {E}_{s} ( n , f ) {E}_{s}^{*} ( n , f ) \\ = {\sum }_{n} {\sum }_{f} ( {H}_{s} ( f ) S ( n , f ) - {\sum }_{k = 0}^{K} {H}^{*} ( k , f ) S ( n - k , f ) ) \\ ( {H}_{s} ( f ) {S}^{*} ( n , f ) - {\sum }_{k = 0}^{K} H ( k , f ) {S}^{*} ( n - k , f ) ) \\ = {\sum }_{f} ( \begin{matrix}{\sum }_{n} {H}_{s}^{2} ( f ) S ( n , f ) {S}^{*} ( n , f ) + {\sum }_{n} [ {\underline{H} ( f )}^{T} \underline{S} ( n , f ) ] \\ [ {\underline{S} ( n , f )}^{T} \underline{H} ( f ) ] - {\sum }_{n} {H}_{s} ( f ) S ( n , f ) [ {\underline{S} ( n , f )}^{T} \underline{H} ( f ) ] - \\ {\sum }_{n} [ {\underline{H} ( f )}^{T} \underline{S} ( n , f ) ] {H}_{s} ( f ) {S}^{*} ( n , f )\end{matrix} ) \\ = {\sum }_{f} ( \begin{matrix}{H}_{s}^{2} ( f ) [ {\sum }_{n} S ( n , f ) {S}^{*} ( n , f ) ] + {\underline{H} ( f )}^{T} \\ [ {\sum }_{n} \underline{S} ( n , f ) {\underline{S} ( n , f )}^{T} ] \underline{H} ( f ) - {H}_{s} ( f ) \\ [ {\sum }_{n} {\underline{S} ( n , f )}^{T} S ( n , f ) ] \underline{H} ( f ) - {H}_{s} ( f ) {\underline{H} ( f )}^{T} \\ [ {\sum }_{n} \underline{S} ( n , f ) {S}^{*} ( n , f ) ]\end{matrix} )\end{matrix} \qquad ( 130 )$$

where

S(n,f)=[S(n,f),S(n−1,f), . . . ,S(n−K,f)]^{non-cT} (131)

and under assumption of real residual noise shaping, Hₛ(f).

In a like manner to previous sections, the cost function is constructed as a weighted sum of the cost function for distortion of the desired audio signal and the cost function for the unnaturalness of the residual noise signal:

E=αEₓ+(1−α)Eₛ. (132)

Both the filter coefficients and signal samples can be complex which prevents taking the derivative of the cost function with respect to the filter coefficients due to the complex conjugate not being differentiable. Complex conjugate does not satisfy the Cauchy-Riemann equations. However, since the cost function is real, the gradient can be calculated.

$$\begin{matrix}{∇}_{k} ( E ) = \frac{\partial E}{\partial {H}_{R} ( k , f )} + j \frac{\partial E}{\partial {H}_{I} ( k , f )} \\ = α \frac{\partial {E}_{x}}{\partial {H}_{R} ( k , f )} + α j \frac{\partial {E}_{x}}{\partial {H}_{I} ( k , f )} , k = 0 , 1 , … K + \\ ( 1 - α ) \frac{\partial {E}_{s}}{\partial {H}_{R} ( k , f )} + ( 1 - α ) j \frac{\partial {E}_{s}}{\partial {H}_{I} ( k , f )}\end{matrix} \qquad ( 133 )$$

The individual terms are expanded as

$$\begin{matrix}\begin{matrix}\frac{\partial {E}_{x}}{\partial {H}_{R} ( k , f )} = {\sum }_{n} {E}_{x}^{*} ( n , f ) \frac{\partial {E}_{x} ( n , f )}{\partial {H}_{R} ( k , f )} + {E}_{x} ( n , f ) \frac{\partial {E}_{x}^{*} ( n , f )}{\partial {H}_{R} ( k , f )} \\ = - {\sum }_{n} {E}_{x}^{*} ( n , f ) X ( n - k , f ) + \\ {E}_{x} ( n , f ) {X}^{*} ( n - k , f ) ,\end{matrix} & ( 134 ) \\ \begin{matrix}\frac{\partial {E}_{x}}{\partial {H}_{I} ( k , f )} = {\sum }_{n} {E}_{x}^{*} ( n , f ) \frac{\partial {E}_{x} ( n , f )}{\partial {H}_{I} ( k , f )} + {E}_{x} ( n , f ) \frac{\partial {E}_{x}^{*} ( n , f )}{\partial {H}_{I} ( k , f )} \\ = j {\sum }_{n} {E}_{x}^{*} ( n , f ) X ( n - k , f ) - \\ {E}_{x} ( n , f ) {X}^{*} ( n - k , f ) ,\end{matrix} & ( 135 ) \\ \begin{matrix}\frac{\partial {E}_{s}}{\partial {H}_{R} ( k , f )} = {\sum }_{n} {E}_{s}^{*} ( n , f ) \frac{\partial {E}_{s} ( n , f )}{\partial {H}_{R} ( k , f )} + {E}_{s} ( n , f ) \frac{\partial {E}_{s}^{*} ( n , f )}{\partial {H}_{R} ( k , f )} \\ = - {\sum }_{n} {E}_{s}^{*} ( n , f ) S ( n - k , f ) + \\ {E}_{s} ( n , f ) {S}^{*} ( n - k , f ) ,\end{matrix} \\ and & ( 136 ) \\ \begin{matrix}\frac{\partial {E}_{s}}{\partial {H}_{I} ( k , f )} = {\sum }_{n} {E}_{s}^{*} ( n , f ) \frac{\partial {E}_{s} ( n , f )}{\partial {H}_{I} ( k , f )} + {E}_{s} ( n , f ) \frac{\partial {E}_{s}^{*} ( n , f )}{\partial {H}_{I} ( k , f )} \\ = j {\sum }_{n} {E}_{s}^{*} ( n , f ) S ( n - k , f ) - \\ {E}_{s} ( n , f ) {S}^{*} ( n - k , f )\end{matrix} & ( 137 )\end{matrix}$$

respectively, and inserted into Equation 133 to obtain

$$\begin{matrix}{∇}_{k} ( E ) = - 2 α {\sum }_{n} {E}_{n}^{*} ( n , f ) X ( n - k , f ) - 2 ( 1 - α ) {\sum }_{n} {E}_{s}^{*} ( n , f ) \\ S ( n - k , f ) \\ = - 2 α {\sum }_{n} X ( n - k , f ) \\ ( {X}^{*} ( n , f ) - {\sum }_{i = 0}^{K} H ( i , f ) {X}^{*} ( n - i , f ) ) - \\ 2 ( 1 - α ) {\sum }_{n} S ( n - k , f ) \\ ( {H}_{s} ( f ) {S}^{*} ( n , f ) - {\sum }_{i = 0}^{K} H ( i , f ) {S}^{*} ( n - i , f ) ) \\ = - 2 α ( {\sum }_{n} X ( n - k , f ) {X}^{*} ( n , f ) ) + \\ 2 α {\sum }_{i = 0}^{K} H ( i , f ) ( {\sum }_{n} X ( n - k , f ) {X}^{*} ( n - i , f ) ) - \\ 2 ( 1 - α ) {H}_{s} ( f ) ( {\sum }_{n} S ( n - k , f ) {S}^{*} ( n , f ) ) + \\ 2 ( 1 - α ) {\sum }_{i = 0}^{K} H ( i , f ) ( {\sum }_{n} S ( n - k , f ) {S}^{*} ( n - i , f ) ) \\ = - 2 α ( {\sum }_{n} X ( n - k , f ) {X}^{*} ( n , f ) ) + 2 α \\ ( {\sum }_{n} X ( n - k , f ) {\underline{X} ( n , f )}^{T} ) \underline{H} ( f ) - \\ 2 ( 1 - α ) {H}_{s} ( f ) ( {\sum }_{n} S ( n - k , f ) {S}^{*} ( n , f ) ) + \\ 2 ( 1 - α ) ( {\sum }_{n} S ( n - k , f ) {\underline{S} ( n , f )}^{T} ) \underline{H} ( f )\end{matrix} \qquad ( 138 )$$

This can be written in matrix formulations as

$$\begin{matrix}\underline{∇} ( E ) = - 2 α ( {\sum }_{n} \underline{X} ( n , f ) {X}^{*} ( n , f ) ) + 2 α \\ ( {\sum }_{n} \underline{X} ( n , f ) {\underline{X} ( n , f )}^{T} ) \underline{H} ( f ) - 2 ( 1 - α ) {H}_{s} ( f ) \\ ( {\sum }_{n} \underline{S} ( n , f ) {S}^{*} ( n , f ) ) + 2 ( 1 - α ) \\ ( {\sum }_{n} \underline{S} ( n , f ) {\underline{S} ( n , f )}^{T} ) \underline{H} ( f ) \\ = - 2 α {\underline{r}}_{x} ( f ) + 2 α {{R}_{\underline{\_}}}_{x} ( f ) \underline{H} ( f ) - 2 ( 1 - α ) {H}_{s} ( f ) {\underline{r}}_{s} ( f ) + \\ 2 ( 1 - α ) {{R}_{\underline{\_}}}_{s} ( f ) \underline{H} ( f ) \\ = 2 [ α {{R}_{\underline{\_}}}_{x} ( f ) + ( 1 - α ) {{R}_{\underline{\_}}}_{s} ( f ) ] \underline{H} ( f ) - \\ 2 [ α {\underline{r}}_{x} ( f ) + ( 1 - α ) {H}_{s} ( f ) {\underline{r}}_{s} ( f ) ]\end{matrix} \qquad ( 139 )$$

where

$$\begin{matrix}{\underline{r}}_{x} ( f ) = {\sum }_{n} \underline{X} ( n , f ) {X}^{*} ( n , f ) , & ( 140 ) \\ {{R}_{\underline{\_}}}_{x} ( f ) = {\sum }_{n} \underline{X} ( n , f ) {\underline{X} ( n , f )}^{T} , & ( 141 ) \\ {\underline{r}}_{s} ( f ) = {\sum }_{n} \underline{S} ( n , f ) {S}^{*} ( n , f ) , and & ( 142 ) \\ {{R}_{\underline{\_}}}_{s} ( f ) = {\sum }_{n} \underline{S} ( n , f ) {\underline{S} ( n , f )}^{T} . & ( 143 )\end{matrix}$$

The complex filter per frequency is found as

$$\begin{matrix}\underline{∇} ( E ) & = & 0 \\ & ⇓ & \\ \underline{H} ( f ) & = & {[ α {{R}_{\underline{\_}}}_{x} ( f ) + ( 1 - α ) {{R}_{\underline{\_}}}_{s} ( f ) ]}^{- 1} [ α {\underline{r}}_{x} ( f ) + ( 1 - α ) {H}_{s} ( f ) {\underline{r}}_{s} ( f ) ]\end{matrix} \qquad ( 144 )$$

by setting the gradient of Equation 139 to zero. With an assumption of independence between the desired audio signal and the noise signal, the solution can be re-written as a function of the input audio signal and the noise signal

H(f)=└αR_{y}(f)+(1−2α)Rₛ(f)┘⁻¹[α(r_{y}(f)−rₛ(f))+(1−α)Hₛ(f)rₛ(f)] (145)

where

$$\begin{matrix}{\underline{r}}_{y} ( f ) = {\sum }_{n} \underline{Y} ( n , f ) {Y}^{*} ( n , f ) , and & ( 146 ) \\ {{R}_{\underline{\_}}}_{y} ( f ) = {\sum }_{n} \underline{Y} ( n , f ) {\underline{Y} ( n , f )}^{T} . & ( 147 )\end{matrix}$$

Clearly, the solution of Equation 145 bears great resemblance to previous solutions.

It is important to note that the time averaging of Equations 140-143, 146 and 147 must include more than K/2 points (if the signals are complex) to prevent the matrix (for inversion) from becoming singular. If the signals are real then more than K points are required. This can be seen by example from inspection of inversion of a simple 3×3 real correlation matrix (which would correspond to K=2 in the above).

2. Example Hybrid Single-Channel Noise Suppressor

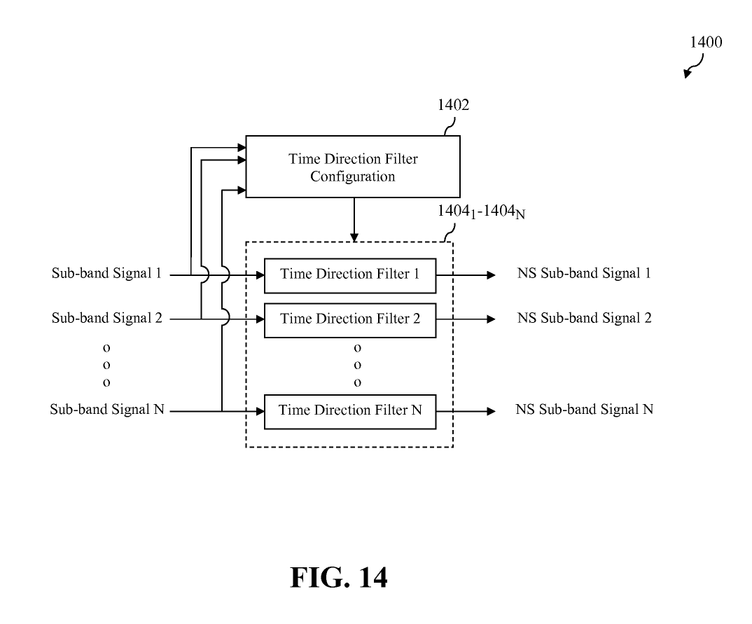

FIG. 14 is a block diagram of an example single-channel noise suppressor 1400 that utilizes a hybrid approach in accordance with an embodiment of the present invention. Generally speaking, noise suppressor 1400 operates to receive a plurality of sub-band signals obtained by applying a frequency conversion process to a time domain representation of an input audio signal and to apply noise suppression to each of the sub-band signals by passing each of the sub-band signals through a corresponding time direction filter. As shown in FIG. 14, noise suppressor 1400 includes a time direction filter configuration module 1402 and a plurality of time direction filters 1404₁-1404_{N} each of which corresponds to a different frequency sub-band 1-N.

The plurality of sub-band signals received by noise suppressor 1400 may be received from an entity that operates upon a frequency domain representation of the input audio signal. For example and without limitation, the plurality of sub-band signals may be received from a sub-band acoustic echo cancellation (SBAEC) module that processes a frequency domain representation of the input audio signal (i.e., that processes the input audio signal as a plurality of sub-band signals). However, this is only one example.

Time direction filter configuration module 1402 operates to update the configuration of each of the plurality of time direction filters 1404₁-1404_{N}. This updating may occur on a periodic or non-periodic basis dependent upon a control scheme. For a given time direction filter associated with a particular sub-band, time direction filter configuration module 1402 configures the filter based on statistics associated with the sub-band signal, a parameter that specifies a degree of balance between distortion of a desired audio signal included in the sub-band signal and an unnaturalness of a residual noise signal included in a noise-suppressed version of the sub-band signal, and a noise attenuation factor or shaping filter. By way of example, time direction filter configuration module 1402 may update the configuration of each of the plurality of time direction filters 1404₁-1404_{N} in accordance with Equation 165, wherein the parameter α comprises the parameter that specifies the degree of balance between distortion of the desired audio signal included in a given sub-band signal and the unnaturalness of the residual noise signal included in the noise-suppressed version of the given sub-band signal, and wherein Hₛ(f) specifies the noise attenuation factor or shaping for the given sub-band. However, this is only one example and other time direction filter formulations may be used.

Each time direction filter 1404₁-1404_{N} operates to receive a corresponding one of the plurality of sub-band signals and to filter it in the time direction in accordance with its current configuration (as determined by time direction filter configuration module 1402) to produce a corresponding noise suppressed (NS) sub-band signal. Depending upon the implementation, the noise-suppressed sub-band signals output by time direction filters 1404₁-1404_{N} may be further processed or may be passed to a time domain conversion module that processes the signals to produce a time domain representation of a noise-suppressed version of the input audio signal.

3. Example Methods for Performing Hybrid Single-Channel Noise Suppression

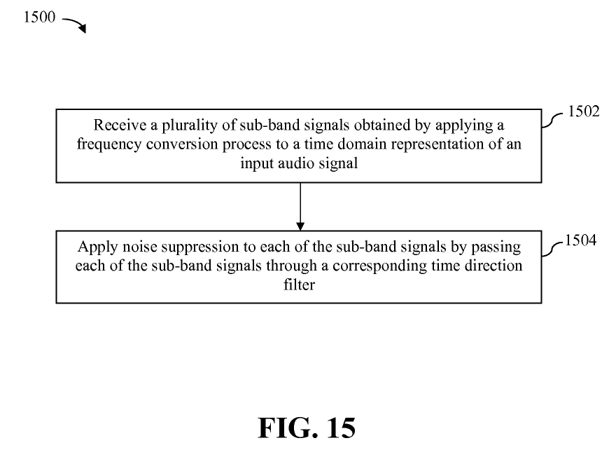

FIG. 15 depicts a flowchart 1500 of an example method for performing hybrid single-channel noise suppression in accordance with an embodiment of the present invention. The method of flowchart 1500 may be performed, for example and without limitation, by noise suppressor 1400 as described above in reference to FIG. 14. However, the method is not limited to that implementation.

As shown in FIG. 15, the method of flowchart 1500 begins at step 1502 in which a plurality of sub-band signals obtained by applying a frequency conversion process to a time domain representation of an input audio signal is received. In certain implementations, this step involves receiving the plurality of sub-band signals from a sub-band acoustic echo cancellation module or some other module that processes a frequency domain representation of the input audio signal.

At step 1504, noise suppression is applied to each of the sub-band signals by passing each of the sub-band signals through a corresponding time direction filter.

In an example embodiment in which each sub-band signal comprises a desired audio signal and a noise signal, step 1504 comprises passing each of the sub-band signals through a corresponding time direction filter having a response that is controlled by at least a parameter that specifies a degree of balance between distortion of the desired audio signal included in the sub-band signal and unnaturalness of a residual noise signal included in a noise-suppressed version of the sub-band signal. An example representation of such a time direction filter was provided above in Equation 165, wherein the parameter that specifies the degree of balance between the distortion of the desired audio signal included in the sub-band signal and the unnaturalness of the residual noise signal included in the noise-suppressed version of the sub-band signal is denoted α. However this is only one example, and other time direction filters may be used to implement step 1504.

In further accordance with an embodiment in which each sub-band signal comprises a desired audio signal and a noise signal, the method of flowchart 1500 may further include determining the parameter that specifies the degree of balance between the distortion of the desired audio signal included in the sub-band signal and the unnaturalness of the residual noise signal included in the noise-suppressed version of the sub-band signal for each sub-band based at least in part on characteristics of the input audio signal.

In still further accordance with an embodiment in which each sub-band signal comprises a desired audio signal and a noise signal, step 1504 may include passing each of the sub-band signals through a corresponding time direction filter having a response that is controlled by at least a parameter that specifies the degree of balance between the distortion of the desired audio signal included in the sub-band signal and the unnaturalness of the residual noise signal included in the noise-suppressed version of the sub-band signal and a noise attenuation factor or noise shaping filter. By way of example, the noise attenuation factor or noise shaping filter for a given sub-band may be specified by the parameter Hₛ(f) included in Equation 165, although this is only an example. In an embodiment in which a noise attenuation factor is specified for a given sub-band, the degree of balance between the distortion of the desired audio signal included in the sub-band signal and the unnaturalness of the residual noise signal included in the noise-suppressed version of the sub-band signal may be determined based on the noise attenuation factor for that sub-band.

### G. Dual-Channel Hybrid Noise Suppression in Accordance with Embodiments of the Present Invention

The hybrid formulation for a single channel described above can be extended to multi-channel configurations. This section will focus on the dual channel configuration of the hybrid formulation. In the following, an example derivation of a hybrid approach for dual-channel noise suppression is first described. An exemplary implementation of a noise suppressor that utilizes such a hybrid approach for performing dual-channel noise suppression will then be described. Finally, exemplary methods for performing dual-channel noise suppression using the hybrid approach will be described.

1. Example Derivation of Hybrid Approach for Dual-Channel Noise Suppression

The dual channel hybrid noise suppression is achieved by a filtering of the sub-band signals in the time direction:

$${\hat{X}}_{1} ( f ) = {\sum }_{{k}_{1} = 0}^{{K}_{1}} {H}_{1}^{*} ( {k}_{1} , f ) {Y}_{1} ( n - {k}_{1} , f ) + {\sum }_{{k}_{2} = 0}^{{K}_{2}} {H}_{2}^{*} ( {k}_{2} , f ) {Y}_{2} ( n - {k}_{2} , f ) \qquad ( 148 )$$

and the task is to estimate the two filters, H₁(k,f) and H₂(k,f), which can be complex given complex sub-band signals, Y₁(n,f) and Y₂(n,f). Equivalent to past dual channel sections the target of the noise suppression is the desired audio signal at one microphone plus an attenuated (and possibly spectrally shaped) version of the original noise at the same microphone. Hence, the error of the noise suppression is defined as

$$\begin{matrix}E ( n , f ) = [ {X}_{1} ( n , f ) + {H}_{s} ( f ) {S}_{1} ( n , f ) ] - {\hat{X}}_{1} ( n , f ) \\ = [ {X}_{1} ( n , f ) + {H}_{s} ( f ) {S}_{1} ( n , f ) ] - \\ {\sum }_{{k}_{1} = 0}^{{K}_{1}} {H}_{1}^{*} ( {k}_{1} , f ) {Y}_{1} ( n - {k}_{1} , f ) - \\ {\sum }_{{k}_{2} = 0}^{{K}_{2}} {H}_{2}^{*} ( {k}_{2} , f ) {Y}_{2} ( n - {k}_{2} , f ) \\ = [ {X}_{1} ( n , f ) + {H}_{s} ( f ) {S}_{1} ( n , f ) ] - \\ {\sum }_{{k}_{1} = 0}^{{K}_{1}} {H}_{1}^{*} ( {k}_{1} , f ) [ \begin{matrix}{X}_{1} ( n - {k}_{1} , f ) + \\ {S}_{1} ( n - {k}_{1} , f )\end{matrix} ] - \\ {\sum }_{{k}_{2} = 0}^{{K}_{2}} {H}_{2}^{*} ( {k}_{2} , f ) [ {X}_{2} ( n - {k}_{2} , f ) + {S}_{2} ( n - {k}_{2} , f ) ] \\ = {X}_{1} ( n , f ) - {\sum }_{{k}_{1} = 0}^{{K}_{1}} {H}_{1}^{*} ( {k}_{1} , f ) {X}_{1} ( n - {k}_{1} , f ) - \\ {\sum }_{{k}_{2} = 0}^{{K}_{2}} {H}_{2}^{*} ( {k}_{2} , f ) {X}_{2} ( n - {k}_{2} , f ) + \\ {H}_{s} ( f ) {S}_{1} ( n , f ) - {\sum }_{{k}_{1} = 0}^{{K}_{1}} {H}_{1}^{*} ( {k}_{1} , f ) {S}_{1} ( n - {k}_{1} , f ) - \\ {\sum }_{{k}_{2} = 0}^{{K}_{2}} {H}_{2}^{*} ( {k}_{2} , f ) {S}_{2} ( n - {k}_{2} , f )\end{matrix} \qquad ( 149 )$$

In a like manner to preceding sections, this is broken into the distortion of the desired audio signal at the first microphone:

$${E}_{{X}_{1}} ( n , f ) = {X}_{1} ( n , f ) - {\sum }_{{k}_{1} = 0}^{{K}_{1}} {H}_{1}^{*} ( {k}_{1} , f ) {X}_{1} ( n - {k}_{1} , f ) - {\sum }_{{k}_{2} = 0}^{{K}_{2}} {H}_{2}^{*} ( {k}_{2} , f ) {X}_{2} ( n - {k}_{2} , f ) \qquad ( 150 )$$

and the unnaturalness of the residual noise signal

$${E}_{{S}_{1}} ( n , f ) = {H}_{s} ( f ) {S}_{1} ( n , f ) - {\sum }_{{k}_{1} = 0}^{{K}_{1}} {H}_{1}^{*} ( {k}_{1} , f ) {S}_{1} ( n - {k}_{1} , f ) - {\sum }_{{k}_{2} = 0}^{{K}_{2}} {H}_{2}^{*} ( {k}_{2} , f ) {S}_{2} ( n - {k}_{2} , f ) . \qquad ( 151 )$$

The associated cost functions for distortion of the desired audio signal at the first microphone and unnaturalness of the residual noise signal are

$$\begin{matrix}\begin{matrix}{E}_{X} = {\sum }_{n} {\sum }_{f} {E}_{{X}_{1}} ( n , f ) {E}_{{X}_{1}}^{*} ( n , f ) \\ = {\sum }_{n} {\sum }_{f} ( \begin{matrix}{X}_{1} ( n , f ) - \\ {\sum }_{{k}_{1} = 0}^{{K}_{1}} {H}_{1}^{*} ( {k}_{1} , f ) {X}_{1} ( n - {k}_{1} , f ) - \\ {\sum }_{{k}_{2} = 0}^{{K}_{2}} {H}_{2}^{*} ( {k}_{2} , f ) {X}_{2} ( n - {k}_{2} , f )\end{matrix} ) \cdot \\ ( \begin{matrix}{X}_{1}^{*} ( n , f ) - \\ {\sum }_{{k}_{1} = 0}^{{K}_{1}} {H}_{1} ( {k}_{1} , f ) {X}_{1}^{*} ( n - {k}_{1} , f ) - \\ {\sum }_{{k}_{2} = 0}^{{K}_{2}} {H}_{2} ( {k}_{2} , f ) {X}_{2}^{*} ( n - {k}_{2} , f )\end{matrix} )\end{matrix} \\ and & ( 152 ) \\ \begin{matrix}{E}_{S} = {\sum }_{n} {\sum }_{f} {E}_{{S}_{1}} ( n , f ) {E}_{{S}_{1}}^{*} ( n , f ) \\ = {\sum }_{n} {\sum }_{f} ( \begin{matrix}{H}_{s} ( f ) {S}_{1} ( n , f ) - \\ {\sum }_{{k}_{1} = 0}^{{K}_{1}} {H}_{1}^{*} ( {k}_{1} , f ) {S}_{1} ( n - {k}_{1} , f ) - \\ {\sum }_{{k}_{2} = 0}^{{K}_{2}} {H}_{2}^{*} ( {k}_{2} , f ) {S}_{2} ( n - {k}_{2} , f )\end{matrix} ) \cdot \\ ( \begin{matrix}{H}_{s} ( f ) {S}_{1}^{*} ( n , f ) - \\ {\sum }_{{k}_{1} = 0}^{{K}_{1}} {H}_{1} ( {k}_{1} , f ) {S}_{1}^{*} ( n - {k}_{1} , f ) - \\ {\sum }_{{k}_{2} = 0}^{{K}_{2}} {H}_{2} ( {k}_{2} , f ) {S}_{2}^{*} ( n - {k}_{2} , f )\end{matrix} )\end{matrix} & ( 153 )\end{matrix}$$

respectively. The cost function is constructed as

E=αEₓ_{₁}+(1−α)Eₛ_{₁}. (154)

Compared to single-channel hybrid solution of Section F.1, the dual-channel version requires deriving the gradient with respect to both H₁(k,f) and H₂(k,f):

$$\begin{matrix}\begin{matrix}{∇}_{{H}_{1} ( {k}_{1} , f )} ( E ) = \frac{\partial E}{\partial {H}_{1 , R} ( {k}_{1} , f )} + j \frac{\partial E}{\partial {H}_{1 , I} ( {k}_{1} , f )} \\ = α \frac{\partial {E}_{X}}{\partial {H}_{1 , R} ( {k}_{1} , f )} + αj \frac{\partial {E}_{X}}{\partial {H}_{1 , I} ( {k}_{1} , f )} + \\ ( 1 - α ) \frac{\partial {E}_{S}}{\partial {H}_{1 , R} ( {k}_{1} , f )} + ( 1 - α ) j \frac{\partial {E}_{S}}{\partial {H}_{1 , I} ( {k}_{1} , f )}\end{matrix} , \\ {k}_{1} = 0 , 1 , … {K}_{1} \\ and & ( 155 ) \\ \begin{matrix}{∇}_{{H}_{2} ( {k}_{2} , f )} ( E ) = \frac{\partial E}{\partial {H}_{2 , R} ( {k}_{2} , f )} + j \frac{\partial E}{\partial {H}_{2 , I} ( {k}_{2} , f )} \\ = α \frac{\partial {E}_{X}}{\partial {H}_{2 , R} ( {k}_{2} , f )} + αj \frac{\partial {E}_{X}}{\partial {H}_{2 , I} ( {k}_{2} , f )} + \\ ( 1 - α ) \frac{\partial {E}_{S}}{\partial {H}_{2 , R} ( {k}_{2} , f )} + ( 1 - α ) j \frac{\partial {E}_{S}}{\partial {H}_{2 , I} ( {k}_{2} , f )}\end{matrix} , \\ {k}_{2} = 0 , 1 , … {K}_{2} & ( 156 )\end{matrix}$$

The individual terms in Equations 155 and 156 are calculated from Equations 152 and 153:

$$\begin{matrix}\begin{matrix}\frac{\partial {E}_{X}}{\partial {H}_{1 , R} ( {k}_{1} , f )} = {\sum }_{n} {E}_{{X}_{1}}^{*} ( n , f ) \frac{\partial {E}_{{X}_{1}} ( n , f )}{\partial {H}_{1 , R} ( {k}_{1} , f )} + \\ {E}_{{X}_{1}} ( n , f ) \frac{\partial {E}_{{X}_{1}}^{*} ( n , f )}{\partial {H}_{1 , R} ( {k}_{1} , f )} \\ = - {\sum }_{n} {E}_{{X}_{1}}^{*} ( n , f ) {X}_{1} ( n - {k}_{1} , f ) + \\ {E}_{{X}_{1}} ( n , f ) {X}_{1}^{*} ( n - {k}_{1} , f ) ,\end{matrix} & ( 157 ) \\ \begin{matrix}\frac{\partial {E}_{X}}{\partial {H}_{1 , I} ( {k}_{1} , f )} = {\sum }_{n} {E}_{{X}_{1}}^{*} ( n , f ) \frac{\partial {E}_{{X}_{1}} ( n , f )}{\partial {H}_{1 , I} ( {k}_{1} , f )} + \\ {E}_{{X}_{1}} ( n , f ) \frac{\partial {E}_{{X}_{1}}^{*} ( n , f )}{\partial {H}_{1 , I} ( {k}_{1} , f )} \\ = j {\sum }_{n} {E}_{{X}_{1}}^{*} ( n , f ) {X}_{1} ( n - {k}_{1} , f ) - \\ {E}_{{X}_{1}} ( n , f ) {X}_{1}^{*} ( n - {k}_{1} , f ) ,\end{matrix} & ( 158 ) \\ \begin{matrix}\frac{\partial {E}_{S}}{\partial {H}_{1 , R} ( {k}_{1} , f )} = {\sum }_{n} {E}_{{S}_{1}}^{*} ( n , f ) \frac{\partial {E}_{{S}_{1}} ( n , f )}{\partial {H}_{1 , R} ( {k}_{1} , f )} + \\ {E}_{{S}_{1}} ( n , f ) \frac{\partial {E}_{{S}_{1}}^{*} ( n , f )}{\partial {H}_{1 , R} ( {k}_{1} , f )} \\ = - {\sum }_{n} {E}_{{S}_{1}}^{*} ( n , f ) {S}_{1} ( n - {k}_{1} , f ) + \\ {E}_{{S}_{1}} ( n , f ) {S}_{1}^{*} ( n - {k}_{1} , f ) ,\end{matrix} & ( 159 ) \\ \begin{matrix}\frac{\partial {E}_{S}}{\partial {H}_{1 , I} ( {k}_{1} , f )} = {\sum }_{n} {E}_{{S}_{1}}^{*} ( n , f ) \frac{\partial {E}_{{S}_{1}} ( n , f )}{\partial {H}_{1 , I} ( {k}_{1} , f )} + \\ {E}_{{S}_{1}} ( n , f ) \frac{\partial {E}_{{S}_{1}}^{*} ( n , f )}{\partial {H}_{1 , I} ( {k}_{1} , f )} \\ = j {\sum }_{n} {E}_{{S}_{1}}^{*} ( n , f ) {S}_{1} ( n - {k}_{1} , f ) - \\ {E}_{{S}_{1}} ( n , f ) {S}_{1}^{*} ( n - {k}_{1} , f ) ,\end{matrix} & ( 160 ) \\ \begin{matrix}\frac{\partial {E}_{X}}{\partial {H}_{2 , R} ( {k}_{2} , f )} = {\sum }_{n} {E}_{{X}_{1}}^{*} ( n , f ) \frac{\partial {E}_{{X}_{1}} ( n , f )}{\partial {H}_{2 , R} ( {k}_{2} , f )} + \\ {E}_{{X}_{1}} ( n , f ) \frac{\partial {E}_{{X}_{1}}^{*} ( n , f )}{\partial {H}_{2 , R} ( {k}_{2} , f )} \\ = - {\sum }_{n} {E}_{{X}_{1}}^{*} ( n , f ) {X}_{2} ( n - {k}_{2} , f ) + \\ {E}_{{X}_{1}} ( n , f ) {X}_{2}^{*} ( n - {k}_{2} , f ) ,\end{matrix} & ( 161 ) \\ \begin{matrix}\frac{\partial {E}_{X}}{\partial {H}_{2 , I} ( {k}_{2} , f )} = {\sum }_{n} {E}_{{X}_{1}}^{*} ( n , f ) \frac{\partial {E}_{{X}_{1}} ( n , f )}{\partial {H}_{2 , I} ( {k}_{2} , f )} + \\ {E}_{{X}_{1}} ( n , f ) \frac{\partial {E}_{{X}_{1}}^{*} ( n , f )}{\partial {H}_{2 , I} ( {k}_{2} , f )} \\ = j {\sum }_{n} {E}_{{X}_{1}}^{*} ( n , f ) {X}_{2} ( n - {k}_{2} , f ) - \\ {E}_{{X}_{1}} ( n , f ) {X}_{2}^{*} ( n - {k}_{2} , f ) ,\end{matrix} & ( 162 ) \\ \begin{matrix}\frac{\partial {E}_{S}}{\partial {H}_{2 , R} ( {k}_{2} , f )} = {\sum }_{n} {E}_{{S}_{1}}^{*} ( n , f ) \frac{\partial {E}_{{S}_{1}} ( n , f )}{\partial {H}_{2 , R} ( {k}_{2} , f )} + \\ {E}_{{S}_{1}} ( n , f ) \frac{\partial {E}_{{S}_{1}}^{*} ( n , f )}{\partial {H}_{2 , R} ( {k}_{2} , f )} \\ = - {\sum }_{n} {E}_{{S}_{1}}^{*} ( n , f ) {S}_{2} ( n - {k}_{2} , f ) + \\ {E}_{{S}_{1}} ( n , f ) {S}_{2}^{*} ( n - {k}_{2} , f ) , and\end{matrix} & ( 163 ) \\ \begin{matrix}\frac{\partial {E}_{S}}{\partial {H}_{2 , I} ( {k}_{2} , f )} = {\sum }_{n} {E}_{{S}_{1}}^{*} ( n , f ) \frac{\partial {E}_{{S}_{1}} ( n , f )}{\partial {H}_{2 , I} ( {k}_{2} , f )} + \\ {E}_{{S}_{1}} ( n , f ) \frac{\partial {E}_{{S}_{1}}^{*} ( n , f )}{\partial {H}_{2 , I} ( {k}_{2} , f )} \\ = j {\sum }_{n} {E}_{{S}_{1}}^{*} ( n , f ) {S}_{2} ( n - {k}_{2} , f ) - \\ {E}_{{S}_{1}} ( n , f ) {S}_{2}^{*} ( n - {k}_{2} , f ) .\end{matrix} & ( 164 )\end{matrix}$$

Inserting Equations 157 through 160 into Equation 155 yields

$$\begin{matrix}{∇}_{{H}_{1} ( {k}_{1} , f )} ( E ) = - 2 α {\sum }_{n} {E}_{{x}_{1}}^{*} ( n , f ) {X}_{1} ( n - {k}_{1} , f ) - \\ 2 ( 1 - α ) {\sum }_{n} {E}_{{s}_{1}}^{*} ( n , f ) {S}_{1} ( n - {k}_{1} , f ) \\ = - 2 α {\sum }_{n} {X}_{1} ( n - {k}_{1} , f ) ( \begin{matrix}{X}_{1}^{*} ( n , f ) - \\ {\sum }_{{i}_{1} = 0}^{{K}_{1}} {H}_{1} ( {i}_{1} , f ) {X}_{1}^{*} ( n - {i}_{1} , f ) - \\ {\sum }_{{i}_{2} = 0}^{{K}_{2}} {H}_{2} ( {i}_{2} , f ) {X}_{2}^{*} ( n - {i}_{2} , f )\end{matrix} ) - \\ 2 ( 1 - α ) {\sum }_{n} {S}_{1} ( n - k , f ) ( \begin{matrix}{H}_{s} ( f ) {S}_{1}^{*} ( n , f ) - \\ {\sum }_{{i}_{1} = 0}^{{K}_{1}} {H}_{1} ( {i}_{1} , f ) {S}_{1}^{*} ( n - {i}_{1} , f ) - \\ {\sum }_{{i}_{2} = 0}^{{K}_{2}} {H}_{2} ( {i}_{2} , f ) {S}_{2}^{*} ( n - {i}_{2} , f )\end{matrix} ) \\ = - 2 α ( {\sum }_{n} {X}_{1} ( n - {k}_{1} , f ) {X}_{1}^{*} ( n , f ) ) + \\ 2 α ( {\sum }_{n} {X}_{1} ( n - {k}_{1} , f ) {{\underline{X}}_{1} ( n , f )}^{T} ) {\underline{H}}_{1} ( f ) + \\ 2 α ( {\sum }_{n} {X}_{1} ( n - {k}_{1} , f ) {{\underline{X}}_{2} ( n , f )}^{T} ) {\underline{H}}_{2} ( f ) - \\ 2 ( 1 - α ) {H}_{s} ( f ) ( {\sum }_{n} {S}_{1} ( n - {k}_{1} , f ) {S}_{1}^{*} ( n , f ) ) + \\ 2 ( 1 - α ) ( {\sum }_{n} {S}_{1} ( n - {k}_{1} , f ) {{\underline{S}}_{1} ( n , f )}^{T} ) {\underline{H}}_{1} ( f ) + \\ 2 ( 1 - α ) ( {\sum }_{n} {S}_{1} ( n - {k}_{1} , f ) {{\underline{S}}_{2} ( n , f )}^{T} ) {\underline{H}}_{2} ( f )\end{matrix} \qquad ( 165 )$$

In more compact matrix form this is written as

$$\begin{matrix}{\underline{∇}}_{{\underline{H}}_{1} ( f )} ( E ) = - 2 α {\underline{r}}_{{x}_{1}} ( f ) + 2 α {{R}_{\underline{\_}}}_{{x}_{1}} ( f ) {\underline{H}}_{1} ( f ) + 2 α {{R}_{\underline{\_}}}_{{x}_{1} {x}_{2}} ( f ) {\underline{H}}_{2} ( f ) - \\ 2 ( 1 - α ) {H}_{s} ( f ) {\underline{r}}_{{s}_{1}} ( f ) + 2 ( 1 - α ) {{R}_{\underline{\_}}}_{{s}_{1}} ( f ) {\underline{H}}_{1} ( f ) + \\ 2 ( 1 - α ) {{R}_{\underline{\_}}}_{{s}_{1} {s}_{2}} ( f ) {\underline{H}}_{2} ( f ) \\ = 2 [ α {{R}_{\underline{\_}}}_{{x}_{1}} ( f ) + ( 1 - α ) {{R}_{\underline{\_}}}_{{s}_{1}} ( f ) ] {\underline{H}}_{1} ( f ) + \\ 2 [ α {{R}_{\underline{\_}}}_{{x}_{1} {x}_{2}} ( f ) + ( 1 - α ) {{R}_{\underline{\_}}}_{{s}_{1} {s}_{2}} ( f ) ] {\underline{H}}_{2} ( f ) - \\ 2 [ α {\underline{r}}_{{x}_{1}} ( f ) + ( 1 - α ) {H}_{s} ( f ) {\underline{r}}_{{s}_{1}} ( f ) ]\end{matrix} \qquad ( 166 )$$

where in addition to the definitions in Equations 140 through 143

$$\begin{matrix}{{R}_{\underline{\_}}}_{{x}_{1} {x}_{2}} ( f ) = {\sum }_{n} {\underline{X}}_{1} ( n , f ) {{\underline{X}}_{2} ( n , f )}^{T} , and & ( 167 ) \\ {{R}_{\underline{\_}}}_{{s}_{1} {s}_{2}} ( f ) = {\sum }_{n} {\underline{S}}_{1} ( n , f ) {{\underline{S}}_{2} ( n , f )}^{T} . & ( 168 )\end{matrix}$$

Inserting Equations 161 through 164 into Equation 156 yields

$$\begin{matrix}{∇}_{{H}_{2} ( {k}_{2} , f )} ( E ) = - 2 α {\sum }_{n} {E}_{{x}_{1}}^{*} ( n , f ) {X}_{2} ( n - {k}_{1} , f ) - \\ 2 ( 1 - α ) {\sum }_{n} {E}_{{s}_{1}}^{*} ( n , f ) {S}_{2} ( n - {k}_{1} , f ) \\ = - 2 α {\sum }_{n} {X}_{2} ( n - {k}_{1} , f ) ( \begin{matrix}{X}_{1}^{*} ( n , f ) - \\ {\sum }_{{i}_{1} = 0}^{{K}_{1}} {H}_{1} ( {i}_{1} , f ) {X}_{1}^{*} ( n - {i}_{1} , f ) - \\ {\sum }_{{i}_{2} = 0}^{{K}_{2}} {H}_{2} ( {i}_{2} , f ) {X}_{2}^{*} ( n - {i}_{2} , f )\end{matrix} ) - \\ 2 ( 1 - α ) {\sum }_{n} {S}_{2} ( n - k , f ) ( \begin{matrix}{H}_{s} ( f ) {S}_{1}^{*} ( n , f ) - \\ {\sum }_{{i}_{1} = 0}^{{K}_{i}} {H}_{1} ( {i}_{1} , f ) {S}_{1}^{*} ( n - {i}_{1} , f ) - \\ {\sum }_{{i}_{2} = 0}^{{K}_{2}} {H}_{2} ( {i}_{2} , f ) {S}_{2}^{*} ( n - {i}_{2} , f )\end{matrix} ) \\ = - 2 α ( {\sum }_{n} {X}_{2} ( n - {k}_{2} , f ) {X}_{1}^{*} ( n , f ) ) + \\ 2 α ( {\sum }_{n} {X}_{2} ( n - {k}_{2} , f ) {{\underline{X}}_{1} ( n , f )}^{T} ) {\underline{H}}_{1} ( f ) + \\ 2 α ( {\sum }_{n} {X}_{2} ( n - {k}_{2} , f ) {{\underline{X}}_{2} ( n , f )}^{T} ) {\underline{H}}_{2} ( f ) - \\ 2 ( 1 - α ) {H}_{s} ( f ) ( {\sum }_{n} {S}_{2} ( n - {k}_{2} , f ) {S}_{1}^{*} ( n , f ) ) + \\ 2 ( 1 - α ) ( {\sum }_{n} {S}_{2} ( n - {k}_{2} , f ) {{\underline{S}}_{1} ( n , f )}^{T} ) {\underline{H}}_{1} ( f ) + \\ 2 ( 1 - α ) ( {\sum }_{n} {S}_{2} ( n - {k}_{2} , f ) {{\underline{S}}_{2} ( n , f )}^{T} ) {\underline{H}}_{2} ( f )\end{matrix} \qquad ( 169 )$$

In matrix form, this is written as

$$\begin{matrix}{\underline{∇}}_{{\underline{H}}_{2} ( f )} ( E ) = - 2 α {\underline{r}}_{{x}_{2} {x}_{1}} ( f ) + 2 α {{R}_{\underline{\_}}}_{{x}_{2} {x}_{1}} ( f ) {\underline{H}}_{1} ( f ) + \\ 2 α {{R}_{\underline{\_}}}_{{x}_{2}} ( f ) {{H}_{\underline{\_}}}_{2} ( f ) - \\ 2 ( 1 - α ) {H}_{s} ( f ) {\underline{r}}_{{s}_{2} {s}_{1}} ( f ) + 2 ( 1 - α ) {{R}_{\underline{\_}}}_{{s}_{2} {s}_{1}} ( f ) {\underline{H}}_{1} ( f ) + \\ 2 ( 1 - α ) {{R}_{\underline{\_}}}_{{s}_{2}} ( f ) {\underline{H}}_{2} ( f ) \\ = 2 [ α {{R}_{\underline{\_}}}_{{x}_{2} {x}_{1}} ( f ) + ( 1 - α ) {{R}_{\underline{\_}}}_{{s}_{2} {s}_{1}} ( f ) ] {\underline{H}}_{1} ( f ) + \\ 2 [ α {{R}_{\underline{\_}}}_{{s}_{2}} ( f ) + ( 1 - α ) {{R}_{\underline{\_}}}_{{s}_{2}} ( f ) ] {\underline{H}}_{2} ( f ) - \\ 2 [ α {\underline{r}}_{{x}_{2} {x}_{1}} ( f ) + ( 1 - α ) {H}_{s} ( f ) {\underline{r}}_{{s}_{2} {s}_{1}} ( f ) ]\end{matrix} \qquad ( 170 )$$

wherein

$$\begin{matrix}{\underline{r}}_{{x}_{2} {x}_{1}} ( f ) = {\sum }_{n} {\underline{X}}_{2} ( n , f ) {X}_{1}^{*} ( n , f ) , & ( 171 ) \\ {{R}_{\underline{\_}}}_{{x}_{2} {x}_{1}} ( f ) = {\sum }_{n} {\underline{X}}_{2} ( n , f ) {{\underline{X}}_{1} ( n , f )}^{T} , & ( 172 ) \\ {\underline{r}}_{{s}_{2} {s}_{1}} ( f ) = {\sum }_{n} {\underline{S}}_{2} ( n , f ) {S}_{1}^{*} ( n , f ) , and & ( 173 ) \\ {{R}_{\underline{\_}}}_{{s}_{2} {s}_{1}} ( f ) = {\sum }_{n} {\underline{S}}_{2} ( n , f ) {{\underline{S}}_{1} ( n , f )}^{T} . & ( 174 )\end{matrix}$$

It is once again noted that * represents the complex conjugate and that ^{T} represents the complex conjugate transpose. It is easily seen that

Rₓ_{₂}ₓ_{₁}(f)=Rₓ_{₁}ₓ_{₂}(f)^{T}, and (175)

Rₛ_{₂}ₛ_{₁}(f)=Rₛ_{₁}ₛ_{₂}(f)^{T}. (176)

Combining Equations 166 and 170 into a single matrix equation and exploiting Equations 175 and 176 results in

∇(E)=2R(f)H(f)−2r(f), (177)

where

$$\begin{matrix} ( 178 ) \\ \underline{∇} ( E ) = [ \begin{matrix}{\underline{∇}}_{{\underline{H}}_{1} ( f )} ( E ) \\ {\underline{∇}}_{{\underline{H}}_{2} ( f )} ( E )\end{matrix} ] , \\ ( 179 ) \\ \underline{H} ( f ) = [ \begin{matrix}{\underline{H}}_{1} ( f ) \\ {\underline{H}}_{2} ( f )\end{matrix} ] ' \\ ( 180 ) \\ {R}_{\underline{\_}} ( f ) = [ \begin{matrix}α {{R}_{\underline{\_}}}_{{x}_{1}} ( f ) + ( 1 - α ) {{R}_{\underline{\_}}}_{{s}_{1}} ( f ) & α {{R}_{\underline{\_}}}_{{x}_{1} {x}_{2}} ( f ) + ( 1 - α ) {{R}_{\underline{\_}}}_{{s}_{1} {s}_{2}} ( f ) \\ α {{{R}_{\underline{\_}}}_{{x}_{1} {x}_{2}} ( f )}^{T} + ( 1 - α ) {{{R}_{\underline{\_}}}_{{s}_{1} {s}_{2}} ( f )}^{T} & α {{R}_{\underline{\_}}}_{{x}_{2}} ( f ) + ( 1 - α ) {{R}_{\underline{\_}}}_{{s}_{2}} ( f )\end{matrix} ] , \\ and \\ ( 181 ) \\ \underline{r} ( f ) = [ \begin{matrix}α {\underline{r}}_{{x}_{1}} ( f ) + ( 1 - α ) {H}_{s} ( f ) {\underline{r}}_{{s}_{1}} ( f ) \\ α {\underline{r}}_{{x}_{2} {x}_{1}} ( f ) + ( 1 - α ) {H}_{s} ( f ) {\underline{r}}_{{s}_{2} {s}_{1}} ( f )\end{matrix} ] .\end{matrix}$$

The solution for the filters H₁(k,f) and H₂(k,f) is found as the point where the gradient is zero:

$$\begin{matrix}\underline{∇} ( E ) = 0 \\ ⇓ \\ \underline{H} ( f ) = {{R}_{\underline{\_}} ( f )}^{- 1} \underline{r} ( f )\end{matrix} \qquad ( 182 )$$

In practice with the assumption of the desired audio signal at the first microphone and the residual noise being independent and additive, Equations 180 and 181 are calculated as

$$\begin{matrix} ( 183 ) \\ {R}_{\underline{\_}} ( f ) = [ \begin{matrix}α {{R}_{\underline{\_}}}_{{x}_{1}} ( f ) + ( 1 - 2 α ) {{R}_{\underline{\_}}}_{{s}_{1}} ( f ) & α {{R}_{\underline{\_}}}_{{y}_{1} {y}_{2}} ( f ) + ( 1 - 2 α ) {{R}_{\underline{\_}}}_{{s}_{1} {s}_{2}} ( f ) \\ α {{{R}_{\underline{\_}}}_{{y}_{1} {y}_{2}} ( f )}^{T} + ( 1 - 2 α ) {{{R}_{\underline{\_}}}_{{s}_{1} {s}_{2}} ( f )}^{T} & α {{R}_{\underline{\_}}}_{{y}_{2}} ( f ) + ( 1 - 2 α ) {{R}_{\underline{\_}}}_{{s}_{2}} ( f )\end{matrix} ] , \\ and \\ ( 184 ) \\ \underline{r} ( f ) = [ \begin{matrix}α ( {\underline{r}}_{{y}_{1}} ( f ) - {\underline{r}}_{{s}_{1}} ( f ) ) + ( 1 - α ) {H}_{s} ( f ) {\underline{r}}_{{s}_{1}} ( f ) \\ α ( {\underline{r}}_{{y}_{2} {y}_{1}} ( f ) - {\underline{r}}_{{s}_{2} {s}_{1}} ( f ) ) + ( 1 - α ) {H}_{s} ( f ) {\underline{r}}_{{s}_{2} {s}_{1}} ( f )\end{matrix} ] ,\end{matrix}$$

respectively.

2. Example Hybrid Dual-Channel Noise Suppressor

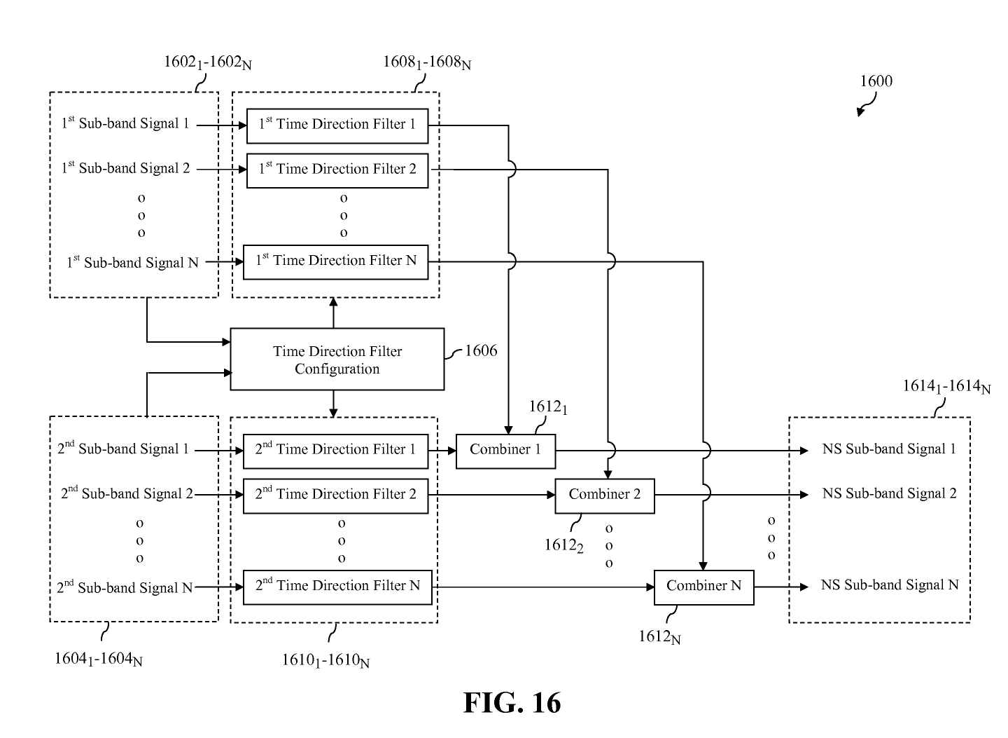

FIG. 16 is a block diagram of an example dual-channel noise suppressor 1600 that utilizes a hybrid approach in accordance with an embodiment of the present invention. Generally speaking, noise suppressor 1600 operates to receive a plurality of first sub-band signals 1602₁-1602_{N} obtained by applying a frequency conversion process to a time domain representation of a first input audio signal, to receive a plurality of second sub-band signals 1604₁-1604_{N} obtained by applying a frequency conversion process to a time domain representation of a second input audio signal, and to process the plurality of first sub-band signals 1602₁-1602_{N} and the plurality of second sub-band signals 1604₁-1604_{N} to produce a plurality of noise suppressed (NS) sub-band signals 1614₁-1614_{N}. As shown in FIG. 16, noise suppressor 1600 includes a time direction filter configuration module 1606, a plurality of first time direction filters 1608₁-1608_{N} each corresponding to a particular frequency sub-band 1-N, a plurality of second time direction filters 1610₁-1610_{N} each corresponding to a particular frequency sub-band 1-N, and a plurality of combiners 1612₁-1612_{N}.

The plurality of first sub-band signals 1602₁-1602_{N} and the plurality of second sub-band signals 1604₁-1604_{N} may be received by noise suppressor 1600 from an entity that operates upon a dual-channel frequency domain representation of the input audio signal. For example and without limitation, the plurality of first sub-band signals 1602₁-1602_{N} and the plurality of second sub-band signals 1604₁-1604_{N} may be received from a sub-band acoustic echo cancellation (SBAEC) module that processes a dual-channel frequency domain representation of a dual microphone input audio signal. However, this is only one example.

Time direction filter configuration module 1606 operates to update the configuration of each of the plurality of first time direction filters 1608₁-1608_{N} and the configuration of each of the plurality of second time direction filters 1610₁-1610_{N}. Such updating may occur on a periodic or non-periodic basis dependent upon a control scheme. For each time direction filter associated with a given sub-band, time direction filter configuration module 1602 configures the filter based on statistics associated with the first and second sub-band signals received for the given sub-band, a parameter that specifies a degree of balance between distortion of a desired audio signal included in the first sub-band signal for the given sub-band and an unnaturalness of a residual noise signal included in a noise-suppressed sub-band signal generated for the given sub-band, and a noise attenuation factor or shaping filter. By way of example, time direction filter configuration module 1602 may update the configuration of each of the plurality of first time direction filters 1608₁-1608_{N} and the configuration of each of the plurality of second time direction filters 1610₁-1610_{N} in accordance with Equation 179, wherein the parameter α comprises the parameter that specifies the degree of balance between distortion of the desired audio signal included in the first sub-band signal for a given sub-band and the unnaturalness of the residual noise signal included in the noise-suppressed sub-band signal generated for the given sub-band, and wherein Hₛ(f) specifies the noise attenuation factor or shaping for the given sub-band. However, this is only one example and other time direction filter formulations may be used.

Each first time direction filter 1608₁-1608_{N} operates to receive a corresponding one of the plurality of first sub-band signals 1602₁-1602_{N} and to filter it in the time direction in accordance with its current configuration (as determined by time direction filter configuration module 1606) to produce a corresponding filtered sub-band signal. Likewise, each second time direction filter 1610₁-1610_{N} operates to receive a corresponding one of the plurality of second sub-band signals 1604₁-1604_{N} and to filter it in the time direction in accordance with its current configuration (as determined by time direction filter configuration module 1606) to produce a corresponding filtered sub-band signal.

Each combiner 1612₁-1612_{N} operates to combine one of the filtered sub-band signals produced by the plurality of first time direction filters 1608₁-1608_{N} with a corresponding filtered sub-band signal produced by the plurality of second time direction filters 1610₁-1610_{N} to generate a corresponding one of plurality of noise-suppressed sub-band signals 1614₁-1614_{N}. Depending upon the implementation, noise-suppressed sub-band signals 1614₁-1614_{N} may be further processed or may be passed to a time domain conversion module that processes the signals to produce a time domain representation of a noise-suppressed version of the input audio signal.

3. Example Methods for Performing Hybrid Dual-Channel Noise Suppression

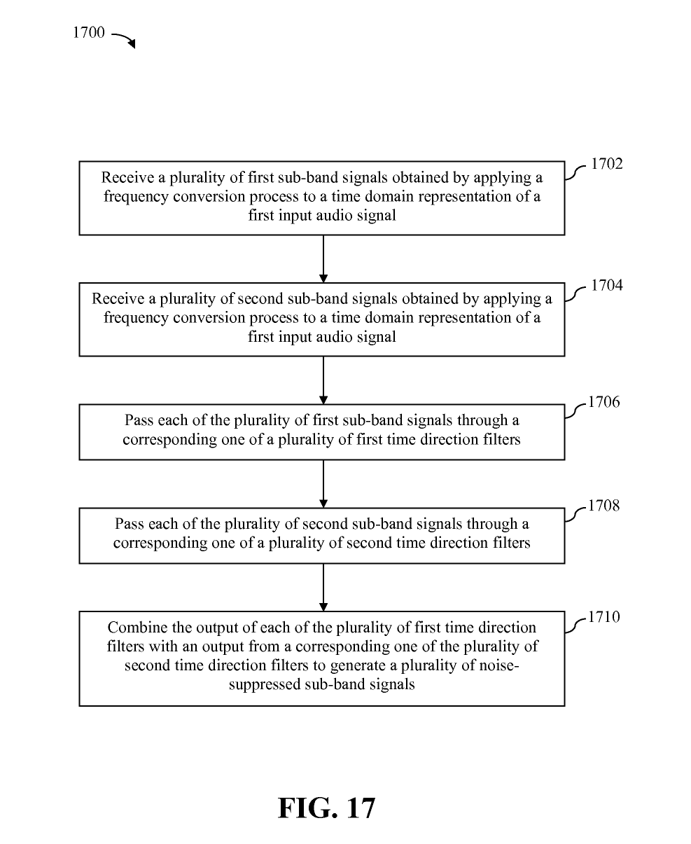

FIG. 17 depicts a flowchart 1700 of an example method for performing hybrid dual-channel noise suppression in accordance with an embodiment of the present invention. The method of flowchart 1700 may be performed, for example and without limitation, by noise suppressor 1600 as described above in reference to FIG. 16. However, the method is not limited to that implementation.

As shown in FIG. 17, the method of flowchart 1700 begins at step 1702 in which a plurality of first sub-band signals obtained by applying a frequency conversion process to a time domain representation of a first input audio signal is received. At step 1704, a plurality of second sub-band signals obtained by applying a frequency conversion process to a time domain representation of a second input audio signal is received. In certain implementations, steps 1702 and 1704 involve receiving the plurality of first sub-band signals and the plurality of second sub-band signals from a sub-band acoustic echo cancellation module or some other module that processes a dual-channel frequency domain representation of the input speech signal.

At step 1706, each of the plurality of first sub-band signals is passed through a corresponding one of a plurality of first time direction filters. At step 1708, each of the plurality of second sub-band signals is passed through a corresponding one of a plurality of second time direction filters.

In one embodiment, step 1706 comprises passing each first sub-band signal through a corresponding first time direction filter for a given sub-band having a response that is controlled by at least a parameter that specifies a degree of balance between distortion of a desired audio signal included in the first sub-band signal for the given sub-band and unnaturalness of a residual noise signal present in a noise-suppressed sub-band signal generated for the given sub-band and step 1708 comprises passing each second sub-band signal through a corresponding second time direction filter for a given sub-band having a response that is controlled by at least a parameter that specifies a degree of balance between distortion of a desired audio signal included in the first sub-band signal for the given sub-band and unnaturalness of a residual noise signal present in the noise-suppressed sub-band signal generated for the given sub-band. For example, such an embodiment may be implemented by using a plurality of first time direction filters and a plurality of second time direction filters constructed in accordance with Equation 179, wherein the parameter α comprises the parameter that specifies the degree of balance between distortion of the desired audio signal included in the first sub-band signal for a given sub-band signal and the unnaturalness of the residual noise signal present in the noise-suppressed sub-band signal generated for the given sub-band.

At step 1710, the output of each of the plurality of first time direction filters is combined with an output from a corresponding one of the plurality of second time domain filters to generate a plurality of noise-suppressed sub-band signals.

### H. Example Computer System Implementation

It will be apparent to persons skilled in the relevant art(s) that various elements and features of the present invention, as described herein, may be implemented in hardware using analog and/or digital circuits, in software, through the execution of instructions by one or more general purpose or special-purpose processors, or as a combination of hardware and software.

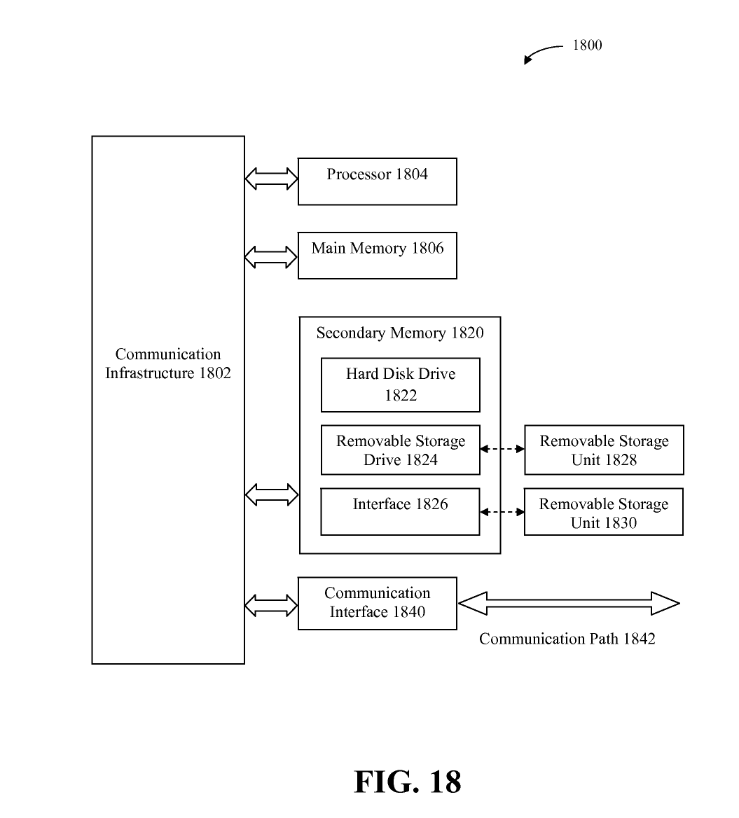

The following description of a general purpose computer system is provided for the sake of completeness. Embodiments of the present invention can be implemented in hardware, or as a combination of software and hardware. Consequently, embodiments of the invention may be implemented in the environment of a computer system or other processing system. An example of such a computer system 1800 is shown in FIG. 18. All of the modules and logic blocks depicted in FIGS. 1, 3, 4, 6-8, 10, 12, 14 and 16 for example, can execute on one or more distinct computer systems 1800. Furthermore, all of the steps of the flowcharts depicted in FIGS. 5, 9, 11, 13, 15 and 17 can be implemented on one or more distinct computer systems 1800.

Computer system 1800 includes one or more processors, such as processor 1804. Processor 1804 can be a special purpose or a general purpose digital signal processor. Processor 1804 is connected to a communication infrastructure 1802 (for example, a bus or network). Various software implementations are described in terms of this exemplary computer system. After reading this description, it will become apparent to a person skilled in the relevant art(s) how to implement the invention using other computer systems and/or computer architectures.

Computer system 1800 also includes a main memory 1806, preferably random access memory (RAM), and may also include a secondary memory 1820. Secondary memory 1820 may include, for example, a hard disk drive 1822 and/or a removable storage drive 1824, representing a floppy disk drive, a magnetic tape drive, an optical disk drive, or the like. Removable storage drive 1824 reads from and/or writes to a removable storage unit 1828 in a well known manner. Removable storage unit 1828 represents a floppy disk, magnetic tape, optical disk, or the like, which is read by and written to by removable storage drive 1824. As will be appreciated by persons skilled in the relevant art(s), removable storage unit 1828 includes a computer usable storage medium having stored therein computer software and/or data.

An alternative implementations, secondary memory 1820 may include other similar means for allowing computer programs or other instructions to be loaded into computer system 1800. Such means may include, for example, a removable storage unit 1830 and an interface 1826. Examples of such means may include a program cartridge and cartridge interface (such as that found in video game devices), a removable memory chip (such as an EPROM, or PROM) and associated socket, a flash drive and USB port, and other removable storage units 1830 and interfaces 1826 which allow software and data to be transferred from removable storage unit 1830 to computer system 1800.

Computer system 1800 may also include a communications interface 1840. Communications interface 1840 allows software and data to be transferred between computer system 1800 and external devices. Examples of communications interface 1840 may include a modem, a network interface (such as an Ethernet card), a communications port, a PCMCIA slot and card, etc. Software and data transferred via communications interface 1840 are in the form of signals which may be electronic, electromagnetic, optical, or other signals capable of being received by communications interface 1840. These signals are provided to communications interface 1840 via a communications path 1842. Communications path 1842 carries signals and may be implemented using wire or cable, fiber optics, a phone line, a cellular phone link, an RF link and other communications channels.

As used herein, the terms “computer program medium” and “computer readable medium” are used to generally refer to tangible, non-transitory storage media such as removable storage units 1828 and 1830 or a hard disk installed in hard disk drive 1822. These computer program products are means for providing software to computer system 1800.

Computer programs (also called computer control logic) are stored in main memory 1806 and/or secondary memory 1820. Computer programs may also be received via communications interface 1840. Such computer programs, when executed, enable the computer system 1800 to implement the present invention as discussed herein. In particular, the computer programs, when executed, enable processor 1804 to implement the processes of the present invention, such as any of the methods described herein. Accordingly, such computer programs represent controllers of the computer system 1800. Where the invention is implemented using software, the software may be stored in a computer program product and loaded into computer system 1800 using removable storage drive 1824, interface 1826, or communications interface 1840.

In another embodiment, features of the invention are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### I. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
receiving an input audio signal that comprises a desired audio signal and an additive noise signal; and
applying noise suppression to the input audio signal to generate a noise-suppressed audio signal in a manner that is controlled by at least a parameter that specifies a degree of balance between distortion of the desired audio signal and unnaturalness of a residual noise signal included in the noise-suppressed audio signal.

2. The method of claim 1, further comprising:
determining the parameter that specifies the degree of balance between the distortion of the desired audio signal and the unnaturalness of the residual noise signal based at least in part on characteristics of the input audio signal.

3. The method of claim 1, wherein applying noise suppression to the input audio signal comprises:
passing a time domain representation of the input audio signal through a time domain filter having an impulse response that is controlled by at least the parameter that specifies the degree of balance between the distortion of the desired audio signal and the unnaturalness of the residual noise signal.

4. The method of claim 3, wherein passing the time domain representation of the input audio signal through the time domain filter comprises:
passing the time domain representation of the input audio signal through a time domain filter having an impulse response that is controlled by at least the parameter that specifies the degree of balance between the distortion of the desired audio signal and the unnaturalness of the residual noise signal and a noise attenuation factor.

5. The method of claim 4, further comprising:
identifying the noise attenuation factor; and
determining the degree of balance between the distortion of the desired audio signal and the unnaturalness of the residual noise signal based on the noise attenuation factor.

6. The method of claim 3, wherein passing the time domain representation of the input audio signal through the time domain filter comprises:
passing the time domain representation of the input audio signal through a time domain filter having an impulse response that is controlled by at least the parameter that specifies the degree of balance between the distortion of the desired audio signal and the unnaturalness of the residual noise signal and a noise shaping filter.

7. The method of claim 1, further comprising:
estimating statistics comprising correlation of the time domain representation of the input audio signal and correlation of a time domain representation of the additive noise signal; and
wherein passing the time domain representation of the input audio signal through the time domain filter comprises passing the time domain representation of the input audio signal through a time domain filter having an impulse response that is a function of at least the parameter that specifies the degree of balance between the distortion of the desired audio signal and the unnaturalness of the residual noise signal and the estimated statistics.

8. The method of claim 1, wherein applying noise suppression to the input audio signal comprises:
multiplying a frequency domain representation of the input audio signal by a frequency domain gain function that is controlled by at least the parameter that specifies the degree of balance between the distortion of the desired audio signal and the unnaturalness of the residual noise signal.

9. The method of claim 8, wherein multiplying the frequency domain representation of the input audio signal by the frequency domain gain function comprises multiplying the frequency domain representation of the input audio signal by a frequency domain gain function that is controlled by a single parameter that specifies the degree of balance between the distortion of the desired audio signal and the unnaturalness of the residual noise signal for all of a plurality of frequency sub-bands.

10. The method of claim 8, wherein multiplying the frequency domain representation of the input audio signal by the frequency domain gain function comprises multiplying the frequency domain representation of the input audio signal by a frequency domain gain function that is controlled by a plurality of parameters that specify the degree of balance between the distortion of the desired audio signal and the unnaturalness of the residual noise signal for each of a plurality of frequency sub-bands.

11. The method of claim 8, wherein multiplying the frequency domain representation of the input audio signal by the frequency domain gain function comprises:
multiplying the frequency domain representation of the input audio signal by a frequency domain gain function that is controlled by at least the parameter that specifies the degree of balance between the distortion of the desired audio signal and the unnaturalness of the residual noise signal and a frequency-dependent noise attenuation factor.

12. The method of claim 8, further comprising:
estimating statistics comprising power spectra associated with the input audio signal and power spectra associated with the additive noise signal;
wherein multiplying the frequency domain representation of the input audio signal by the frequency domain gain function comprises multiplying the frequency domain representation of the input audio signal by a frequency domain gain function that is a function of at least the parameter that specifies the degree of balance between the distortion of the desired audio signal and the unnaturalness of the residual noise signal and the estimated statistics.

13. A method, comprising:
receiving a first input audio signal that comprises a first desired audio signal and a first additive noise signal;
receiving a second input audio signal that comprises a second desired audio signal and a second additive noise signal;
processing the first input audio signal to generate a first processed audio signal in a manner that is controlled by at least a parameter that specifies a degree of balance between distortion of the first desired audio signal and unnaturalness of a residual noise signal included in a noise-suppressed audio signal;
processing the second input audio signal to generate a second processed audio signal in a manner that is controlled by at least the parameter that specifies the degree of balance between distortion of the first desired audio signal and unnaturalness of the residual noise signal; and
combining at least the first processed audio signal and the second processed audio signal to produce the noise-suppressed audio signal.

14. The method of claim 13, further comprising:
determining the parameter that specifies the degree of balance between the distortion of the first desired audio signal and the unnaturalness of the residual noise signal based at least in part on characteristics of the first input audio signal and/or characteristics of the second input audio signal.

15. The method of claim 13, wherein processing the first input audio signal comprises passing a time domain representation of the first input audio signal through a first time domain filter having an impulse response that is controlled by at least the parameter that specifies the degree of balance between the distortion of the first desired audio signal and the unnaturalness of the residual noise signal;
wherein processing the second input audio signal comprises passing a time domain representation of the second input audio signal through a second time domain filter having an impulse response that is controlled by at least the parameter that specifies the degree of balance between the distortion of the first desired audio signal and the unnaturalness of the residual noise signal; and
wherein combining at least the first processed audio signal and the second processed audio signal comprises adding the output of the first time domain filter to the output of the second time domain filter.

16. The method of claim 15, wherein passing the time domain representation of the first input audio signal through the first time domain filter comprises passing the time domain representation of the first input audio signal through a first time domain filter having an impulse response that is controlled by at least the parameter that specifies the degree of balance between the distortion of the first desired audio signal and the unnaturalness of the residual noise signal and a noise attenuation factor; and
wherein passing the time domain representation of the second input audio signal through the second time domain filter comprises passing the time domain representation of the second input audio signal through a second time domain filter having an impulse response that is controlled by at least the parameter that specifies the degree of balance between the distortion of the first desired audio signal and the unnaturalness of the residual noise signal and the noise attenuation factor.

17. The method of claim 16, further comprising:
identifying the noise attenuation factor; and
determining the degree of balance between the distortion of the first desired audio signal and the unnaturalness of the residual noise signal based on the noise attenuation factor.

18. The method of claim 15, wherein passing the time domain representation of the first input audio signal through the first time domain filter comprises passing the time domain representation of the first input audio signal through a first time domain filter having an impulse response that is controlled by at least the parameter that specifies the degree of balance between the distortion of the first desired audio signal and the unnaturalness of the residual noise signal and a noise shaping filter; and
wherein passing the time domain representation of the second input audio signal through the second time domain filter comprises passing the time domain representation of the second input audio signal through a second time domain filter having an impulse response that is controlled by at least the parameter that specifies the degree of balance between the distortion of the first desired audio signal and the unnaturalness of the residual noise signal and the noise shaping filter.

19. The method of claim 15, further comprising:
estimating statistics that include correlation of the time domain representation of the first input audio signal, correlation of a time domain representation of the first additive noise signal, correlation of the time domain representation of the second input audio signal, correlation of a time domain representation of the second additive noise signal, a cross-correlation between the time domain representation of the first input audio signal and the time domain representation of the second input audio signal, and a cross-correlation of the time domain representation of the first additive noise signal and the time domain representation of the second additive noise signal; and
wherein passing the time domain representation of the first input audio signal through the first time domain filter comprises passing the time domain representation of the first input audio signal through a first time domain filter having an impulse response that is a function of at least the parameter that specifies the degree of balance between the distortion of the first desired audio signal and the unnaturalness of the residual noise signal and at least some of the statistics; and
wherein passing the time domain representation of the second input audio signal through the second time domain filter comprises passing the time domain representation of the second input audio signal through a second time domain filter having an impulse response that is a function of at least the parameter that specifies the degree of balance between the distortion of the first desired audio signal and the unnaturalness of the residual noise signal and at least some of the statistics.

20. The method of claim 13, wherein processing the first input audio signal comprises multiplying a frequency domain representation of the first input audio signal by a first frequency domain gain function that is controlled by at least the parameter that specifies the degree of balance between the distortion of the first desired audio signal and the unnaturalness of the residual noise signal to generate a first product;
wherein processing the second input audio signal comprises multiplying a frequency domain representation of the second input audio signal by a second frequency domain gain function that is controlled by at least the parameter that specifies the degree of balance between the distortion of the first desired audio signal and the unnaturalness of the residual noise signal to generate a second product; and
wherein combining at least the first processed audio signal and the second processed audio signal comprises adding the first product to the second product.

21. The method of claim 20, wherein
multiplying the frequency domain representation of the first input audio signal by the first frequency domain gain function comprises multiplying the frequency domain representation of the first input audio signal by a first frequency domain gain function that is controlled by a single parameter that specifies the degree of balance between the distortion of the first desired audio signal and the unnaturalness of the residual noise signal for all of a plurality of frequency sub-bands; and
multiplying the frequency domain representation of the second input audio signal by the second frequency domain gain function comprises multiplying the frequency domain representation of the second input audio signal by a second frequency domain gain function that is controlled by the single parameter that specifies the degree of balance between the distortion of the first desired audio signal and the unnaturalness of the residual noise signal for all of the plurality of frequency sub-bands.

22. The method of claim 20, wherein
multiplying the frequency domain representation of the first input audio signal by the first frequency domain gain function comprises multiplying the frequency domain representation of the first input audio signal by a first frequency domain gain function that is controlled by a plurality of parameters that specify the degree of balance between the distortion of the desired audio signal and the unnaturalness of the residual noise signal for each of a plurality of frequency sub-bands; and
multiplying the frequency domain representation of the second input audio signal by the second frequency domain gain function comprises multiplying the frequency domain representation of the second input audio signal by a second frequency domain gain function that is controlled by the plurality of parameters that specify the degree of balance between the distortion of the desired audio signal and the unnaturalness of the residual noise signal for each of the plurality of frequency sub-bands.

23. The method of claim 20, wherein multiplying the frequency domain representation of the first input audio signal by the first frequency domain gain function comprises multiplying the frequency domain representation of the first input audio signal by a first frequency domain gain function that is controlled by at least the parameter that specifies the degree of balance between the distortion of the first desired audio signal and the unnaturalness of the residual noise signal and a frequency-dependent noise attenuation factor; and
wherein multiplying the frequency domain representation of the second input audio signal by the second frequency domain gain function comprises multiplying the frequency domain representation of the second input audio signal by a second frequency domain gain function that is controlled by at least the parameter that specifies the degree of balance between the distortion of the first desired audio signal and the unnaturalness of the residual noise signal and the frequency-dependent noise attenuation factor.

24. The method of claim 20, further comprising:
estimating statistics comprising power spectra associated with the first input audio signal, power spectra associated with the second input audio signal, power spectra associated with the first additive noise signal, power spectra associated with the second additive noise signal, cross-power-spectra associated with the first and second input audio signals, and cross-power-spectra associated with the first and second additive noise signals;
wherein multiplying the frequency domain representation of the first input audio signal by the first frequency domain gain function comprises multiplying the frequency domain representation of the first input audio signal by a first frequency domain gain function that is a function of at least the parameter that specifies the degree of balance between the distortion of the first desired audio signal and the unnaturalness of the residual noise signal and at least some of the statistics; and
wherein multiplying the frequency domain representation of the second input audio signal by the second frequency domain gain function comprises multiplying the frequency domain representation of the second input audio signal by a second frequency domain gain function that is a function of at least the parameter that specifies the degree of balance between the distortion of the first desired audio signal and the unnaturalness of the residual noise signal and at least some of the statistics.

25. A method for applying noise suppression to an input audio signal, comprising:
receiving a plurality of sub-band signals obtained by applying a frequency conversion process to a time domain representation of the input audio signal; and
applying noise suppression to each of the sub-band signals by passing each of the sub-band signals through a corresponding time direction filter.

26. The method of claim 25, further comprising:
applying a time domain conversion process to the outputs of each of the corresponding time direction filters to generate a time domain representation of a noise-suppressed version of the input audio signal.

27. The method of claim 25, wherein receiving the plurality of sub-band signals comprises receiving the plurality of sub-band signals from a sub-band acoustic echo cancellation module.

28. The method of claim 25, wherein each sub-band signal comprises a desired audio signal and a noise signal; and
wherein passing each of the sub-band signals through a corresponding time direction filter comprises passing each of the sub-band signals through a time direction filter having a response that is controlled by at least a parameter that specifies a degree of balance between distortion of the desired audio signal included in the sub-band signal and unnaturalness of a residual noise signal included in a noise-suppressed version of the sub-band signal.

29. The method of claim 28, further comprising:
determining the parameter that specifies the degree of balance between the distortion of the desired audio signal included in the sub-band signal and the unnaturalness of the residual noise signal included in the noise-suppressed version of the sub-band signal for each sub-band based at least in part on characteristics of the input audio signal.

30. The method of claim 28, wherein passing each of the sub-band signals through a corresponding time direction filter comprises:
passing each of the sub-band signals through a corresponding time direction filter having a response that is controlled by at least a parameter that specifies the degree of balance between the distortion of the desired audio signal included in the sub-band signal and the unnaturalness of the residual noise signal included in the noise-suppressed version of the sub-band signal and a noise attenuation factor.

31. The method of claim 30, further comprising, for each sub-band:
identifying the noise attenuation factor; and
determining the degree of balance between the distortion of the desired audio signal included in the sub-band signal and the unnaturalness of the residual noise signal included in the noise-suppressed version of the sub-band signal based on the noise attenuation factor.

32. The method of claim 28, wherein passing each of the sub-band signals through a corresponding time direction filter comprises:
passing each of the sub-band signals through a corresponding time direction filter having a response that is controlled by at least a parameter that specifies the degree of balance between the distortion of the desired audio signal included in the sub-band signal and the unnaturalness of the residual noise signal included in the noise-suppressed version of the sub-band signal and a noise shaping filter.

33. A method for performing noise suppression, comprising:
receiving a plurality of first sub-band signals obtained by applying a frequency conversion process to a time domain representation of a first input audio signal;
receiving a plurality of second sub-band signals obtained by applying a frequency conversion process to a time domain representation of a second input audio signal;
passing each of the plurality of first sub-band signals through a corresponding one of a plurality of first time direction filters;
passing each of the plurality of second sub-band signals through a corresponding one of a plurality of second time direction filters; and
combining an output from each of the plurality of first time direction filters with an output from a corresponding one of the plurality of second time direction filters to generate a plurality of noise-suppressed sub-band signals.

34. The method of claim 33, further comprising:
applying a time domain conversion process to the plurality of noise-suppressed sub-band signals to generate a time domain representation of a noise-suppressed audio signal.

35. The method of claim 33,
wherein passing each of the plurality of first sub-band signals through a corresponding one of a plurality of first time direction filters comprises passing each first sub-band signal through a corresponding first time direction filter for a given sub-band having a response that is controlled by at least a parameter that specifies a degree of balance between distortion of a desired audio signal included in the first sub-band signal for the given sub-band and unnaturalness of a residual noise signal present in a noise-suppressed sub-band signal generated for the given sub-band; and
wherein passing each of the plurality of second sub-band signals through a corresponding one of a plurality of second time direction filters comprises passing each second sub-band signal through a corresponding second time direction filter for a given sub-band having a response that is controlled by at least a parameter that specifies a degree of balance between distortion of a desired audio signal included in the first sub-band signal for the given sub-band and unnaturalness of a residual noise signal present in the noise-suppressed sub-band signal generated for the given sub-band.
